(19) United States
(12) Patent Application Publication
(10) Pub. No.: US 2010/0199972 A1
(43) Pub. Date: Aug. 12, 2010

(54) Apparatus and Method for Building Linear Solar Collectors Directly from Rolls of Reflective Laminate Material

(75) Inventor: Randolph C. Brost, Albuquerque, NM (US)

Correspondence Address: GREENLEE WINNER AND SULLIVAN P C, 4875 PEARL EAST CIRCLE, SUITE 200, BOULDER, CO, 80301, US

(73) Assignee: SkyFuel, Inc., Albuquerque, NM (US)

(21) Appl. No.: 12/687,368

(22) Filed: Jan. 14, 2010

Related U.S. Application Data
(60) Provisional application No. 61/144,703, filed on Jan. 14, 2009.

(51) Int. Cl. F24J 2/38; F24J 2/18; B23P 15/26; B23P 19/00

(52) U.S. Cl. 126/601; 126/685; 29/890.033; 29/700

(57) ABSTRACT

Provided herein are linear solar reflectors and collectors, and methods of efficiently constructing such reflectors and collectors. The reflectors are made using reflective laminate sheets, which can be reinforced by tension-bearing strips. Methods and apparatuses for installing the sheets from a roll dispensing the sheets carried on a deployment vehicle are disclosed, as well as methods and apparatuses for assembling and constructing various collector components, methods and apparatuses for tensioning the reflective laminate sheets, methods and apparatus for passively changing the focal length of the reflectors while controlling their movement to track the sun, and methods and apparatuses for compensating for temperature changes in system components for moving the collectors, are provided.

### CROSS-REFERENCE TO RELATED APPLICATION

This application claims priority to U.S. Provisional Patent Application No. 61/144,703 filed Jan. 14, 2009, which is incorporated herein to the extent it is not inconsistent with the disclosure hereof.

### STATEMENT OF GOVERNMENT SUPPORT

This Invention was made, at least in part, with U.S. Government support under Department of Energy Contract No. DE-FC36-08GO18034. The Government has certain rights in this invention.

### BACKGROUND

Reflective laminated films or sheets for use in solar reflectors are known to the art. For example, U.S. Pat. No. 6,989,924 to Gee et al. for “Durable corrosion and ultraviolet-resistant silver reflective,” issued Jan. 24, 2006, and U.S. Patent Publication No. 20060181765 of Gee et al. for “Reflective laminated films or sheets for use in solar reflectors” disclose thin, flexible reflective films. U.S. Pat. No. 4,372,027 to Hutchison for “Method of Manufacturing Parabolic Trough Solar Collector” discloses a method for making a laminate; however the laminated product does not lend itself to forming rolls.

U.S. Pat. No. 6,234,166, entitled “Absorber-Reflector for Solar Heating,” issued May 22, 2001 to Katsir, et al., assigned to Acktar, Ltd. of Kiryat Gat, Israel, discloses a reflective laminate comprising a polymer layer, a reflective layer, an adhesive layer, a metal layer, and a solar absorbing layer in that order for indoor use as a solar absorber-reflector for transmitting solar heat into a heat-absorbing chamber such as a room of a house, and/or repelling heat resulting from solar radiation from a chamber. The laminate disclosed requires the presence of a solar-absorbing layer and is not designed for outdoor use.

U.S. Pat. No. 5,237,337 for “Method and Apparatus for Manufacturing and Erecting Concave Metallic Membrane Type Reflectors,” issued Aug. 17, 1993 to Hutchison, et al., assigned to Solar Kinetics, Inc., Dallas, Tex., discloses a method and apparatus for forming a reflective stainless steel membrane one-half to four mil thick into a concave shape in a controlled environment in a factory for use as a solar energy collector, and rolling it onto an appropriately-shaped mandrel for transport to a remote site for attachment to a support structure and use as a solar reflector.

U.S. Pat. No. 4,343,533 for “Solar Radiation Reflector with a Cellulosic Substrate and Method of Making,” issued Aug. 10, 1982 to Currin, et al., assigned to Dow Corning Corporation, Midland, Mich., discloses a reflective laminate for use in solar reflectors comprising a reflective metal foil layer with a weather-resistant protective coating on its reflective side, and at least one layer of cellulosic material, such as corrugated cardboard, impregnated with a weather-resistant composition. The laminate can be shaped as required for appropriate reflection of sunlight. This solar reflector is made by first shaping the cardboard, then dipping it into a polymer composition. While the polymer is still uncured, metal foil is applied. After the polymer cures, a weather-resistant, clear protective coating is applied. This material is not capable of being rolled or shaped in the field.

Patent Publication 2008/0050579 for “Solar Control Glazing Laminates,” issued Feb. 28, 2008 to Kirkman, et al, assigned to 3M Innovative Properties Company, St. Paul, Minn., discloses a laminate that has an infrared radiation reflecting film and an infrared absorbing material. It is apparently used in automobile windows rather than solar reflectors, and does not contain a metal layer.

Japanese published Abstract No. JP59072401 entitled “Manufacture of Curved Surface Reflector,” published Apr. 24, 1984, inventor, Fujiwara Kenji, assigned to Nippon Sheet Glass Col. Ltd. discloses a method for mass-producing a curved surface reflector by elastically deforming a plate glass reflector along the curved surface of a rigid substrate, and bonding the layers together.

U.S. Pat. No. 4,141,626, entitled “Method and Apparatus for Collecting Solar Radiation Utilizing Variable Curvature Cylindrical Reflectors, issued Feb. 27, 1979 to Treytl, et al. describes a linear Fresnel solar collector having a secondary reflector, with a heavy space frame structure supporting the mirror. This patent also discloses a mechanism for actively varying the mirror curvature and focal length.

U.S. Pat. No. 4,596,238, entitled “Interiorly Tensioned Solar Reflector,” issued Jun. 24, 1986 to Bronstein discloses use of a spring and internal compressive elements to apply tension to a reflective panel made using a reflective laminate film, similar to the film described in the aforementioned U.S. Pat. No. 6,989,924.

All patents and publications referred to herein are incorporated herein by reference for purpose of written description and enablement.

The foregoing examples of the related art and its limitations are intended to be illustrative and not exclusive. Other limitations of the related art will become apparent to those of ordinary skill in the art upon a reading of the specification and a study of the drawings.

### SUMMARY

In addition to the exemplary aspects and embodiments described above, further aspects and embodiments will become apparent by reference to the drawings and by study of the following descriptions.

Provided herein is a linear solar reflector. The linear solar reflectors provided herein typically comprise (a) a fixed mount; (b) a mirror comprising at least one continuous reflective laminate sheet, which is under tension being exerted along its length, the sheet having a fixed end and tension end, wherein the fixed end is operably connected to the fixed mount; (c) a tension mount operably connected to the tension end of the reflective laminate sheet; and (d) one or more ground connections for the reflective laminate sheet separately connected to the ground and spaced along a line defined by the fixed mount and the tension mount. A tension mount is an assembly of components which, in an embodiment, comprise a tension frame, cable, pulley, and tension weight, or tension spring and second fixed mount, as more fully described with reference to the Figures. A ground connection is an assembly of components, which in an embodiment, comprise a mirror support, including a rib. In an embodiment, the mirror support comprises a ground attachment interface, one or two vertical poles, one or two alignable attachment devices, and a horizontal support rod.

In an embodiment, the tension on the reflective laminate sheet can be between about 100 pounds/inch and about 700 pounds/inch, measured relative to the width of the reflective laminate sheet. In embodiments, this tension is at least about 200 pounds/inch, and in embodiments, the tension is about 200 pounds/inch.

The linear solar reflector can comprise a tension device operationally connected to the tension mount and the tension end of the reflective laminate sheet. The tension device can comprise a tension weight. Alternatively or in addition, it can comprise a cable having first and second ends, wherein the first end is operationally connected to the tension end of the reflective laminate sheet; a pulley operationally connected to the cable; a tension frame fixedly attached to the ground and operationally connected to the pulley; and wherein the second end of the cable is operationally connected to the tension weight. In embodiments, the tension weight weighs between about 6,000 pounds and about 42,000 pounds. The tension weight can weigh at least about 12,000 pounds, and it can weigh about 12,000 pounds. The tension device can also or alternatively comprise a tension spring.

In embodiments of the linear solar reflector, the reflective laminate sheet is a continuous, unbroken sheet, which, in embodiments, comprises a reflective polymer film and a backing substrate.

In embodiments, the reflective laminate sheet comprises tension-bearing strips, which are generally sandwiched between the reflective polymer film layer and its backing material. The strips have a long axis parallel to the long axis of the laminate sheet. The strips can be wires or flat strips. The flat strips can be spaced apart so that the ratio of the strip width to the space between the strips is between about 1:7 and about 7:1, and in embodiments about 1:1. In embodiments, the backing material can have an elastic modulus at least about 10 times lower, at least about 25 times lower, or at least about 50 times lower than the material of the strips. In embodiments, the laminate material comprising strips has a total resistance to elongation at least 25 times higher than the reflective polymer film and backing material without strips. The strips can be made of any suitable material providing the desired strength and flexibility, for example, aluminum, steel, or stainless steel. The backing substrate can have a thickness between about 0.010 inches and about 0.050 inches.

The backing substrate can comprise a formed shape that includes features out of the nominal plane of the original sheet to increase the sheet's resistance to bending. For example, these features can be edge features such as channels. In embodiments, the features are made as part of a roll-forming process as described herein.

In embodiments, the ground connection for the reflector comprises: (a) a mirror support operationally secured to the ground; a rib operationally connected to the mirror support, wherein the reflective laminate sheet is operationally secured to the rib, and wherein the operational connection between the rib and the mirror support allows the rib to rotate along a rotation freedom and translate along a translation freedom.

The mirror support comprises, in embodiments hereof, (a) a first vertical support pole operationally secured to the ground; and (b) a horizontal support rod attached to the first vertical support pole. An alignable attachment device can connect the horizontal support rod to the first vertical support pole.

The rib can comprise a pivot bearing at its operational connection with the mirror support, wherein the pivot bearing is operationally connected to the horizontal support rod. The pivot bearing can be fixedly attached to, or can be part of the rib, and the operational connection between the pivot bearing and the horizontal support rod can allow the pivot bearing to rotate along a rotation freedom and/or translate along a translation freedom. In embodiments, the rib comprises an arm as its lower portion. In such embodiments, the rib can comprise a crossbar as its upper portion. The reflective laminate sheet can be operationally secured to the rib, for example, by means of a top strap. The rib can comprise one or more extension tabs with holes, and the top strap can comprise one or more matching holes, and a means of securing the top strap to the rib can comprise fasteners for insertion into the holes to operationally connect the top strap and rib extension tabs. Alternatively, or in addition, the rib can comprise a plurality of clip holes, the top strap can comprise a series of matching clip holes, and a means of securing the top strap to the rib can comprise fasteners for insertion through the clip holes. The fasteners can be clips, rivets, screws or other fasteners known to the art.

The linear solar reflector can also comprise an actuation mechanism, also referred to herein as an “actuation system,” operationally connected thereto to allow it to move, for example to track the sun. The actuation mechanism can comprise: (a) a push rod operationally connected to an arm portion of a rib supporting the reflective laminate sheet, wherein motion of the push rod approximately along an axis defined by its length results in a change in angle of the rib; (b) an actuation unit operationally connected to the push rod, wherein the actuation unit can cause the push rod to move approximately along an axis defined by its length; and (c) a controller programmed with a sun-tracking algorithm, wherein the program causes the actuation unit to move the push rod approximately along an axis defined by its length in such a way as to cause the angle of the solar reflector to change as required for efficient collection of solar energy. The actuation unit can also comprise a drive arm pivotally connected to the push rod, one end of the drive arm being pivotally connected to the push rod. In an embodiment, the other end of the drive arm is pivotally connected to the actuation unit, such that the motion of the push rod is caused by the drive arm. The actuation unit can also comprise a hydraulic actuator and/or an electric motor. In embodiments, the push rod is operationally connected to the rib arm via an intervening actuation rod. The connection can be one that allows the rib to rotate along a rotation freedom and translate along a translation freedom relative to the actuation rod. In embodiments, the rib arm comprises an actuation bearing at its operational connection with the push rod, wherein the actuation bearing is operationally connected to the actuation rod. In this embodiment, the requirement for a translation freedom can be avoided.

In embodiments, the push rod can be operationally connected to a component of a temperature compensation mechanism and the actuation rod can be operationally connected to a component of the temperature compensation mechanism, such as a temperature compensation mechanism comprising: (a) a first link having first, second, and third holes; and (b) a second link with a thermal expansion coefficient that is different from the push rod, wherein the first hole is pivotally connected to the push rod, the third hole is operationally connected to the actuation rod, the second hole is pivotally connected to one end of the second link, and the opposite end of the second link is pivotally connected to the push rod. The push rod can be a rigid rod capable of bearing compressive forces. In embodiments, the push rod is made of a material with a coefficient of linear expansion less than about 2×10⁻⁶ 1/° C. In embodiments, the push rod is made of a material such as Invar™ or other suitable material known to the art.

The function of the push rod can alternatively be performed by a cable held under tension, e.g., by an actuation tension weight as described below. In embodiments, the cable is made of a material with a coefficient of linear expansion less than about 2×10⁻⁶ 1/° C. In embodiments, the cable is made of a material such as Invar™ or other suitable material known to the art.

In embodiments, tension is maintained on the cable by means of an actuation tension unit comprising (a) a pylori; (b) a shaft bearing mounted on the pylori; (c) a shaft disposed within the shaft bearing; (d) an idler arm operationally connected to the shaft; (e) an actuation pulley operationally connected to the shaft; (f) a weight cable or push rod operationally connected to the actuation pulley; and (g) an actuation tension weight operationally connected to the weight cable or push rod.

A linear solar reflector can comprise a plurality of actuation mechanisms, powered by hydraulic or electrical means.

Linear Fresnel collectors can be built with fixed focal length, but this results in less than optimal optical performance. To improve optical performance, mechanisms for automatically varying mirror focus as the mirrors are rotated to track the sun are provided herein. These mechanisms use simple, mechanical elements, and do not require complex servo-controlled components used in previously-attempted variable focus mechanisms.

In embodiments, the rib is a self-adjusting rib, to enable passive adjustment of the focal length of the mirror. The term “passive adjustment” as used in this context means that the focal length of the mirror is automatically changed when the mirror is moved to track the sun. The self-adjusting rib, in an embodiment, comprises one or more of the following components: (a) a first main plate as a component of the rib; (b) a compliant mirror support operationally attached to the first main plate, wherein the reflective laminate sheet can be operationally secured to the compliant mirror support, and wherein the compliant mirror support is flexible and can bend through a range of desired curvatures for the linear solar reflector; (c) a mechanism that moves the compliant mirror support to the desired curvature in passive response to the actuation mechanism rotating the rib to track the sun through the day. The reflective laminate sheet can be operationally secured to the compliant mirror support by means of a compliant top strap, as described above with respect to securing the laminate sheet to a rib that is not necessarily a self-adjusting rib. The compliant mirror support can be fixedly attached to the first main plate by means of an intervening compliant support mounting bracket. In an embodiment, the compliant mirror support and compliant top strap form a flexible beam when connected, wherein the dimensions of the resulting flexible beam are such that when the beam is moved into the shape desired when the self-adjusting rib is oriented at its neutral angle, the beam provides a preload force sufficient to resist expected disturbances, while allowing further movement to its maximally flattened shape without exceeding the allowable material stress at any point. In embodiments, the compliant mirror support and compliant top strap can be made of stainless steel, with combined thickness of about 0.43 inches, a width of about 4.0 inches, and a length of about 60 inches plus additional length to accommodate fastening features including extension tabs.

In another embodiment, the mechanism capable of moving the compliant mirror support to a desired curvature can comprise: (a) a rotatable pivot bearing pivotally attached to the first main plate, said rotatable pivot bearing comprising means for maintaining a fixed orientation relative to ground when installed on the horizontal support rod; (b) a primary pulley strap, with a proximal end operationally attached to the rotatable pivot bearing, and a distal end operationally attached to a first wheel of a compound pulley; (c) a compound pulley, wherein the compound pulley is pivotally attached to the main plate, and comprises: (1) a first wheel, operationally attached to the distal end of the primary pulley strap; and (2) a second wheel, operationally attached to the proximal end of a secondary pulley strap, wherein the first wheel and second wheel have different diameters; and (d) a secondary pulley strap, with a proximal end operationally attached to the second wheel of the compound pulley, and a distal end operationally attached to the compliant mirror support, wherein rotation of the self-adjusting rib by the mirror actuation mechanism to an orientation away from the rib's neutral angle causes the rotatable pivot bearing to pull on the primary pulley strap, which in turn rotates the compound pulley, causing the secondary pulley strap to pull on the compliant mirror support, pulling the flexible beam formed by the compliant mirror support into a desired curvature. The means for maintaining the pivot bearing in a fixed orientation relative to ground when installed on the horizontal support rod can be a part on the pivot bearing that interlocks with another part on the support rod such that the parts can slide on each other, but not allow rotation. For example, there can be a projection on the pivot bearing that fits slidably into a groove on the support rod. In other embodiments, the groove can be on the pivot bearing and the projection on the support rod.

Also provided herein is a linear solar reflector wherein the mechanism that changes the compliant mirror support to the desired curvature in passive response to the actuation mechanism rotating the rib to track the sun through the day (also referred to herein as a “curvature adjustment system”) comprises: (a) at least one cam-following finger attached to and extending downward from the underside of the center of the compliant mirror support, and comprising a cam-following pin extending perpendicularly from the finger; (b) centering tabs attached to the rib and flanking the cam-following finger so as to prevent lateral movement of the finger relative to the rib; (c) a rotatable pivot cam rotatably attached to the first main plate of the rib, said rotatable cam comprising means for maintaining a fixed orientation relative to ground when installed on the horizontal support rod; d) at least one cam groove formed in the pivot cam for receiving said cam-following pin and allowing slidable movement of the pin therein during operation of the mechanism, in which operation the rib rotates upon said pivot cam in response to an actuation mechanism for orienting the reflector to track the sun; wherein the cam groove is shaped so as to cause the pin to move to a position within the groove calculated such that the finger causes the center of the compliant mirror support to move toward or away from the rib pivot point so as to produce a desired curvature in the mirror support. The means for maintaining the pivot cam in a fixed orientation relative to ground when installed on the horizontal support rod can be a part on the pivot cam that interlocks with another part on the support rod such that the parts can slide on each other, but not allow rotation. For example, there can be a projection on the pivot cam that fits slidably into a groove on the support rod. In other embodiments, the groove can be on the pivot cam and the projection on the support rod.

In embodiments only one groove is provided in the cam, e.g., on only one side of the cam. In embodiments only one cam-following finger with an attached cam-following pin sized, shaped and positioned to fit into a groove on the cam is provided. In other embodiments there can be corresponding grooves on opposite sides (front and back sides) of the cam. In embodiments, the cam can be solid, and the grooves can extend part way or all the way through the cam. In embodiments the cam can be a hollow shell, and the grooves can be cut in each side. The grooves on each side of the cam should be the same size and shape. In embodiments comprising grooves on each side of the cam, cam-following fingers with attached opposed (facing each other) cam-following pins each designed to fit into one of the grooves on each side of the cam are provided. In embodiments, two opposed cam-following fingers are provided on each side of the cam, each finger being attached to a single cam-following pin that spans between the fingers.

In embodiments, the cam-following pin can be integral to the cam-following finger, e.g., molded with the finger as one piece. In other embodiments, the cam-following pin can be attached to the finger by means known to the art, e.g., welding, bolting, and the like. In embodiments the cam-following finger can be a bolt that is attached to the finger.

In embodiments, the desired curvature of the mirror support changes with the movement of the sun to focus a desired amount of solar radiation on a receiver positioned at a known horizontal distance and vertical angle from a reflector. The desired curvature of the mirror support produces the desired curvature in the mirror attached to its top surface, and is typically the curvature required to focus maximal sunlight on the receiver. This curvature is different for reflectors located at different horizontal distances and vertical angles from the receiver. In embodiments, the desired amount of sunlight reflected on the receiver can be less than maximal, for example in response to the temperature of the fluid within the receiver, or to the capacity of an energy plant powered by the reflected sunlight to utilize it.

In embodiments, the compliant mirror support is attached to the crossbar of the rib by at least one linkage bar pivotally attached to the support at one end and pivotally attached to the crossbar at the other end. In embodiments, the compliant mirror support is attached to the crossbar of the rib by means of at least one flexure plate attached to each end of the crossbar. In embodiments the compliant mirror support can be attached to the crossbar by both flexure plate(s) and linkage bar(s). In embodiments, the compliant mirror support is attached to a mirror sheet. Also in embodiments, the compliant mirror support comprises at least one row of clip holes along its length, and a top strap positioned such that the mirror sheet can be clamped between the top strap and the mirror support by clips engaging with the clip holes.

In embodiments, the compliant mirror support has an hourglass shape contoured to provide a deflection matching the desired parabolic shape of the mirror corresponding to a second-order polynomial function. To allow positioning of the compliant mirror support with its attached cam-following fingers comprising cam-following pins with respect to the pivot cam on the rib, in embodiments, the cam groove can be extended as an extension groove to the boundary of the pivot cam to allow insertion of the cam-following pins into the cam groove from the side. In other embodiments, insertion of the cam-following pins into the cam groove is done by providing cam-following fingers that are sufficiently flexible to be spread apart a sufficient distance to allow insertion of the pivot cam between the pins, and to allow them to spring back so that the pins are inserted into the cam groove. In other embodiments, the cam-following pins are attached to the cam-following fingers after they are positioned with respect to the pivot cam form, e.g., by means of bolts or other fastening means known to the art.

The rib assembly can also comprise a retainer plate attached to the rib to protect and stabilize the pivot cam mechanism.

In embodiments, the compliant mirror support has an hourglass shape contoured to provide a deflection substantially matching the desired parabolic shape of the mirror corresponding to a second-order polynomial function.

Solar reflectors as described above, each comprising a curvature adjustment system, can be arranged in arrays, positioned with respect to a single receiver, each reflector being designed to reflect a desired amount of sunlight on the receiver.

In embodiments comprising pivot cams, the groove in the pivot cam of each reflector is designed to have a shape and size selected to cause change of the curvature of the mirror of that reflector so as to reflect the desired amount of sunlight on said receiver over time as the sun moves across the sky and the reflector is rotated to track the movement of the sun.

Further provided herein is a method of making a supporting rib for a solar reflector wherein the rib comprises a mechanism that changes a compliant mirror support attached to the rib to a desired curvature in passive response to an actuation mechanism that rotates the rib to track the sun through the day. In an embodiment, the method comprises: (a) providing a rib main plate comprising a crossbar, an arm, and a pivot bearing hole; (b) providing a pair of centering tabs fixedly attached to the rib; (c) providing a compliant mirror support having one or more cam-following fingers extending from the center of the underside thereof, each cam-following finger being designed to support an attached or integral cam-following pin; (d) inserting a pivot cam into the pivot bearing hole, whereby the pivot cam is rotatably attached to the rib main plate, wherein the pivot cam comprises a pivot cam groove on one or both sides thereof; (e) positioning the compliant mirror support with respect to said rib main plate such that the cam-following finger(s) are flanked by the centering tabs attached to the rib, and such that cam-following pin(s) attached to or integral to the cam-following finger(s) are or can be positioned within the cam groove; (f) attaching the compliant mirror support to the rib by attachment means extending between the crossbar of the rib and the compliant mirror support; and (g) assembling the device so that the cam-following pin(s) engage the pivot cam groove. The attachment means extending between the crossbar of the rib and the compliant mirror support can comprise at least one linkage bar, and/or at least one flexure plate.

The method can further comprise attaching a retainer plate to the main plate, and can also comprise attaching a mirror sheet and compliant strap to the top surface of the compliant mirror support, e.g., by clamping it between a top strap and the top surface of the mirror support using clamps that engage with clip holes in the mirror support

Cam-following pins can be positioned within the cam groove by providing cam-following fingers sufficiently flexible that they can be flexed apart sufficiently to allow the pivot cam to be inserted between them, and initially flexing them and positioning them adjacent to the cam groove, then allowing them to spring back into the cam groove. Alternatively, the cam-following pins can be positioned within the cam groove by positioning cam-following fingers to which the pins have not yet been attached over the cam groove and then attaching the pins to said fingers such that they extend into the cam groove. In another embodiment, the cam groove is provided with an extension groove extending to the boundary of the pivot cam, and the cam-following pins are inserted into said extension groove from the side, and slid into position in the cam groove. Also provided herein are linear Fresnel collectors comprising linear solar reflectors as described above, and also comprising a solar receiver positioned to receive solar energy reflected from the linear solar reflector. In embodiments, the solar receiver is positioned to receive solar energy reflected from the reflector wherein the angle between the rib crossbar and arm is chosen to reflect solar energy onto the receiver. The linear Fresnel reflector can be controlled by a controller program that causes the actuation unit to move the push rod in such a way as to cause the angle of the solar reflector to reflect solar energy onto the receiver. A solar field comprising a plurality of the solar collectors described above is also provided. In such solar fields, the collectors can comprise a push rod as part of an actuation mechanism, wherein the push rod is operationally connected to an arm portion of a second rib supporting a second reflective laminate sheet, wherein motion of the push rod substantially along an axis defined by its length results in a change in angle of the second rib. A plurality of ribs supporting a plurality of reflective laminate sheets can be moved by the motion of a single push rod.

Also provided herein is a method for converting solar energy to electrical or steam energy comprising operating a solar field described herein to focus the solar energy on a receiver; and converting the energy collected by the receiver to electrical or heat energy.

Further provided herein is a method of constructing a linear Fresnel collector comprising one or more of the following steps: (a) providing a fixed mount; (b) providing a reflective laminate sheet having a fixed end and a tension end; (c) forming an operational connection between the fixed end of the reflective laminate sheet and the fixed mount; (d) providing a tension mount; (e) providing a first ground connection for the reflective laminate sheet between the fixed mount and tension mount; (f) attaching the reflective laminate sheet to the first ground connection; g) extending the tension end of the reflective laminate sheet to a location at or near the tension mount; and h) forming an operational connection between the tension end of the reflective laminate sheet and the tension mount.

The method for constructing the linear Fresnel collector can also comprise providing the reflective laminate sheet in the form of a roll. Also, the tension end of the reflective laminate sheet can be operationally connected to a tension mount via a tension device, which can comprise a tension weight and/or a spring. The method can comprise cutting the reflective laminate sheet to a length at least as long as the distance between the first ground connection and the second ground connection, and no more than the distance between the fixed mount and the tension mount.

The method for constructing the linear Fresnel collector can be performed in the field, e.g., by dispensing the reflective laminate sheet from a deployment vehicle. The laminate sheet can be deployed by operating the deployment vehicle from a first ground connection to additional ground connections. The laminate sheet can then be secured to the ground connections. Such a deployment vehicle can comprise installation tools, such as cutting devices, e.g., shears, saws, and other cutting means known to the art, for use in a method comprising cutting the reflective laminate sheet.

The method can comprise: (a) providing a mirror support as part of the ground connection; and (b) pivotally connecting a rib to the mirror support; wherein the reflective laminate sheet is supported by the rib. The rib can comprise an arm as its lower portion.

The method can also comprise installing an actuation mechanism in operational connection with the linear Fresnel collector. The method for installing the actuation mechanism can comprise: (a) operationally connecting a push rod to an arm portion of a rib supporting the reflective laminate sheet, wherein motion of the push rod approximately along an axis defined by its length results in a change in angle of the rib; and (b) operationally connecting the push rod to an actuation unit with a controller programmed with a sun-tracking algorithm, wherein the program causes motion of the push rod approximately along an axis defined by its length in such a way as to cause the angle of the solar reflector to change as required for efficient collection of solar energy. Operationally connecting the push rod to the arm can comprise pivotally connecting the arm to the push rod via an actuation rod.

Linear Fresnel collectors made by the foregoing methods are provided herein, as are solar fields comprising a plurality of the solar reflectors and/or collectors described above.

Collector components described above for performing particular functions are provided herein. They can be grouped into systems that can be used in combination with each other, or separately, or combined with any other collector components that are conventional or newly provided herein. Any novel collector component or novel combination of collector components described herein can form the basis of a claim, whether or not a claim to such component or combination is presented herewith.

Another system described herein is the temperature compensation system shown in FIGS. 24A and B, comprising two connected links (metal bars or rods) connecting the push rod and actuation rod, described above. The ends of the first link are pivotally connected to the push rod and to the actuation rod, respectively, and it extends substantially vertically between the push rod and actuation rod. One end of the second link is fixedly attached to the first link at a point between its ends, and the other end of the second link is fixedly attached to the push rod, so that the second link angles up from the push rod to its connection to the first link. The second link is made from a material with a thermal expansion coefficient different from that of the push rod, so that the push rod and the actuation rod expand at different rates. When the push rod changes in length due to thermal expansion, the length of the second link also expands, but at a greater rate than the push rod. The second link is now longer than it was, and because it is fixedly attached to the push rod and to a point on the first link, and the first link is rotatably attached to the push rod, the second link pushes the first link to a tilted angle. But the connection point between the first link and the actuation rod still stays where it was, causing the mirror tilt angle to remain unchanged, despite the thermal expansion of the push rod.

Another system described herein is the deployment vehicle useful for constructing a linear Fresnel collector, the deployment vehicle comprising: (a) a chassis; (b) at least one reflective laminate sheet disposed on said vehicle; (c) a tool disposed on said vehicle selected from the group consisting of: (i) means for cutting reflective laminate sheets; and (ii) means for attaching reflective laminate sheets to ground connections, wherein the chassis provides a means for moving the vehicle along the length of the mirror while deploying the reflective laminate sheet. The deployment vehicle can also comprise installation tools for attaching the reflective laminate sheet to a ground connection. The deployment vehicle can carry a reflective laminate sheet in the form of a roll on a roll carrier for unwinding reflective laminate sheets from the roll. In addition, the deployment vehicle can comprise a main sliding frame, which carries the roll carrier, wherein the roll carrier can be moved up and down vertically relative to the main sliding frame. Further, the deployment vehicle can comprise: (a) a carriage, which carries the main sliding frame; and (b) a track operationally connected to the carriage, wherein the carriage can move along the track carrying the main sliding frame in order to position the roll carrier as required to install the reflective laminate sheet. Also in embodiments, the carriage can move along the track to move the main sliding frame and roll carrier to a retracted position over the chassis. Further the deployment vehicle can comprise outrigger wheels on the end of the track opposite the chassis to support the track and prevent tipping. The deployment vehicle can also comprise means for making the reflective laminate sheets and/or forming means for forming features out of the nominal plane of the reflective laminate sheet, such as edge features along the long sides of the reflective laminate sheet(s) that are sized and shaped to engage with interlocking features of ground connections for the sheet(s). In addition, the deployment vehicle can be robotically controlled using robotic control systems known to the art.

When elements discussed herein are described as being attached or connected to other elements or “operationally secured” to such elements, they can be directly attached to the other elements, or formed integrally therewith, e.g., by molding or soldering, or can be indirectly attached to the other elements through intervening components. An “operational” connection between elements can be a fixed connection wherein the elements do not move relative to each other, or a movable, e.g., pivotable, connection wherein the elements are in movable relation to each other. When a component is described herein as comprising another component, the other component can be formed integrally with such component, or directly or indirectly attached thereto.

### BRIEF DESCRIPTION OF THE FIGURES

FIG. 1 is a perspective view of a linear Fresnel collector made by the methods described herein.

FIG. 2 is a plot showing an estimate of mirror deflection under wind load as a function of tension for mirrors having a 7.5 m span, a 10 m span and a 12.5 m span.

FIG. 3 is a side cross-sectional view of a reflective laminate sheet used herein.

FIG. 4 shows the effect of applying tension to a reflective laminate sheet.

FIG. 5 shows the effect of applying tension to a set of discrete tension-bearing strips connected in parallel.

FIG. 6 shows a cross-section of a reflective laminate sheet including tension-bearing wires.

FIG. 7 shows a cross-section of a reflective laminate sheet including tension-bearing strips.

FIGS. 8A and 8B show mirror supports for the collector.

FIGS. 9A and 9B show simplified renderings of mirror supports.

FIG. 10 shows a perspective view of a line of mirror supports for the present linear Fresnel collector, in relation to a receiver.

FIG. 11 shows a rib mounted on a mirror support.

FIG. 12 shows the mirror supports of FIG. 10, with ribs mounted.

FIG. 13 shows the mirror formed by mounting a length of reflective polymer film on the ribs of FIG. 12.

FIG. 14 shows a detailed view of a weight used to apply tension to the mirror of FIG. 13.

FIG. 15 shows an alternative means of applying tension to the mirror using a spring.

FIGS. 16A, B, C, and D show the configuration of the mirror tension weight under various conditions.

FIGS. 17A, B, C, and D show the configuration of the mirror tension spring under various conditions.

FIGS. 18A-18F illustrate the mirror actuation system for moving the tilt angle of the mirrors to track the sun. FIGS. 18A, B, C, D, and E show cross-sectional views of configurations of the present linear Fresnel collector actuation mechanism for various sun positions. FIG. 18F shows the views of FIGS. 18A-18E respectively on a single page for visual comparison.

FIGS. 19A and B are close-up perspective views of collectors shown in FIGS. 18A-18F, showing the support, tension, and actuation mechanisms at the fixed and tension ends of the collector, respectively. FIG. 19C shows a close-up of an actuation unit near the fixed end of the collector shown in FIG. 19A. FIG. 19D shows a close-up of an actuation unit near the tension end of the collector.

FIGS. 20A, B, C, and D show side views of the configuration of ribs and actuation mechanisms at the tension end of the collector under various conditions.

FIGS. 21A and B show cross-sectional views of an alternative actuation mechanism using a tensioned cable operating to focus the mirror for two different sun angles.

FIG. 22 shows a perspective view of a tensioned cable actuation system.

FIGS. 23A and 23B show close-up views of the passive tension-producing counterweight for the cable actuation system.

FIGS. 24A and B show two different positions of a linkage mechanism used to cancel the effects of thermal expansion in the actuation system.

FIGS. 25A and B show a front view and perspective view, respectively, of a simplified mirror rib.

FIGS. 26A and B show a detailed, simplified front view and perspective view, respectively, of a mirror rib.

FIGS. 27A-27E show examples of mirror rib configurations useful for different mirror row positions.

FIGS. 28A and B show a front and a perspective view, respectively, of a mirror rib having a top strap for attaching the reflective laminate sheet.

FIGS. 29A and B show a front and a perspective view, respectively of a mirror rib that includes a reinforcing buttress, having a top strap for attaching the reflective laminate.

FIGS. 30A and B show a front and a perspective view, respectively, of a mirror rib having a mirror interface with cut-outs for attaching a mirror sheet using clips.

FIGS. 31A and B show a front and a perspective view, respectively, of the mirror rib of FIG. 30, having a mirror top strap that includes cut-outs for clips.

FIG. 32A shows a side view of a rib with clips in place. FIG. 32B is a cross-sectional view of the rib taken along line A-A of FIG. 32A. FIG. 32C shows an enlarged section of an end of the rib with clips in place.

FIG. 33A shows an example clip for attaching a reflective laminate sheet to a rib. FIG. 33B shows an alternative embodiment of a clip.

FIGS. 34A and B show ray tracing analyses for a linear Fresnel collector mirror with a fixed focal length. FIG. 34A shows the analysis performed at a sun angle of 34°. FIG. 34B shows the analysis performed at a sun angle of −69°.

FIG. 35 shows a plot indicating the optimum focal length as a function of sun position for a linear Fresnel collector.

FIGS. 36A and B show ray tracing analyses for a linear Fresnel collector mirror with a focal length that varies to match the optimum focal length shown in FIG. 35.

FIG. 37 is a plot showing a comparison of horizontal aperture widths required to intercept a full reflected beam for mirrors with fixed vs. varying focal lengths.

FIGS. 38A and B show a front and a perspective view, respectively, of a self-adjusting rib that passively adjusts its focal length.

FIGS. 39A and B show a front and a perspective view, respectively, of the self-adjusting rib of FIG. 38, with the first main plate removed to show the internal mechanism.

FIGS. 40A and B show a front and a perspective view, respectively, of a self-adjusting rib having a pivot bearing. FIG. 40C shows a detailed, enlarged view of the front of the pivot bearing shown in FIG. 40A. FIG. 40D shows a detailed, enlarged perspective view of the back of the pivot bearing shown in FIG. 40B.

FIGS. 41A and B show a front and a perspective view, respectively, of detailed views of a self-adjusting rib comprising a pulley. FIG. 41C shows a detailed, enlarged view of the front of the pulley shown in FIG. 41A. FIG. 40D shows a detailed, enlarged view of the back of the pulley shown in FIG. 41B.

FIGS. 42A and B show a lower perspective and a side view, respectively, of a self-adjusting rib having pulleys and pulley straps. FIG. 42C shows a detailed, enlarged lower perspective view of the pulley shown in FIG. 41A. FIG. 42D shows a detailed, enlarged side view of the pulley shown in FIG. 42B.

FIGS. 43A and B show flat and wrapped views, respectively, of the primary pulley straps of the self-adjusting rib. FIGS. 43C and D show flat and wrapped views, respectively, of the secondary pulley straps of the self-adjusting ribs.

FIG. 44A shows a perspective view of the self-adjusting rib installed in a linear Fresnel collector, and connected to a push rod via a horizontal support rod. FIG. 44B shows a detailed view of the horizontal support rod comprising a slot.

FIGS. 45A-E show different positions of the self-adjusting rib as it is moved to various sun-tracking angles.

FIGS. 46A-E show different self-adjusting ribs having different configurations for different mirror row positions. FIGS. 46A₁-E₁ show details of the rotatable pivot bearings of the ribs shown in FIGS. 46A-E respectively.

FIG. 47 shows a plot of desired vs. achieved mirror tip positions as a function of sun angle for a first self-adjusting rib.

FIG. 48 shows a plot of desired vs. achieved mirror tip positions as a function of sun angle for a second self-adjusting rib.

FIGS. 49A and B show side and top views, respectively, of a schematic diagram showing a first roll-to-roll manufacturing process for producing rolls of reflective laminate sheets with contiguous backing.

FIGS. 50A and B show side and top views, respectively, of a schematic diagram showing a second roll-to-roll manufacturing process for producing rolls of reflective laminate sheets with discrete tension-bearing wires or strips.

FIG. 51 shows the row of mirror supports of FIG. 10, with ribs mounted using temporary locking brackets.

FIGS. 52A and B show side and top views, respectively, of a mirror deployment vehicle.

FIGS. 53A, B and C show different positions of the mirror deployment vehicle attaching the mirror sheet to a rib as it passes.

FIG. 54A shows the deployment vehicle having advanced past the final rib in a line. FIG. 54B shows the deployment vehicle having placed a temporary tension clamp in position for cutting the reflective laminate sheet. FIG. 54C shows the end of the reflective laminate sheet after the mirror deployment vehicle has passed.

FIG. 55A is a side view of the deployment vehicle showing its attachment deck rotating from its deployed position to its stowed position. FIG. 55B is a top view of the deployment vehicle shown in FIG. 55A.

FIG. 56 shows a side cross-sectional view of a reflective laminate sheet with formed edges.

FIG. 57 shows a roll-forming device added to the mirror roll carriage of the deployment vehicle to form the edges of the reflective laminate sheet at the time of installation.

FIGS. 58A, B, and C show mirror rib designs of FIG. 29 with additional features for holding and orienting a reflective laminate sheet with formed edges.

FIG. 59 shows a pivot cam embodiment of the self-adjusting rib curvature adjustment mechanism for adjusting mirror curvature in mechanical response to the actuator tilting the mirror to track the sun.

FIGS. 60A and B show the embodiment of FIG. 59 in action.

FIG. 61 shows a pivot cam with a cam groove designed for a reflector positioned with respect to a receiver of x=0 m.

FIG. 62 shows a pivot cam with a cam groove designed for a reflector positioned with respect to a receiver of x=12.5 m.

FIG. 63 shows a pivot cam with a cam groove designed for a reflector positioned with respect to a receiver of x=25 m.

FIGS. 64A and B show a perspective view and back perspective view, respectively, of a pivot cam.

FIG. 65 shows a pivot cam embodiment of a self-adjusting rib curvature adjustment system comprising flexure plates for attaching a mirror support to a rib.

FIGS. 66A, B and C show a front view, a perspective view and a back perspective view, respectively of a rib main plate.

FIGS. 67A and B show a front view and perspective view, respectively, of the rib main plate shown in FIGS. 66A, B and C after the addition of a pivot cam and actuation bearing.

FIG. 68 shows a compliant mirror support.

FIG. 69 is a close-up view of the underside of a compliant mirror support equipped with cam-following fingers having cam-following pins.

FIGS. 70A and B show a front view and a perspective view, respectively, of a rib with an attached compliant mirror support comprising a pivot cam, extension tabs and flexure plates.

FIG. 71 shows a close-up view of a flexure plate attaching a compliant mirror support to a rib main plate.

FIG. 72 shows a close-up view of a pivot cam having a cam groove extension, for a reflector position with respect to a receiver of 0=0 m.

FIGS. 73A and B show front and perspective views, respectively of an assembled self-adjusting rib curvature adjustment system.

FIGS. 74A and B show front and perspective views, respectively, of an assembled self-adjusting rib curvature adjustment system comprising a top strap.

FIG. 75 shows second and third order functions as example deflection shapes of the mirror support.

Exemplary embodiments are illustrated in referenced figures of the drawings. It is intended that the embodiments and figures disclosed herein are to be considered illustrative rather than limiting.

### DETAILED DESCRIPTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Provided herein is a design of a linear Fresnel collector for collecting solar energy. The collector comprises an array of long linear mirrors, which have a nominally parabolic curved cross section. The terms “nominal” or “nominally” as used herein in reference to an amount or quality of an element being described mean that the actual amount or quality may vary from the theoretical or average amount or quality that is being described, but not so greatly that the element fails to function for its intended purpose. The term “collector” as used herein refers to one or more mirrors positioned to focus on a single receiver. The term “mirror” is used to refer to one or more mirror sheets after installation to form a contiguous, or substantially contiguous, reflective surface. A “mirror sheet,” also referred to herein as a “reflective laminate sheet,” is a continuous sheet of reflective laminate material. A collector can comprise an array of mirrors arranged in rows. The mirrors of linear Fresnel collectors are longer than they are wide. A “mirror row” as used herein can be a single such long mirror or two or more such mirrors arranged end to end. A “mirror array” consists of two or more parallel mirror rows. When mirror rows are arranged so as to focus on a single receiver, the array is referred to as a “collector.” A “solar field” comprises one or more solar collectors.

In operation, each mirror is oriented to reflect incident sun rays onto the receiver, heating a fluid contained therein. The reflective surface of each mirror is made from a reflective laminate sheet. The long axis of each mirror and its reflective laminate sheet is parallel to the receiver tube of the collector. The collector can optionally include a secondary reflector.

Provided herein is also a process for manufacturing said linear Fresnel collectors, in particular their mirrors and actuation system. In an embodiment, the process uses continuous rolls of reflective laminate sheet for manufacturing collectors in an efficient process that produces very long mirrors in a single linear deployment operation.

The following sections will explain aspects of the solar collector provided herein by presenting specific examples. It should be understood that all details are exemplary only, and modifications to and equivalents of specific details readily apparent to one of ordinary skill in the art still fall within the spirit of the claims hereof.

### 1. Apparatus Description

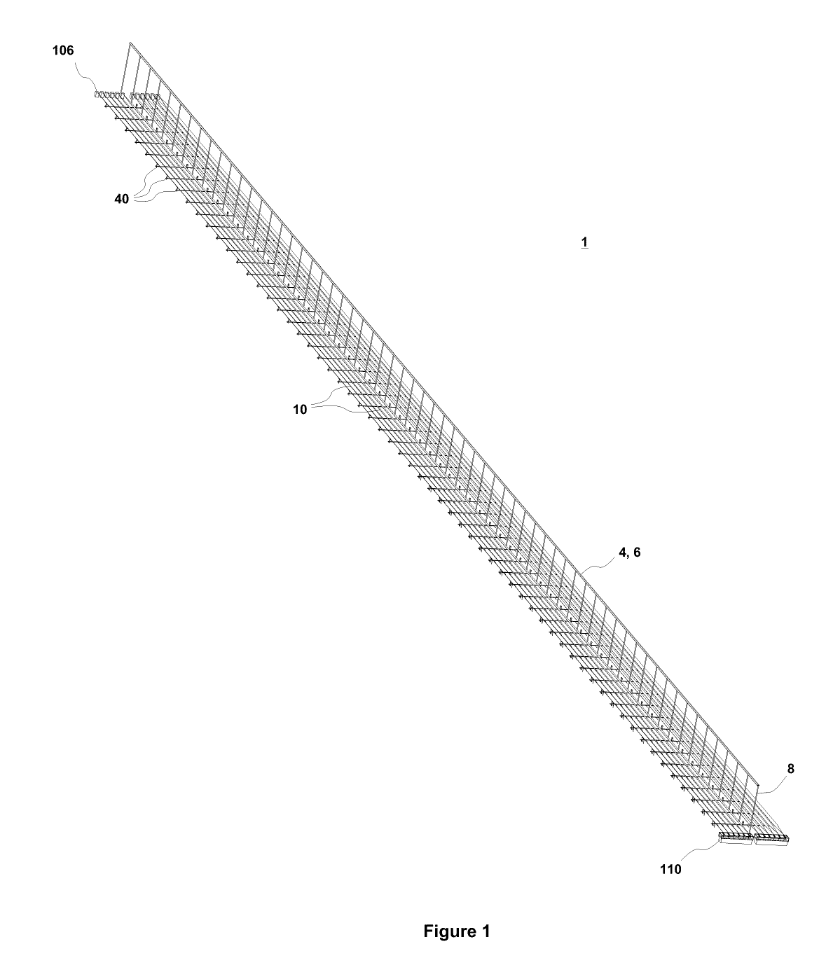

FIG. 1 shows a perspective view of an example linear Fresnel collector 1 provided herein. The receiver 4 and its optional secondary reflector 6 are mounted on receiver supports 8 attached to the ground 2. In this example, the mirror array comprises six long, adjacent mirrors 10 on each side of the receiver 4. The reflective surface of each mirror 10 is made from a laminate reflective sheet 60″ wide; the thickness and composition of this laminate are explained shortly. Each mirror 10 is attached to the ground 2 via a series of mirror supports 40, with each mirror held in place along its length by a fixed mount 106 at one end and a tension device 110 at the opposite end. The linear Fresnel collector's economic performance increases as it is made longer; in this example the length of the active area of the collector mirrors is nominally 600 meters.

### 1.1. Reflective Laminate Sheet Under Tension

The great advantage of this design over previous designs is that it eliminates the space frame and compressive elements used previously. The space frame is eliminated by applying tension in the long axial direction to stabilize the reflective sheet. The compressive elements are eliminated by using the Earth as a compressive element to provide the reaction force to the sheet tension.

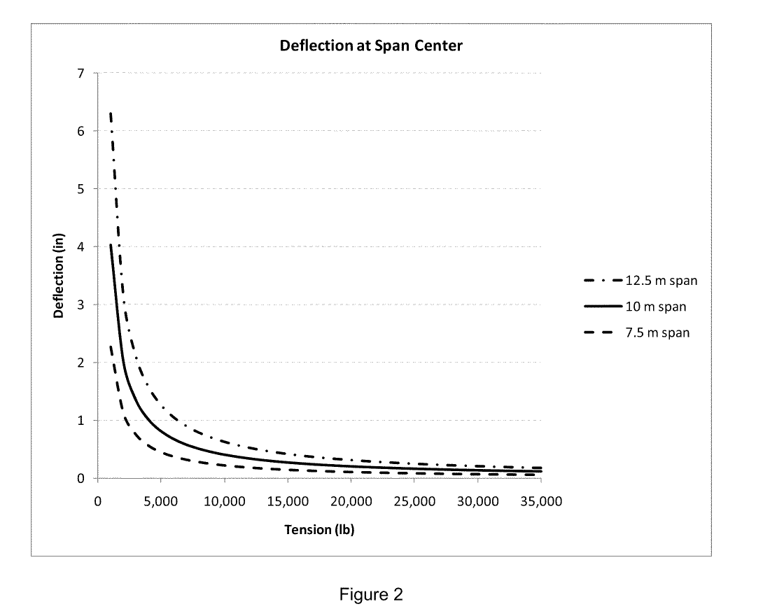

FIG. 2 plots a simplified analysis of sheet deflection vs. tension for materials of different length spans between supports. Each curve shows the deflection that would result from a long sheet of inelastic material held under tension and subject to a load that is uniform along its length. In this example, a sheet 60 inches wide is assumed, subject to a constant load of 0.5 lb/ft² perpendicular to the sheet. The deflection is estimated using classical beam theory. While the real physical system is much more complex, this simplified analysis demonstrates important relationships between tension, deflection, and the length of the span between support points. For example, the plot indicates that deflection drops dramatically as tension is increased, and that increasing the distance between supports increases the deflection. It further demonstrates that high tension values are required to drive deflection to small values. For the 60-inch sheet width considered here and an example 10 meter span between supports, the tension required to reduce deflection below 0.5 inches is estimated to be nearly 10,000 pounds. To achieve acceptable optical performance, deflections must be kept lower than this limit.

In the example described herein the tension is 12,000 pounds (or equivalently, a force for unit width of 200 pounds/inch). However, tension as low as 6,000 pounds (100 pounds/inch) can be acceptable in some applications, while others require tension levels of 42,000 pounds (700 pounds/inch) or even higher. All of these tension levels can be achieved by the means described herein, as well as intermediate values within this range. If the sheet width is increased or decreased, the total tension requirement can be scaled accordingly.

Reflective polymer films, such as the film described in U.S. Pat. No. 6,989,924 and U.S. Patent Publication No. 20060181765, are not strong enough to withstand such high tension levels, due to both to their thinness and limited strength.

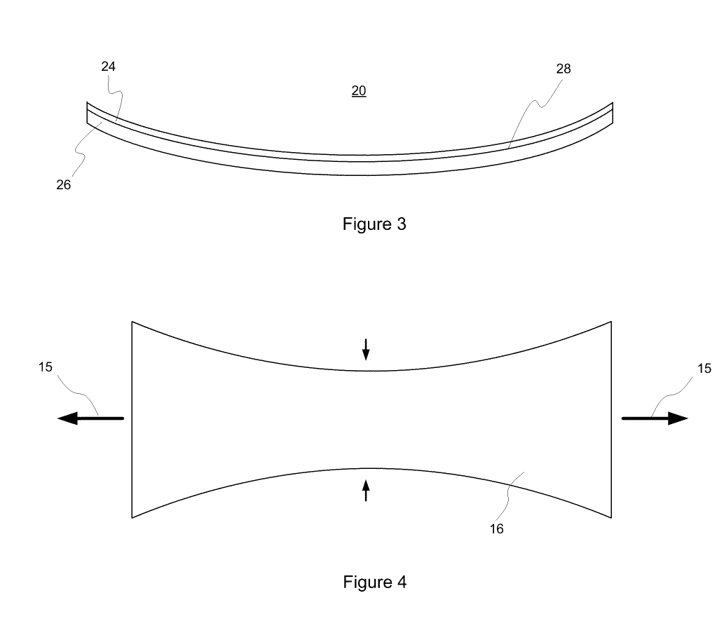

FIG. 3 shows a cross-sectional view of a reflective laminate sheet 20 that solves this strength problem by laminating the reflective polymer film 24 to a backing substrate 26 made of a stronger material using an adhesive interface layer 28. Example backing substrate materials can be aluminum, steel, stainless steel, or durable composites, with thicknesses ranging from about 0.010 inches to about 0.050 inches. In the current example, a backing substrate of stainless steel 0.010 inches thick is sufficiently strong.

FIG. 4 shows the effect of applying a tension force 15 to a sample sheet of material 16. As tension increases, the material elongates. In order to preserve bulk volume and balance internal shear stresses, the material narrows in the middle. This is known as Poisson's effect, and is intrinsic to all materials. For a curved surface such as the example linear reflectors, this can lead to three-dimensional distortions as the material modifies sheet curvature to minimize global internal stress. For this reason, designs which minimize Poisson's effect are preferred.

One method of minimizing such elastic deformations is to minimize elastic effects altogether. For example, choosing a material with a high elastic modulus (such as stainless steel with an elastic modulus of 28×10⁶ psi) and increasing material thickness (for example, to 0.025 inch) both serve to reduce elastic strain and therefore Poisson's effect.

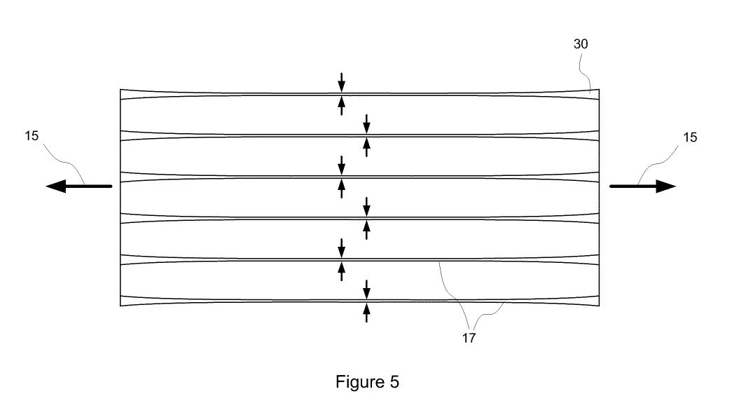

Another method for reducing Poisson's effect while simultaneously reducing material content, weight, and cost is to produce a reflective laminate using discrete strips of tension-bearing material. FIG. 5 shows an example in which six tension-bearing strips 30 can be used to reinforce the laminate material (not shown). When tension is applied, each strip 30 individually narrows at its middle, according to Poisson's effect. But the aggregate shape of the entire system narrows almost not at all, and the global shape defined by the ensemble of strips is virtually unchanged.

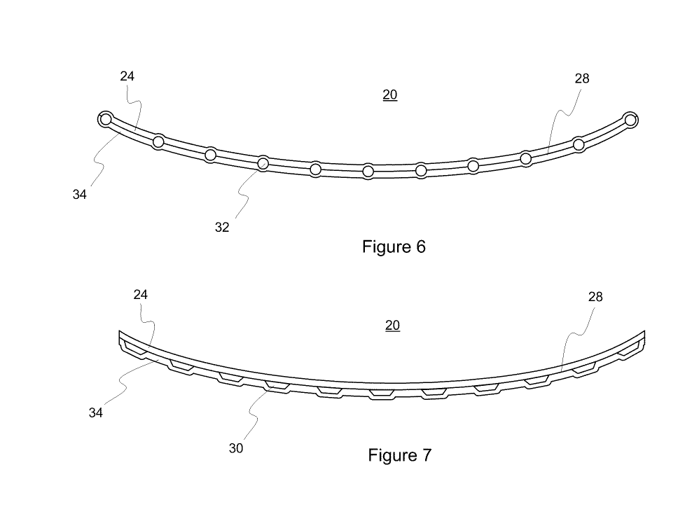

FIGS. 6 and 7 show reflective laminate designs based on this principle. Note that material thickness is exaggerated for clarity. In FIG. 6 the strips are round wires 32, which are commonly available in a variety of materials, such as aluminum, steel, stainless steel, Kevlar, and other durable fibers. In FIG. 7 the strips are flat strips 30 of material. Such strips are also available in a variety of materials, including aluminum, steel, stainless steel, Kevlar, woven Dacron, and the like. Further, materials can be acquired in great lengths, rolled onto spools.

These wires 32 or strips 30 are laminated between the reflective polymer film 24 and a backing material 34, by means of an adhesive interface layer 28. The backing material 34 can be any of a variety of durable materials. The backing material 34 advantageously has an elastic modulus significantly lower than the wires or strips, at least ten times lower but preferably more than 25 times lower, or even more preferably more than 50 times lower. A variety of durable outdoor polymeric materials can be used as the backing material, e.g., acrylic and polyethylene terephthalate. The materials should be somewhat elastic so that they can respond to tension in the similar way as the reflective polymer film. A suitable backing would be the polymeric backing used for the reflective layer described in U.S. Patent Publication No. 20060181765 for “Advanced Ultraviolet-resistant Silver Mirrors for use in Solar Reflectors,” published Aug. 17, 2006, incorporated herein by reference to the extent not inconsistent herewith. The backing material for this embodiment is different from the backing material used when no embedded strips are used. In the case when no strips are used, the backing material must bear the load when tension is applied. In the case when strips are used, the backing material should be softer. In the strip embodiment, the backing material and its thickness should be chosen so that the effective stiffness of the embedded strips is much greater than the stiffness of the reflective laminate sheet without the strips. For example, when the strips are made from high-strength stainless steel 0.125 inches wide by 0.025 inches thick, an ensemble of 61 such strips embedded at 1-inch intervals along a 60-inch reflective polymer film sheet width has a total cross-sectional area of 0.19 in². When these strips are embedded between sheets of polymer film each 0.005 inches thick and 60 inches wide, the cross-sectional area is 0.6 in². But the much higher elastic modulus of the stainless steel material causes the total resistance to elongation of the ensemble of steel strips to be approximately 25 times higher than the pair of polymer film layers. Thus the stainless steel strips carry nearly all of the tension load, and result in a very small elongation compared to the polymer film's stiffness properties. Thus elongation is dominated by the effect shown in FIG. 5, minimizing Poisson's effect on the contiguous reflective film spanning across tension-bearing strips 30.

Further reductions in Poisson's effect are achieved by increasing the width of the strips. In the previous example of 0.125 inch strips placed at 1 inch intervals across the 60-inch sheet width, the ratio of strip width to unsupported film gap is 1:7. The ratio illustrated in FIG. 7 is close to 1:1. Increased ratios such as 7:1 or even higher can also be used. As strip width increases, Poisson's effect is further diminished, and higher ultimate tensions can be achieved, increasing optical stability in the presence of external disturbances. However, material utilization and weight also increase. Choosing an appropriate strip width can be optimized based on application requirements.

The present examples employ stainless steel strips of 0.025 inch thickness. The width of the strips can range from about 0.125 inches to about 0.875 inches, all embedded in the laminate reflective sheet at 1 inch intervals. A width of 0.5 inches is advantageous because the resulting 1:1 ratio yields equal strip and film gap widths, which results in desirable optical properties. Material temper is chosen to ensure that strip yield strength is not exceeded under nominal tension or momentary increased stress due to wind gusts. For example at tension levels of 12,000 pounds, strip widths near the low end of the above range require high-strength temper.

An advantage of this design is that the reflective laminate sheets described above are produced in great lengths using well-known roll-to-roll manufacturing methods, resulting in rolls of material that can be efficiently transported to the point of installation in a compact format. Section 2 will describe an efficient installation method based on these rolls of reflective laminate sheets.

In the sections that follow, we will sometimes refer to the reflective laminate sheet as a “mirror sheet” for brevity. The term “mirror” is used to refer to the mirror sheet when it is installed.

### 1.2. Linear Mirror

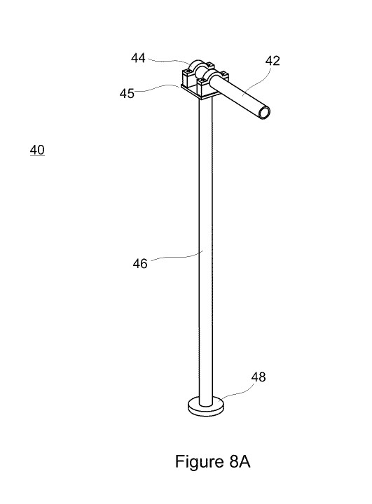

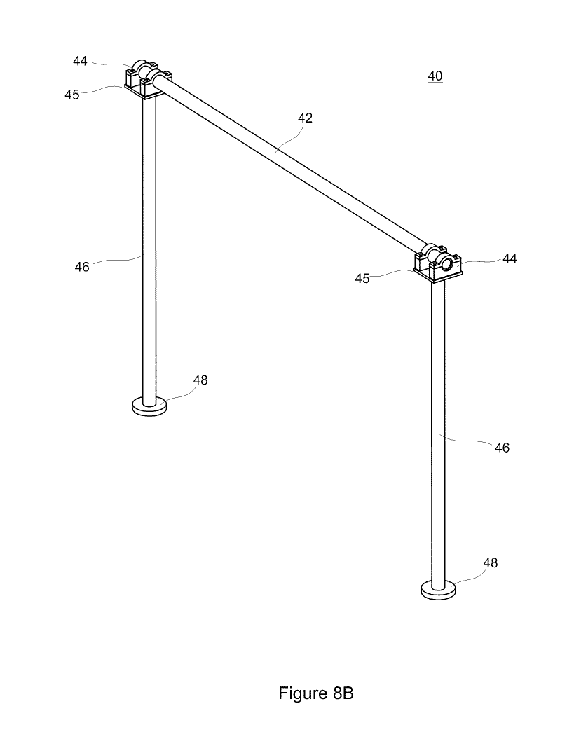

The reflective laminate sheet described above provides the reflective surface which reflects the sun's rays onto the receiver 4 shown in FIG. 1. In order for this to be effective, the sheet must be held in position, with the proper cross-sectional shape and orientation while maintaining proper tension over a range of environmental conditions. FIGS. 8-17 explain the components that achieve this.

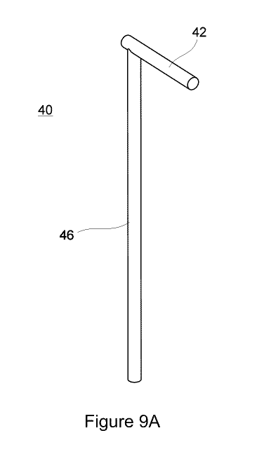

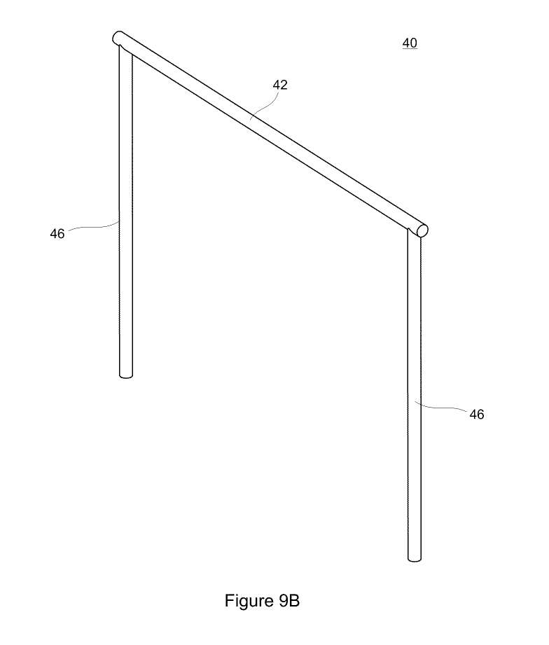

FIGS. 8A and 8B show the mirror supports 40, comprising one or two vertical support poles 46, a horizontal support rod 42, an alignable attachment device 44, and a ground attachment interface 48. These supports can be made in a variety of ways, but in this example, the vertical poles 46 are 2-inch steel pipe, embedded in concrete pads for a ground interface 48. A flat steel pad 45 is welded to the top of the support to support the alignable attachment device 44. The horizontal support rod 42 is a stainless pipe with a 2-inch outer diameter and smooth surface. The horizontal support rod 42 is connected to the vertical pole(s) 46 by an alignable attachment device 44, which in this example is a pair of pillow blocks attached with loose-fitting holes or slots and shims to adjust the horizontal support rod 42 to the desired position and orientation. FIG. 8A shows a single-pole support, while FIG. 8B shows a double-pole support. These are used in the portions of the mirror nearer the fixed and tension ends, respectively, as explained below. The manufactured length of the horizontal support rod 42 can vary from as low as 10 inches to over 7 feet for the current example, depending on the support's position along the mirror from the fixed end to the tension end. FIGS. 9A and 9B show the same support devices, rendered in a simplified form for clarity. This simplified rendering is shown in many of the following figures for clarity, but it will be understood that the more complex design of FIGS. 8A and 8B may be employed, as well as other variations apparent to one of ordinary skill in the art without undue experimentation.

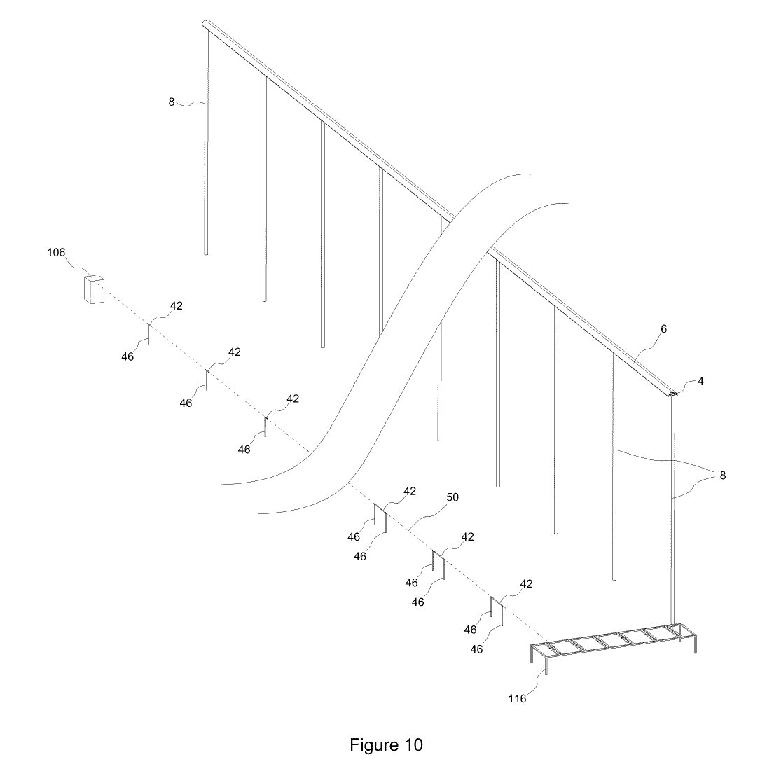

FIG. 10 shows the supports in place for an example linear mirror. The vertical poles 46 have been installed in the ground, and the horizontal support rods 42 have been aligned so that their axes lie on a common line 50. This common line 50 forms the tilt axis for the mirror as it tracks the sun. Also shown are the fixed mount 106 and tension device frame 116, which are used to achieve tension.

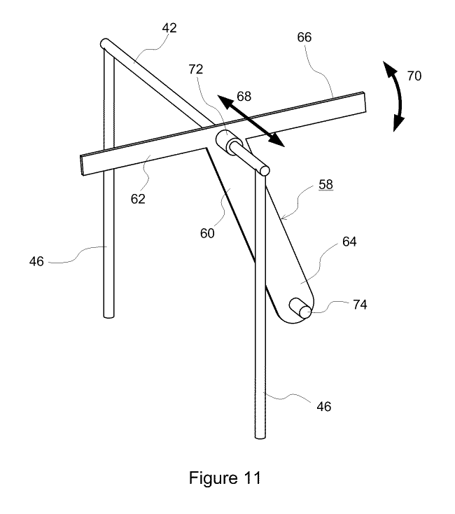

FIG. 11 shows a rib 58 mounted on a support. The rib is shown simplified in this and several following figures. It has a main plate 60, which has a roughly “T” shape including a crossbar 62 and an arm 64. The angle between the crossbar 62 and arm 64 varies depending on the mirror row as explained below. The crossbar 62 includes a mirror interface surface 66 which contacts the mirror sheet and defines its cross-sectional shape. In the example design, the height of this surface above the ground is approximately 1.5 m when the rib 58 is oriented so the crossbar 62 is horizontal.

The rib 58 also includes pivot bearing 72 which surrounds the horizontal support rod 42. The pivot bearing 72 can be integral with the rib main plate 60, or can be a separate part fixedly attached to the main plate 60. The pivot bearing 72 can be made of a variety of materials, but should employ either a material or coating to allow the pivot bearing 72 to move relative to the horizontal support rod 42 without causing wear or galling. For example, the pivot bearing 72 might be made of Delrin™, and then fixedly attached to a steel main plate 60 using any of a number of methods well-known to practitioners of ordinary skill in the art. For example, the pivot bearing 72 might have a threaded portion which extends through a hole in the main plate 60 and is secured by a nut on the other side. Or, the inner cylindrical surface of the pivot bearing 72 might be coated in Teflon™, or contain a Teflon™ or Delrin™ insert.

The interface between the pivot bearing 72 and the horizontal support rod 42 allows two degrees of motion freedom for the rib 58, before other components are installed. The rib can rotate along a rotation freedom 70 to tilt the mirror through a range of angles to track the sun. The rib can also translate along a translation freedom 68 aligned with the axis of the horizontal support rod 42, to account for tension elongation and thermal expansion effects. The length of the pivot bearing 72 and its clearance relative to the horizontal support rod 42 diameter should be chosen so that other motions such as lateral or angular wobbling are substantially eliminated.

The rib 58 also includes an actuation bearing 74. Similar to the pivot bearing 72, the actuation bearing 74 is fixedly attached to the rib main plate 60, in this case at the end of the arm 64. The actuation bearing 74 should include either a material or coating to allow rotational and sliding motion relative to the actuation rod 76, explained below.

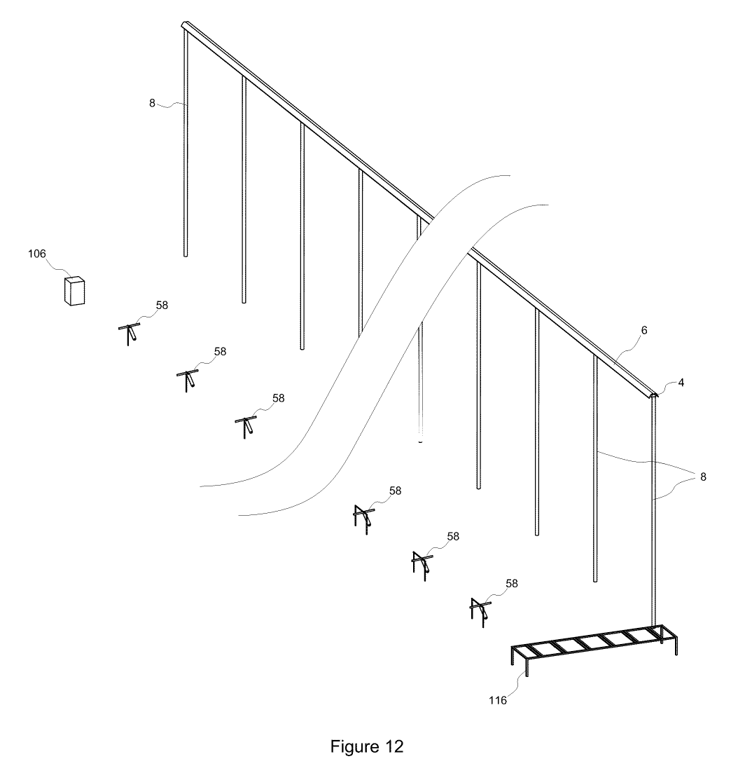

FIG. 12 shows the supports of FIG. 10 with their corresponding ribs 58 in place. Later sections will describe the ribs in more detail.

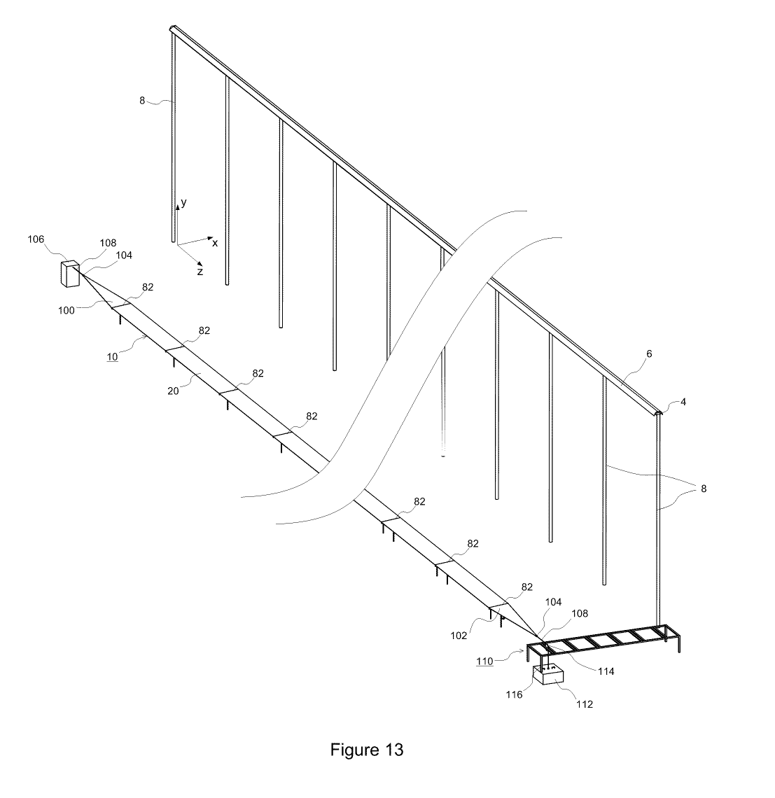

FIG. 13 shows the mirror 10 after attaching a mirror sheet 20 to its supporting ribs. The fixed end 100 of the mirror 10 is attached to the fixed mount 106, which is placed rigidly in the ground 2 in a manner strong enough to resist all expected loads. The mirror sheet 20 is attached to the fixed mount 106 via a cable 108 of adequate strength to support the mirror sheet 20 in tension, such as ¾ inch wire rope. The cable 108 attaches to the mirror sheet 20 by means of a gather clamp 104, which transfers the tension force from the mirror sheet 20 to the cable 108. The gather clamp 104 can be of a variety of designs readily determined by one of ordinary skill in the art without undue experimentation, and can correspond to a gathering of individual mirror strips 30 to a common point as shown in the figures, or a different design can be used in which the mirror shape remains unchanged and load is transferred from the full width of the sheet to a cable attachment point using a rigid bracket.

The interface between the fixed mount 106 and the mirror sheet 20 allows twisting so that the installed mirror can rotate to track the sun. In an embodiment, this is accomplished by simply selecting the length and diameter of the attachment cable 108 so that it provides minimal resistance to torsion. As an alternative, a swivel bearing can be incorporated in the gather clamp 104.

The mirror sheet 20 is attached to multiple ribs along the length of the mirror 10. At each rib, the mirror sheet 20 is held in contact with the rib crossbar mirror interface surface 66 (see FIG. 11), using a top strap 82 described below. By holding the sheet in contact with the rib's mirror interface surface 66, the sheet cross-section is forced to follow the desired optical curve. After tension is applied, the tendency of the embedded tension-bearing strips 30 (see FIGS. 5-7) to maintain a straight line causes the sheet cross-section to follow the desired optical curve throughout the free span between ribs. Gravity sag effects and wind loads can cause displacements from the desired shape, but as demonstrated in FIG. 2 above these displacements can be made very small by increasing tension.

The tension end 102 of the long mirror 10 is opposite the fixed end 100. This end of the mirror 10 is attached to a mirror tension device 110, which maintains desired tension across a range of conditions. As with its attachment to the fixed end, the mirror sheet 20 is attached to the tension device 110 by means of a gather clamp 104 and a length of cable 108. Again these are designed to allow mirror 10 to rotate with a minimum of torsional resistance, either by choosing the length and diameter of the cable 108 so that it will easily twist, or by incorporating a swivel bearing. Also similar to its attachment at the fixed end, the mirror sheet interface with the cable 108 can be accomplished by gathering individual mirror strips 30 to a common point as shown, or by including a rigid bracket which clamps to a full sheet width and transfers the tension load to the cable attachment point.

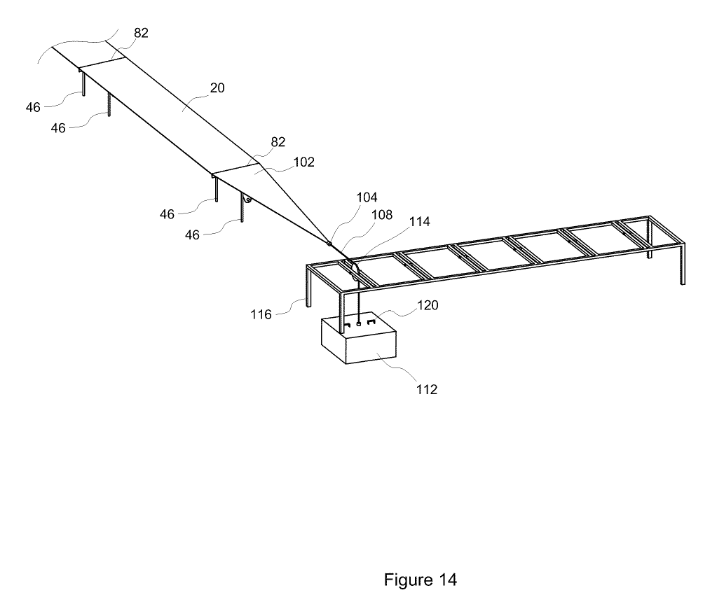

FIG. 13 shows an embodiment of the tension device 110 comprising a tension weight 112 and pulley 114. This is shown in detail in FIG. 14. A rigid frame 116 is fixed to the ground in a manner strong enough to resist all expected loads. A pulley 114 is mounted on this frame, and the tension cable 108 bends around pulley 114 to transform the tension load from a horizontal to a vertical direction. The end of the cable 108 is then attached to a tension weight 112, which under the force of gravity applies the tension force to the cable. The tension weight 112 can be constructed in any of a variety of ways, but in this case is a block of concrete about 63 inches wide in the direction of the length of the mirror sheet, about 72 inches long, and about 31.5 inches high. The tension weight has a total weight of about 12,000 pounds, thus applying about 12,000 pounds of tension to the mirror sheet.

The pulley 114 of the tension device 110 has a diameter chosen to obey the bend radius limitations of the tension cable 108. A minimum diameter is preferred, to provide a compact design and to allow the tension weight 112 to have a higher maximum travel position. In the example design, the pulley diameter is 20 inches. This provides a bend radius compatible with a ¾-inch 6×37 extra flexible hoisting wire rope, which provides a suitable tension cable capable of carrying 12,000 pounds of tension with a significant safety margin.

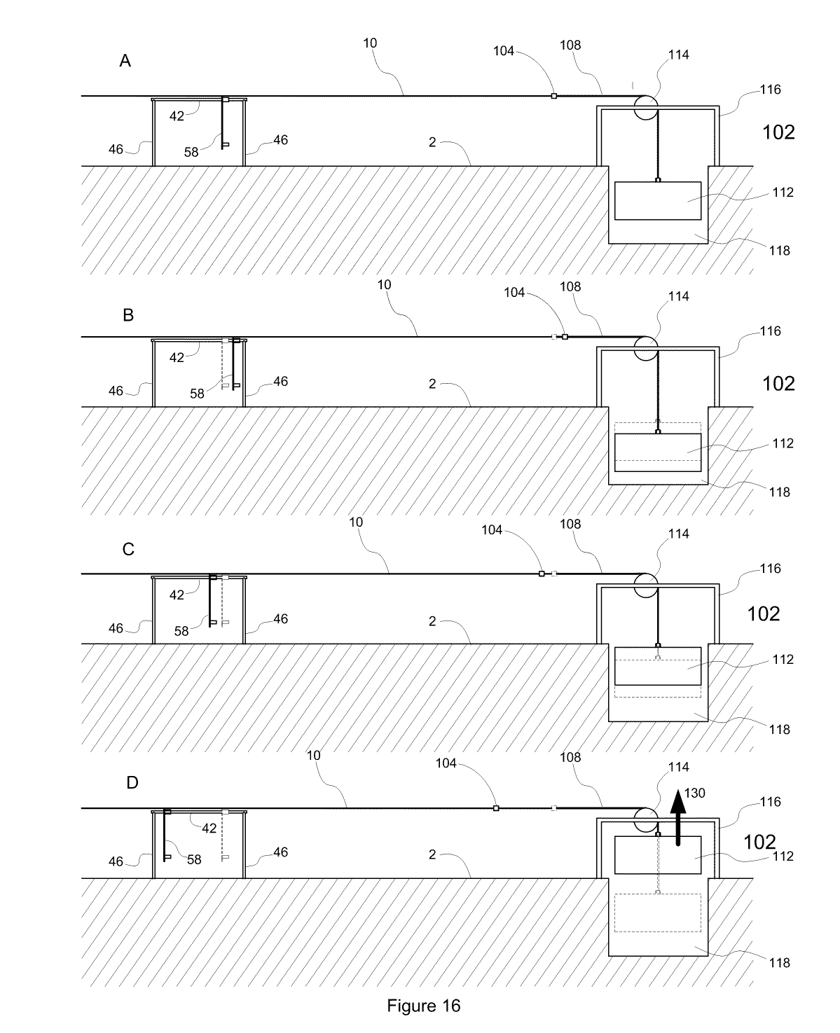

The tension weight 112 includes straps 120, such as forklift straps, and optional hoist rings (not shown) to facilitate handling as described below. Since portions of the tension weight 112 are below ground level, the weight is in a surrounding hole. The tension weight hole is not shown in FIGS. 13 and 14 so that the weight can be more easily seen, but is shown in FIGS. 16A-D and 51 as element 118. Similarly, the figures do not show the ground penetration of various struts, supports, mounts, etc for clarity. These ground penetrations are understood to be present and provide the necessary rigid support, and are easily designed by one of ordinary skill in the art without undue experimentation.

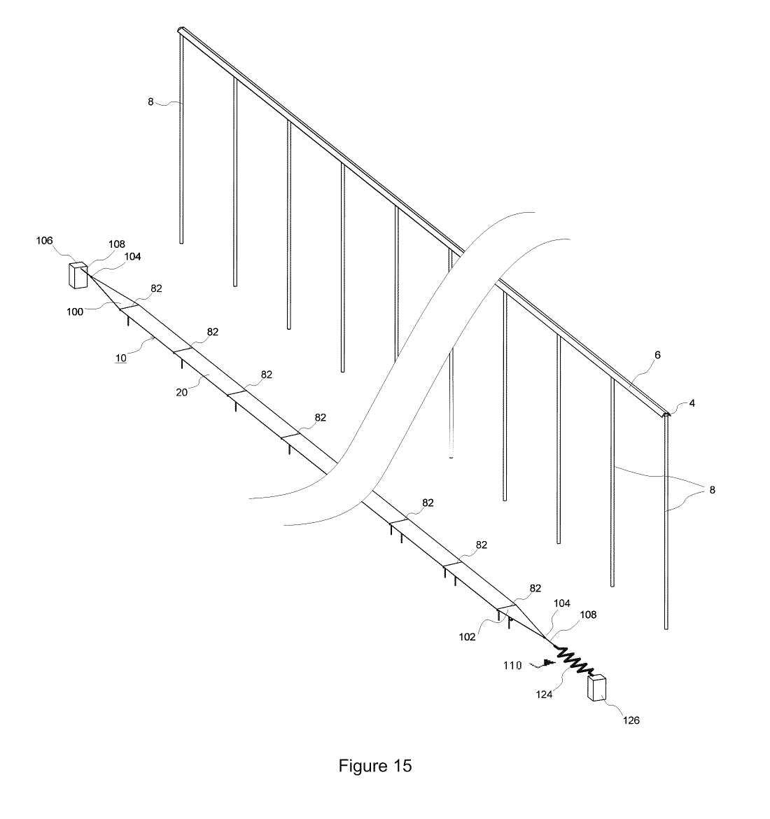

FIG. 15 shows an embodiment of the tension device 110 using a tension spring 124. A rigid second fixed mount 126 is attached to the ground 2 in a manner strong enough to resist all expected loads. The tension cable 108 is then attached to the tension spring 124, which is in turn attached to the second fixed mount 126. The tension spring 124 is preloaded to achieve the desired tension by extending it before attaching it to the mirror sheet 20.

FIGS. 13 and 15 demonstrate two of the key advantages of the present collector. First, by employing a laminate reflective sheet that can withstand large tension forces, the complex, heavy and expensive space frames typical of prior art designs can be eliminated by using tension force to resist wind load. Second, this tension is achieved by using the Earth as the compressive element to provide the reaction force to resist the tension load. This eliminates the heavy and complex compressive elements of previous designs, and also enables much higher tension forces applied over longer distances, because buckling due to slenderness ratio is not a concern.

The tension device 110 must maintain desired tension under a range of operating conditions, particularly over the range of expected ambient temperatures. Recall that each rib has an axial translation motion freedom, allowing it to translate back and forth along the horizontal support rod 42 (see FIG. 11). This motion freedom allows the mirror 10 to expand and contract in response to changes in temperature. The tension device 110 must allow this motion to occur, while maintaining tension.

FIGS. 16A-D show how this is achieved with the tension weight embodiment of the tension device 110. FIG. 16A shows the nominal condition for mirror 10, where it is under tension and the ambient temperature is a nominal 25° C. The tension weight 112 is at an intermediate position along its travel range.

FIG. 16B shows the configuration of the tension device at a high temperature of 50° C. For our 600 m example mirror, thermal expansion will cause the mirror length to grow by 0.25 m. FIG. 16B shows the tension end 102 of the mirror 10 extended by this distance, with the attached rib translating along its horizontal support rod 42. The tension weight 112 has moved down compared to its nominal position, to near the lowest point in its travel range.

Note that there is almost no motion at the fixed end 100 of the mirror 10. The fixed end is held at a constant position by the fixed end cable, and thermal expansion causes ribs 58 along the length of the mirror 10 to translate on their horizontal support rods 42 by a distance commensurate with their distance from the fixed end. The lateral rib translation distance is at a maximum at the rib nearest the tension end 102, as shown in FIG. 16A-D. This is why single-pole supports such as those shown in FIG. 8A can be used close to the fixed end to save material, while double-pole supports as shown in FIG. 8B are preferred near the tension end. The transition from single-pole supports to double-pole supports occurs somewhere along the length of mirror 10, with the crossover point determined by economic and lateral load-bearing calculations straightforward to one of ordinary skill in the art.

FIG. 16C shows the configuration of the tension device at a low temperature of 0° C. Now the mirror 10 has contracted by 0.25 m, and the end rib has again translated by this distance along its horizontal support rod 42, but in the opposite direction. The tension weight 112 is now at a higher position than nominal.

Note that the use of a weight and pulley arrangement assures constant tension across the full range of temperature conditions. Neglecting minor friction effects, the tension applied to the mirror 10 is exactly equal in the low, nominal, and high temperature scenarios, and for all temperatures in between.

FIG. 16D shows the configuration of the tension device during maintenance and installation operations. Here an external device applies a lifting force 130 to hold up the tension weight 112. This lifting force 130 can be applied by a block-and-tackle or winch arrangement attached to hoist rings on the weight (not shown) or by a forklift with forks engaging the forklift straps 120 attached to the tension weight 112. In either case, lifting the tension weight 112 relieves tension from the tension cable 108 and thus also the mirror sheet 20. This allows the mirror 10 to contract to its relaxed length, and the tension cable 108 can be disconnected. For a 600 m mirror made from a reflective laminate sheet comprising 61 embedded stainless steel strips each 0.025 inches thick by 0.125 inches wide, the elongation of the mirror under 12,000 pounds tension is approximately 1.37 m. When the tension is relieved, the mirror shrinks back to its original relaxed length.

FIG. 16D shows the relaxed configuration, with the end rib translated to the left most point in its travel range along the horizontal support rod 42, and the tension weight 112 at the highest point in its travel range. Note that at this point the weight clears both the pulley 114 and the hole 118, allowing a forklift to remove the weight for maintenance purposes. If larger tension weights are desired requiring a larger tension weight height in the z direction, the weight may no longer clear the hole 118 when raised to its highest position. In this case the tension weight 112 can comprise multiple stacked plates which can be removed individually.

The example shown in FIG. 16D corresponds to a scenario with a strip-to-gap ratio of 1:7. If a strip width of 0.5 inches was chosen instead, then the strip-to-gap ratio would be 1:1, and the mirror elongation for the same tension level would be four times smaller. This would in turn require less travel range for both the end rib on its horizontal support rod and the tension weight within its hole. If the tension force is increased, then the required travel range increases commensurately. However, the travel range due to thermal expansion remains the same regardless of the strip width or applied tension force, and can be influenced in the design only by the material selection for the tension-bearing element of the reflective laminate sheet (whether contiguous backing or discrete strips), and by the total mirror length.

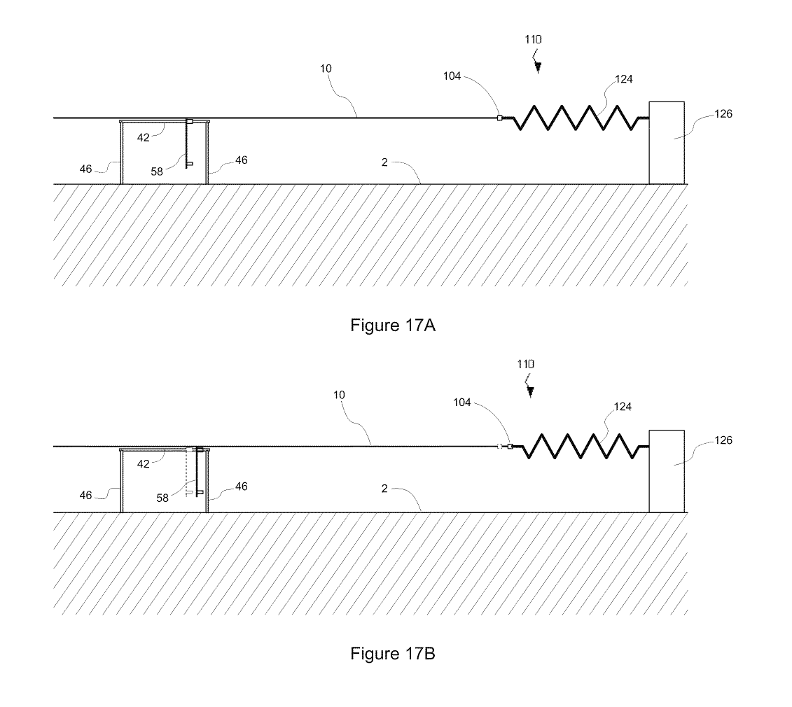

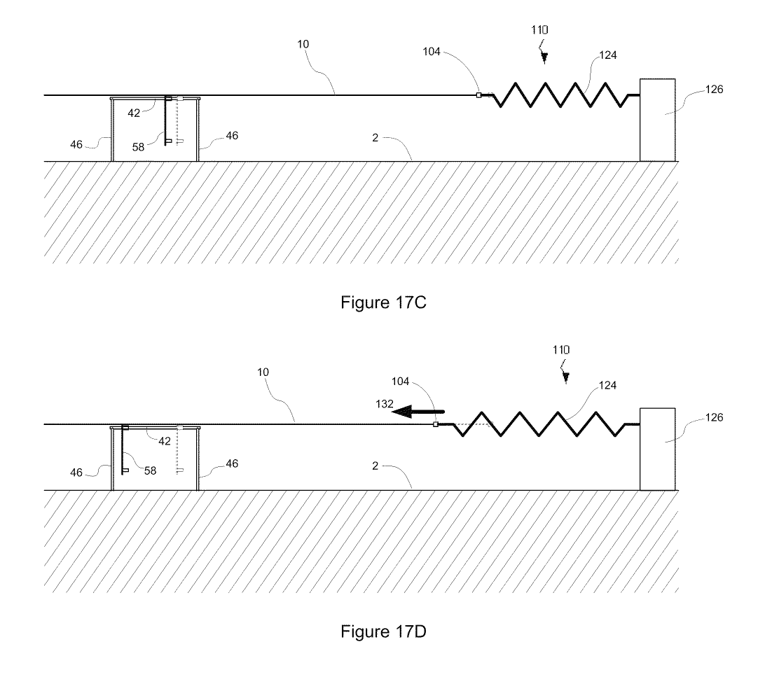

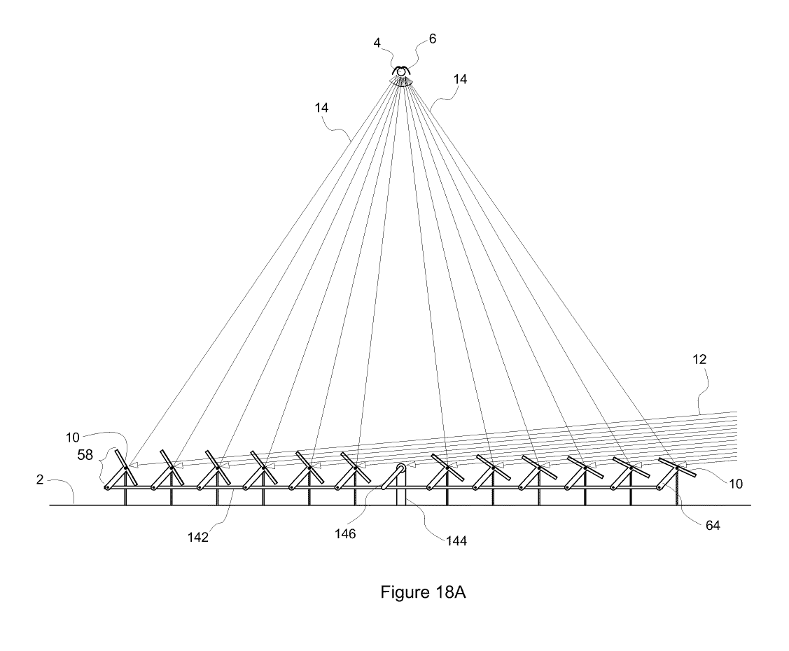

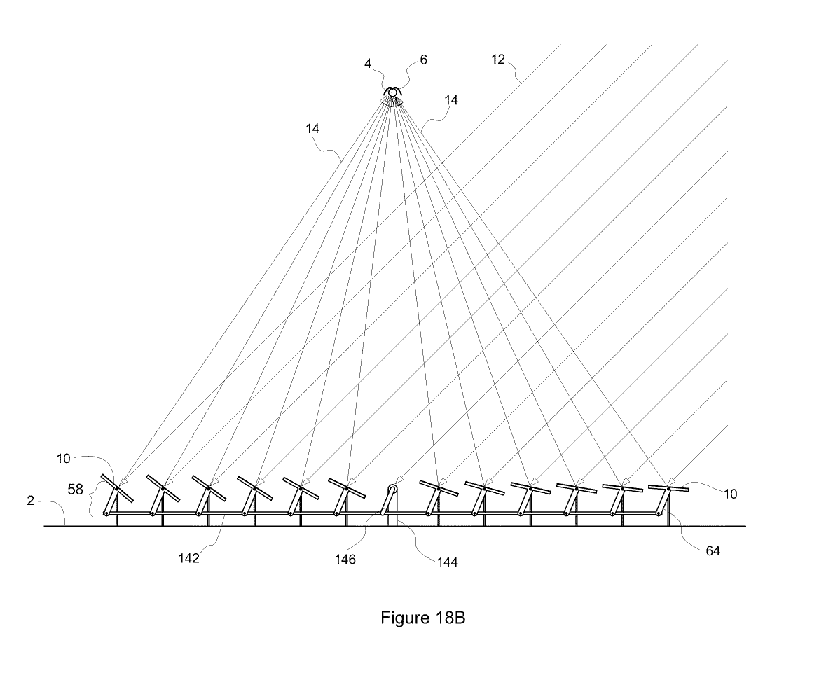

FIGS. 17A-D show how tension is controlled in the tension spring embodiment of the tension device 110. FIG. 17A shows the nominal condition, where the mirror 10 is under tension and the ambient temperature is a nominal 25° C. The tension spring 124 is at an intermediate position along its travel range. FIG. 17B shows the configuration at a high temperature of 50° C. Then expansion of the mirror 10 has allowed the tension spring 124 to contract, reducing its preloaded extension. The applied tension is thus reduced to some degree. FIG. 17C shows the configuration of the components at a low temperature of 0° C. The thermal contraction of the mirror 10 has caused the spring to extend further than its nominal position, increasing tension by some amount. Because variation in temperature causes a change in spring extension and thus applied tension, the tension spring 124 should be designed with this in mind to minimize the change in tension that results from ordinary temperature swings. This can be achieved by decreasing the tension spring's stiffness constant k, thereby reducing the change in force resulting from a given change in spring extension. This then implies that a larger preload extension is required to achieve the desired nominal tension force. This extension must be achievable without exceeding the elastic strain limits of the spring material, which typically can be achieved by increasing the number of coils in the spring. Methods for selecting specific spring parameters to meet these requirements are well-known to those of ordinary skill in the art.

FIG. 17D shows one configuration of the components for mirror installation and maintenance operations. In this figure an external force 132 is applied to the spring to extend it a maximum position that relieves tension on the mirror sheet 20. This causes the end rib to translate to its left-most position as the mirror 10 relaxes, just as in FIG. 16D. The spring can now be disconnected from the mirror 10 for maintenance purposes. This approach is suitable if the tension spring 124 has enough coils to allow this maximum extension without exceeding the elastic strain limit of the spring material. Another approach is to apply an alternative tension force to the mirror 10 to relieve the tension on the spring 124, while simultaneously applying an alternative tension force extending the spring. The spring 124 and mirror 10 can then be disconnected and the applied forces gradually reduced to return each element to its relaxed state.

### 1.3. Sun Tracking Actuation System

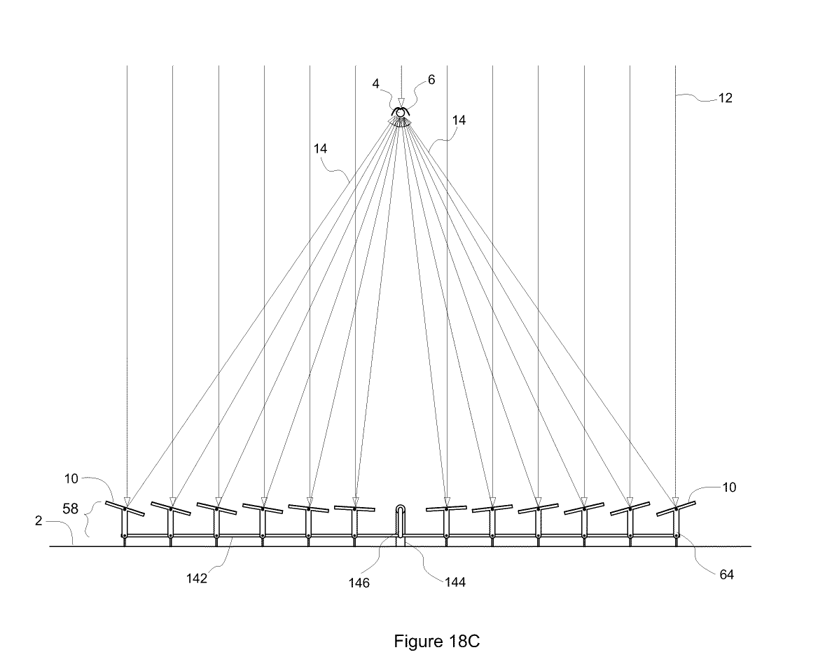

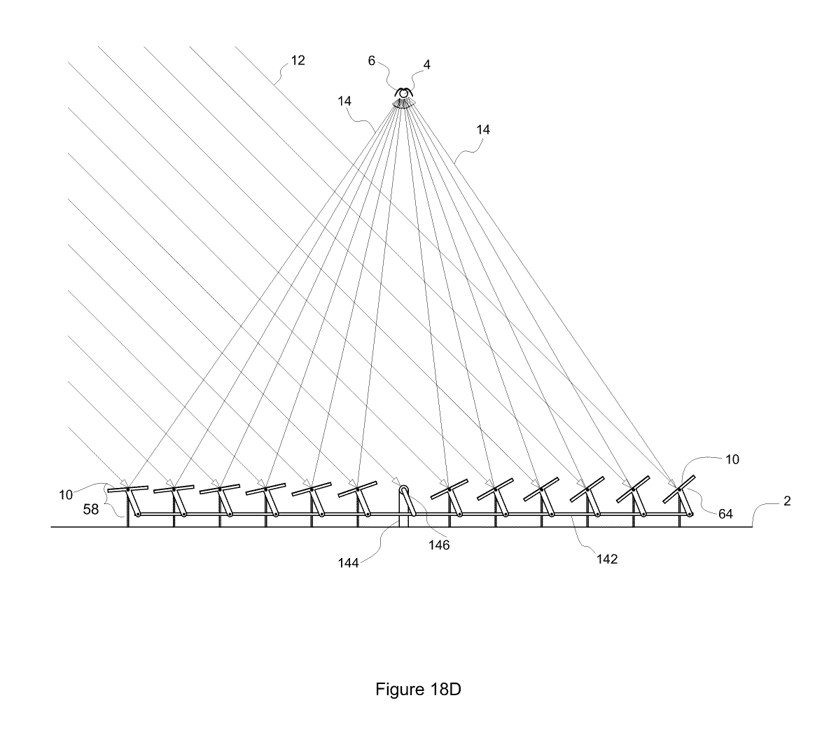

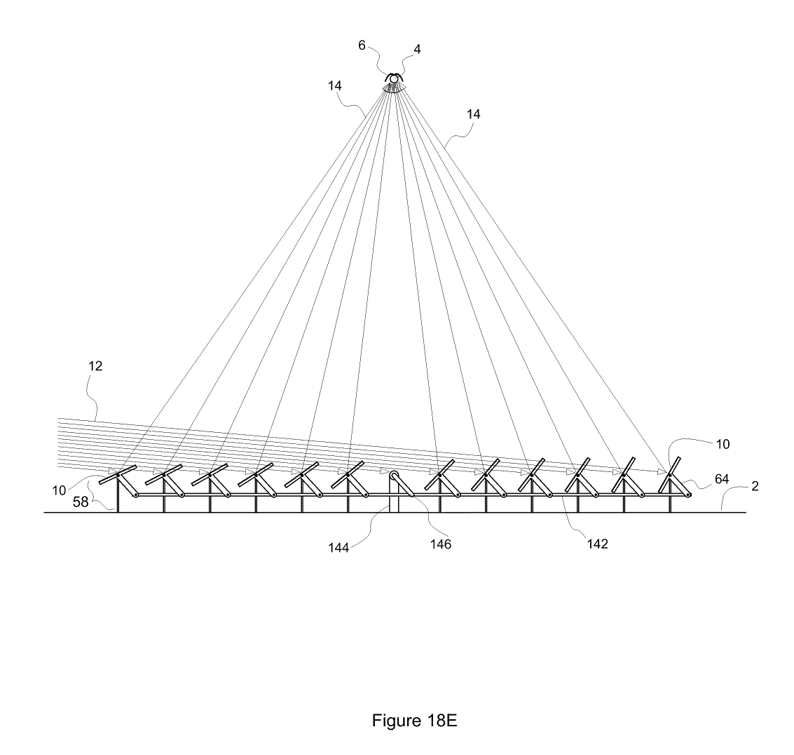

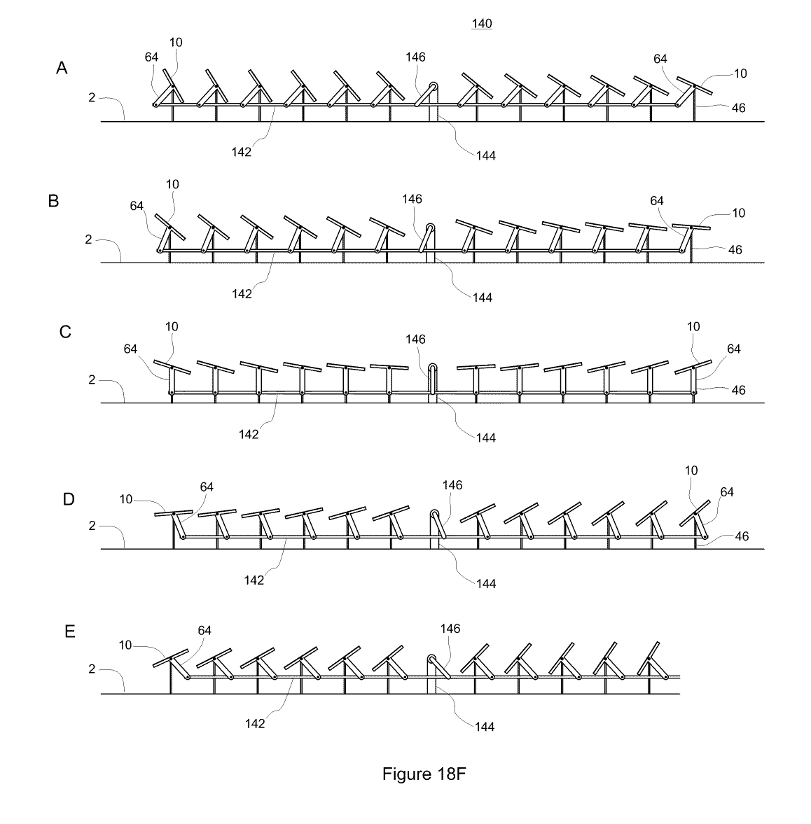

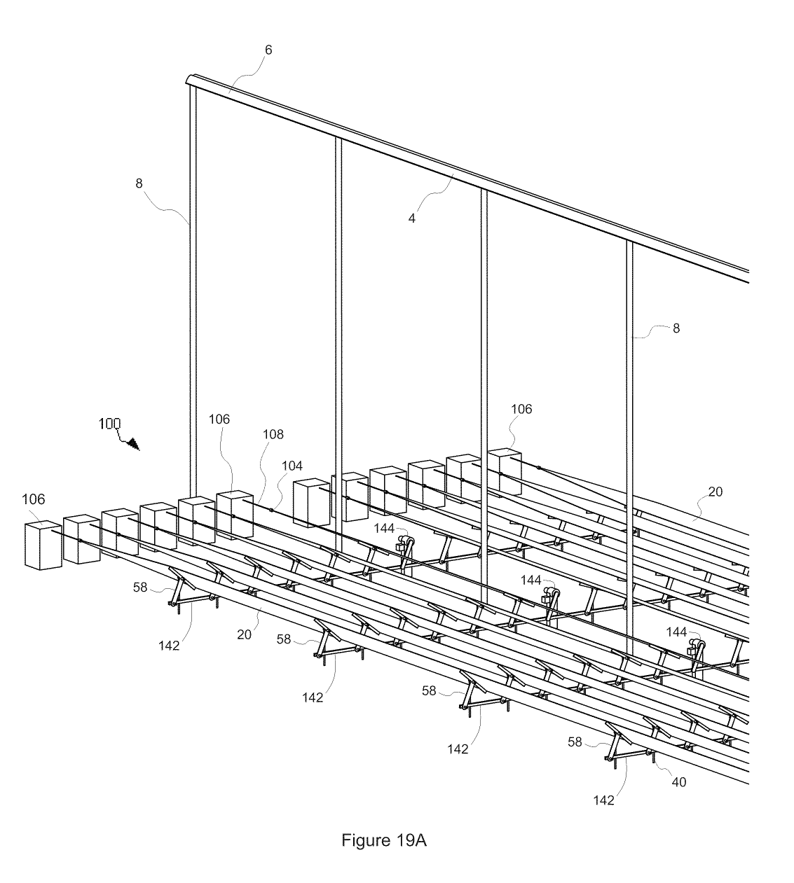

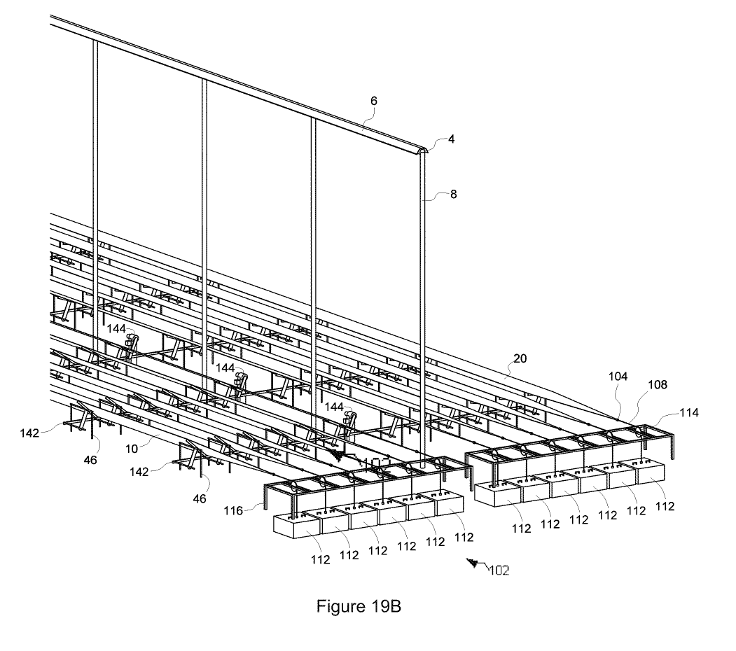

FIGS. 18A-F illustrate the mirror actuation system hereof. FIGS. 18A-E show a cross-sectional view of a linear Fresnel collector in operation for incident sun angles of −85°, −45°, 0°, 45°, and 85°, measured relative to the vertical direction. The linear Fresnel collector 1 requires tilting each mirror so that it reflects incident sun rays 12 onto the receiver 4. The required tilt angle varies throughout the day, and differs for each mirror row. The tilt angles depicted correspond to times of just after sunrise, mid-morning, solar noon, mid-afternoon, and just before sunset, respectively. As can be seen from the figures, the mirror orientations change throughout the day, and each mirror row has a different orientation at any given time.

The relative angle between each mirror row remains constant for all incident sun angles. That is, once each mirror is tilted to the correct orientation angle for a given time, then the change in tilt required to track the sun at a new time is identical for all mirror rows. As a result, the entire mirror array can be actuated by a parallel linkage mechanism, such as push rod 142 and associated components shown in FIGS. 18A-F. FIG. 18F shows the mirror and actuation linkage configurations of FIGS. 18A-E, collected on one page for visual comparison.

FIGS. 18A-F show the mirror actuation system of the present collector. The arm 64 of each mirror rib 58 is connected pivotally to a push rod 142, which links all the mirrors 10 together. The push rod 142 is additionally connected pivotally to a drive arm 146, which is driven by an actuation unit 144, which controls the drive arm's position. When the actuation unit 144 rotates the drive arm 146, this moves the push rod 142, which in turn moves each mirror rib arm 64, rotating each mirror.

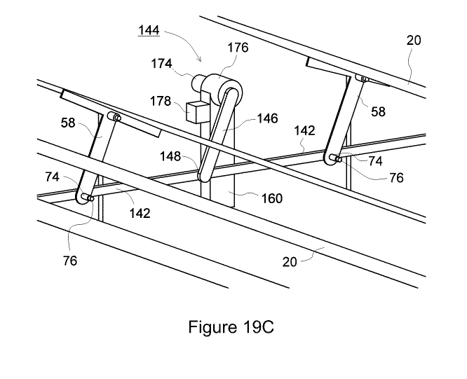

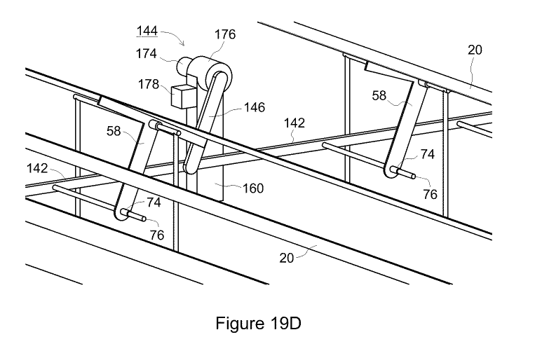

FIGS. 19A and 19B show perspective views of the collector of FIGS. 18A-F, near the fixed end 100 and tension end 102, respectively, of the mirrors 10. Movement of the mirrors 10 is controlled by actuator unit 144. Note that the push rod 142 passes below each mirror 10. FIG. 19A also shows a view including the mirror supports 40, ribs 58, fixed mounts 106, and mirror sheets 20. FIG. 19B shows another view including vertical support poles 46, mirror sheets 20, and tension device components of the collector including tension device frames 116, pulleys 114, gather clamps 104, cables 108 and tension weights 112.

FIG. 19C shows a close-up of an actuation unit 144 near the fixed end of the collector shown in FIG. 19A. The actuation unit 144 comprises a pylori 160, motor 174, optional gear box 176, drive arm 146, drive bearing 148, and controller 178. The unit can also include one or more position sensors, a power supply, and control signals, not shown. The motor 174 can be either electric or hydraulic, and if hydraulic, the actuation unit 144 can include a local hydraulic pump, also not shown. Power can be brought to the actuation unit 144 via underground conduits carrying electrical power, electrical or fiber optic control signals, and/or hydraulic feed lines. The movement of drive arm 146 is controlled automatically, e.g., by a processor programmed with a sun-tracking program, or manually, for example as shown in U.S. patent application Ser. No. 12/353,194 filed Jan. 13, 2009 and/or U.S. Patent Application No. 61/091,254, filed Aug. 22, 2008, which are incorporated by reference herein to the extent not inconsistent with the disclosure herein for purposes of enablement and written description.

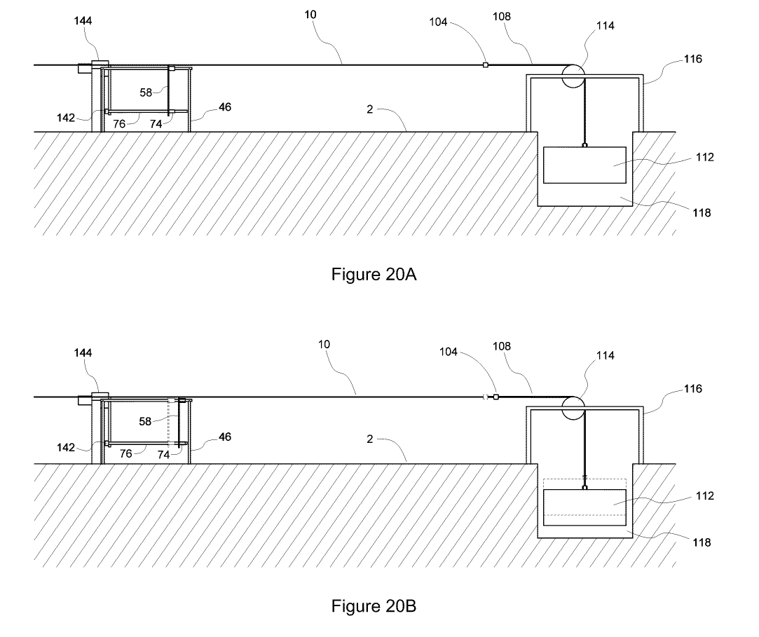

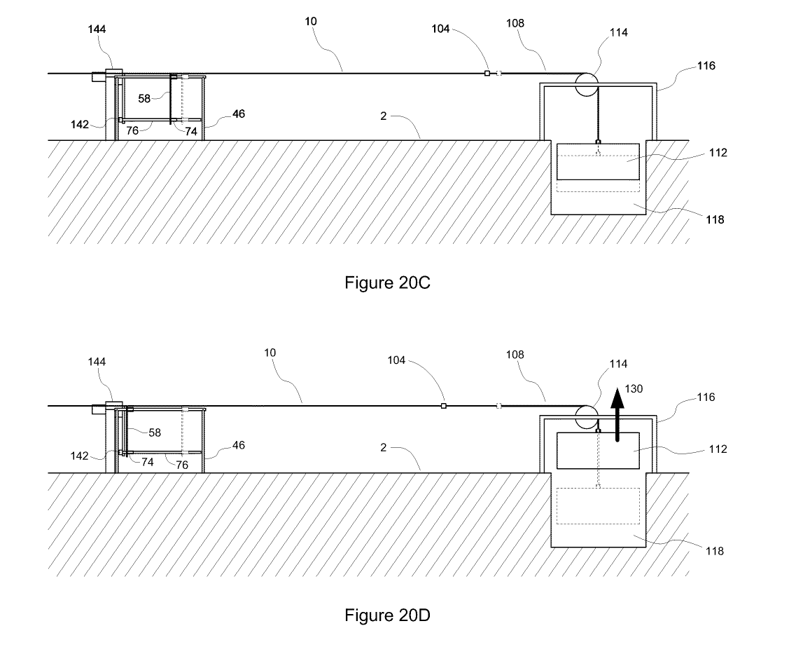

FIG. 19D shows a close-up of an actuation unit 144 near the tension end of the collector. The actuation unit 144 is of the same design shown in FIG. 19C, without modification. However, the push rod design has changed, by including longer actuation rods 76 that pivotally attach to the actuation bearings 74 in the arm 64 of each mirror rib 58. The actuation rods 76 also appear in FIG. 19C, but are shorter in the case near the fixed end of the collector. For the case shown in FIG. 19D near the tension end 102, longer actuation rods 76 are required to maintain engagement with the rib arm actuation bearings 74 as the mirror 10 expands and contracts due to elongation and thermal expansion effects. This is clarified in FIGS. 20A-D, which show the same nominal, high temperature, low temperature, and relaxed maintenance scenarios as shown in FIGS. 16A-D, but now also including the mirror actuation system components. Note that the actuation unit 144, push rod 142, and actuation rods 76 maintain a constant position relative to the ground 2, while only the mirror 10 and its attached rib 58 move laterally as temperature changes or tension is relieved.

This is why the actuation bearing 74 described in section 1.2 is designed to allow translational motion along and rotational motion about the axis of the actuation rod 76. In addition, the length and clearance of the actuation bearing 74 relative to the actuation rod 76 should be chosen to substantially prevent lateral or angular wobbling between the actuation bearing 74 and actuation rod 76. This eliminates the need for the connection between the push rod 142 and actuation rod 76 to resist twisting moments, allowing these moments instead to be resisted by the rib arm and the rib's interface with the horizontal support rod.

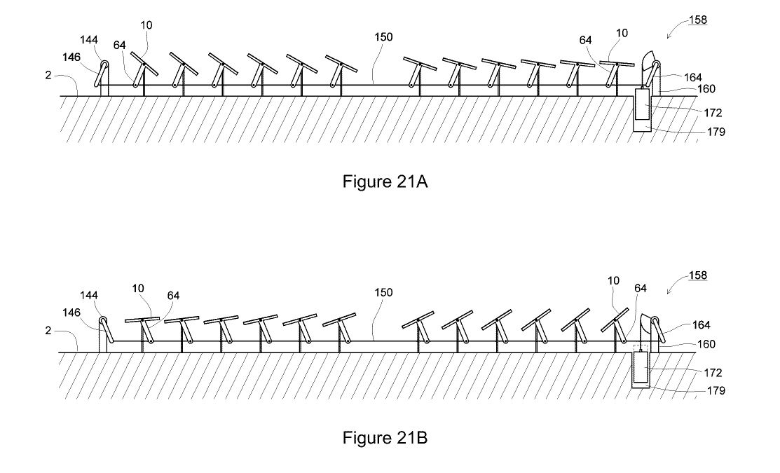

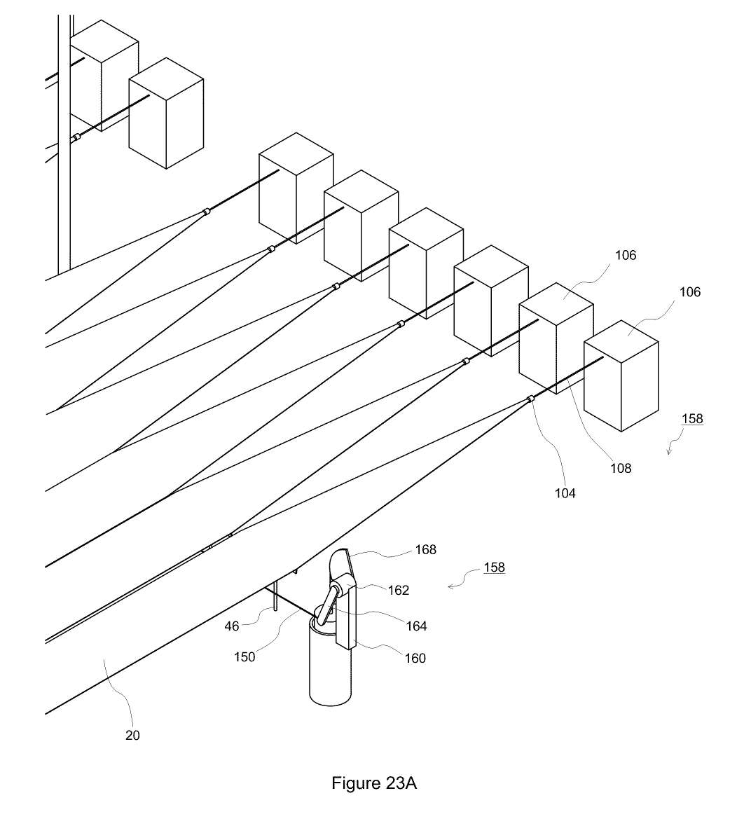

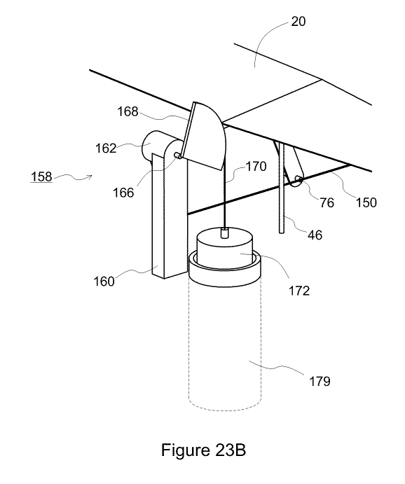

For the push rod embodiment of the actuation mechanism, the push rod 142 transfers drive force from the drive arm 146 to the rib arms 64 through compression (see FIG. 18F). As a result, the dimensions of the push rod 142 must be chosen to avoid buckling due to a high slenderness ratio. An alternative embodiment is shown in FIGS. 21-23. In this embodiment, a flexible actuation cable 150 is used in place of the push rod to connect the rib arms 64 to the drive arm 146. As with the push rod embodiment, the actuation cable 150 has attached actuation rods 76 (see FIGS. 19C and D) which are pivotally attached to the rib actuation bearings 74. In the cable embodiment, the actuation cable 150 is held under constant, preloaded tension by means of an actuation tension unit 158, comprising a pylori 160, bearing 162 (shown in FIGS. 23A and B), idler arm 164, shaft 166 (shown in FIG. 23B), actuation pulley 168, weight cable 170 (shown in FIG. 23B), and actuation tension weight 172 (FIG. 23B).

FIGS. 21A and B show this system in operation for two different sun angles. The actuation unit 144 is now placed on the outside of the mirror array rather than centrally as shown in previous figures, providing easier access for maintenance, etc. This position can also be used for the push rod embodiment. The actuation cable 150 is strung from the end of the drive arm 146 across the rows of the array to the idler arm 164. Gravity pulls the actuation tension weight 172 downward, pulling on the cable which exerts a torque on the actuation pulley 168 (see FIG. 23B). The shaft 166 (see FIG. 23B) transfers this torque to the idler arm 164, which in turn transfers the torque into a tension force on the actuation cable 150.

Since the force of gravity on the actuation tension weight 172 is constant, tension is always applied to the actuation cable 150. However, the magnitude of this tension varies with the idler arm angle, so the tension weight size should be chosen to ensure adequate tension will always exist for all idler arm angles, which vary from −45° to +45° from vertical. Further, the actuation cable tension should be chosen to ensure that the actuation cable 150 will not go slack under the worst-case expected disturbance force. For an example design, analysis indicates that a tension of 1,250 pounds is sufficient. The idler arm length must match the distance from the rib pivot bearing 72 (see FIG. 11) to actuation bearing 74, which is 1.0 m=39.37 inches in the example design. We stipulate that the array is placed in a safety stow position during worst-case wind disturbance events, so the idler arm 164 angle is aligned with vertical. Under these conditions, the resulting torque on the shaft 166 is 49,212 inch-pounds. Selecting an actuation pulley radius of 24.6 inches indicates that the tension weight 172 must weigh 2,000 pounds, which can be achieved by a concrete cylinder 24 inches in diameter by 53 inches tall. This can be connected to the pulley using a ⅜ inch diameter 6×19 hoisting wire rope, which has an allowable bend radius that is compatible with the selected pulley radius. Analysis of geometric travel limits indicates that the weight must be contained in a hole 179 in the ground at least 56 inches deep; this hole 179 is shown in FIGS. 21A and B.

Comparing the actuation cable embodiment of FIGS. 21-23 against the push rod embodiment of FIGS. 18-19, we see that each embodiment has different advantages. The cable embodiment requires substantially less material for the connection between the drive arm 146 and the rib arms 64, but requires additional components to maintain actuation cable tension. Which embodiment is preferred depends on mirror configuration and economic conditions. For example, linear Fresnel collectors with additional mirror rows have longer distances across the mirror array, increasing material requirements to avoid push rod buckling. In these scenarios and depending on other factors, the cable embodiment may be preferred.

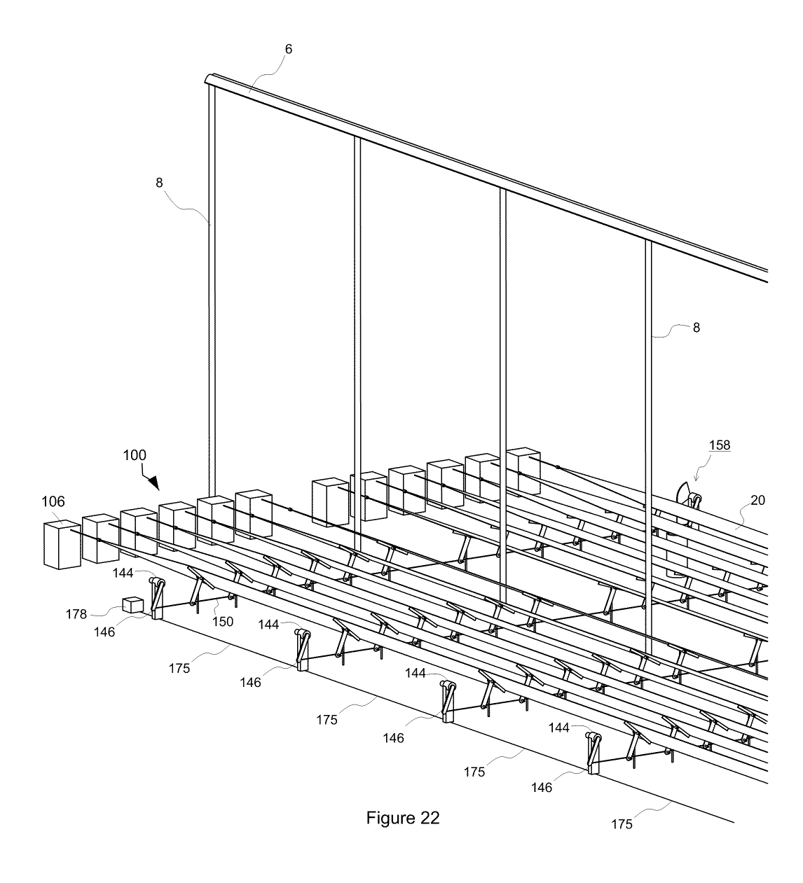

FIG. 22 shows a perspective view of the cable embodiment of the actuation mechanism near the fixed end 100 of the collector. In this figure the control system is shown in a different configuration than that shown in FIGS. 23A and B. In the embodiment shown in FIG. 22, a single controller 178 controls multiple actuation units 144. Conduits 175 between actuation units 144 provide the connection necessary so that the controller 178 can control multiple actuation units 144. If each unit has an independent drive system, then these connections will include sensor and control signals, and optionally also power.

FIGS. 16A-D, 17A-D, and 20A-D show the effect of thermal expansion along the length of the mirror. Thermal expansion effects are also important across the mirror rows. As ambient temperature rises and falls, the length of the actuation mechanism push rod 142 or actuation cable 150 changes in response. This causes errors in mirror tilt angle, especially for mirrors that are far from the drive arm. For example, consider an embodiment where the actuation unit 144 is placed outside the mirror array, to ease maintenance access. For the example design, the distance from the drive bearing 148 (see FIG. 19C) to the actuation bearing 74 (see FIG. 19C) on the furthest rib is 22.25 m. The length of the push rod 142 or actuation cable 150 between these actuation points is then also 22.25 m, at a nominal temperature of 25° C. If the push rod 142 or actuation cable 150 is made of stainless steel with a thermal expansion coefficient of 17.3×10⁻⁶ 1/° C., then at a high temperature of 50° C., this length grows to 22.26 m. This corresponds to an error in rib arm position of 10 mm, which for the example design with a 1 m distance from pivot to actuation bearing produces a 0.57°=10 mrad error in mirror tilt angle at solar noon. This is unacceptable for most applications.

Several embodiments overcome this problem. For example, placing the actuation unit 144 in a central position on the collector 1 as shown in FIGS. 18-19 reduces the distance between the drive arm 146 and most distant rib by a factor of two, thereby reducing error in tilt angle by a similar amount. In a nearly equivalent approach, the actuation unit 144 can be left outside the mirror array for easy access as shown in FIGS. 21-23, and a temperature sensor can be added to the control unit 178 so that the change in length of the push rod or actuation cable can be estimated by the control software and the drive arm's angle adjusted to compensate for predicted expansion. This allows the system to emulate the error pattern that would result from placing the actuation units at the center of the collector as in FIGS. 18-19, but while preserving the ease of maintenance access shown in FIGS. 21-23. Yet neither of these approaches do better than reducing the error by a factor of two, retaining a 0.28°=5 mrad error under the example high-temperature scenario described above.

Another method for reducing mirror tilt error due to temperature changes is to fabricate the push rod 142 or actuation cable 150 from a material with a low thermal expansion coefficient. One such material is Invar™, an alloy of iron and nickel well-known to have a very low thermal expansion coefficient, typically equal to 1.2×10⁻⁶ 1/° C. If the push rod or actuation cable is fabricated from this material, then for the scenario described above, the push rod 142 or actuation cable 150 grows from 22.25 m to only 22.2507 m, corresponding to a tilt error of 0.04°=0.7 mrad for the most distant rib. Similar results may be achieved using any of a variety of other available materials with a thermal expansion coefficient less than 2×10⁻⁶ 1/° C. Examples include Super Invar, Inovar, Microvar, Inovec, or composite materials comprising mixtures of ordinary materials with fibers of high-strength polyethylene, which exhibits a negative linear thermal expansion coefficient in the direction of the fiber. After reducing the mirror tilt error by using low-expansion materials, the remaining error can be further cut in half by placing the actuation unit 144 at the center of the collector 1, or equivalently simulating this through temperature sensing and software control as described above.

Another method for reducing the impact of thermal expansion effects is to reduce the push rod length by reducing the number of connected mirrors. For example, instead of connecting all mirrors across the full mirror array as shown in FIG. 18, an alternative is to provide two separate push rods, each with its own actuator, where each push rod is now roughly half the length of the full-array push rod. This of course can be repeated, further subdividing the array and yielding successively shorter push rods. As push rod length decreases, so does the magnitude of tilt errors resulting from temperature changes.

In this embodiment we can take advantage of the different tilt angle tolerances that apply to different mirrors. For example, if two push rods and actuators are provided as described above, it is advantageous to place the actuator at the periphery of the array, both for ease of maintenance access and because this assures that the outermost mirrors have the smallest tilt errors due to thermal expansion effects. This is well-matched to the optical performance requirements of the mirror array, since the innermost mirrors that experience the largest temperature-induced tilt angle errors are closest to the receiver, and thus have the largest tolerance for such errors.

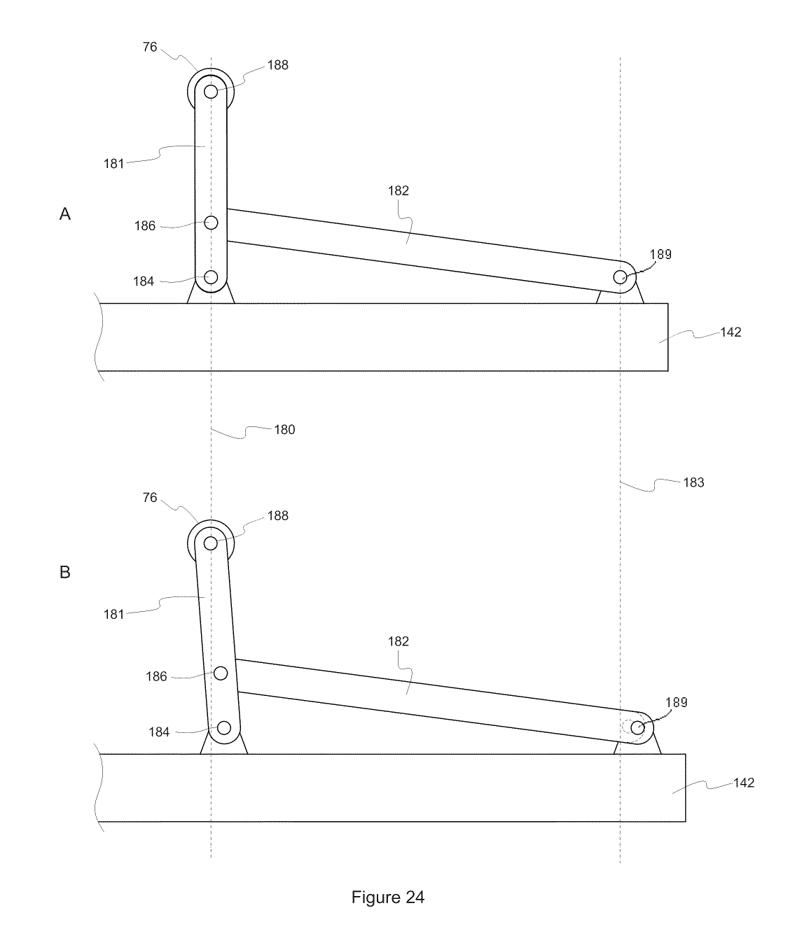

A further method for reducing mirror tilt error due to temperature changes is shown in FIG. 24. In this mechanism the push rod 142 and actuation rod 76 are connected by a linkage. The first link 181 is made of any of a variety of materials, and is pivotally connected to the push rod 142, second link 182, and actuation rod 76. The second link 182 is made from a material with a thermal expansion coefficient that is different from that of the push rod, so that the push rod 142 and the second link 182 expand at different rates. FIG. 24A shows the linkage at nominal temperature. The push rod 142 and second link 182 are both at their nominal lengths, and the first link 181 is aligned vertically. Note that the attachment point 188 between the first link 181 and the actuation rod 76 lies along the vertical dashed line 180, which bisects the first link 181 when it is in vertical position. FIG. 24B shows the configuration of the device components at a high temperature. The push rod 142 has changed in length due to thermal expansion, as can be seen by comparing the position of attachment point 184 of the push rod 142 to first link 181 relative to the vertical dashed line 180 in FIG. 24B with its position in FIG. 24A. At the same time, the length of the second link 182 has expanded, and at a greater rate than the push rod 142. The length of the second link 182 is now comparatively longer than the distance between the attachment points 184 and 189 on the push rod 142, and so the second link 182 has pushed the first link 181 to a tilted angle. As a result, the connection point 188 between the first link 181 and the actuation rod 76 still lies along the first vertical dashed line 180. This causes the mirror tilt angle to remain unchanged, despite the thermal expansion of the push rod 142.

The mechanism shown in FIG. 24 can be made from a variety of materials and dimensions. The calculation of necessary dimensions for a given design problem is straightforward for one of ordinary skill in the art. As an example, if a 22.25 m push rod is made from Invar™ and the second link 182 is made from aluminum, then temperature compensation as shown in FIG. 24 can be achieved if the second link length is 0.241 m long, and the distance between first attachment point 184, of first link 181 to push rod 142, and second attachment point third hole 188 in the first link 181 is five times the distance from first hole 184 to second hole 186.

### 1.4. Fixed Focal Length Rib

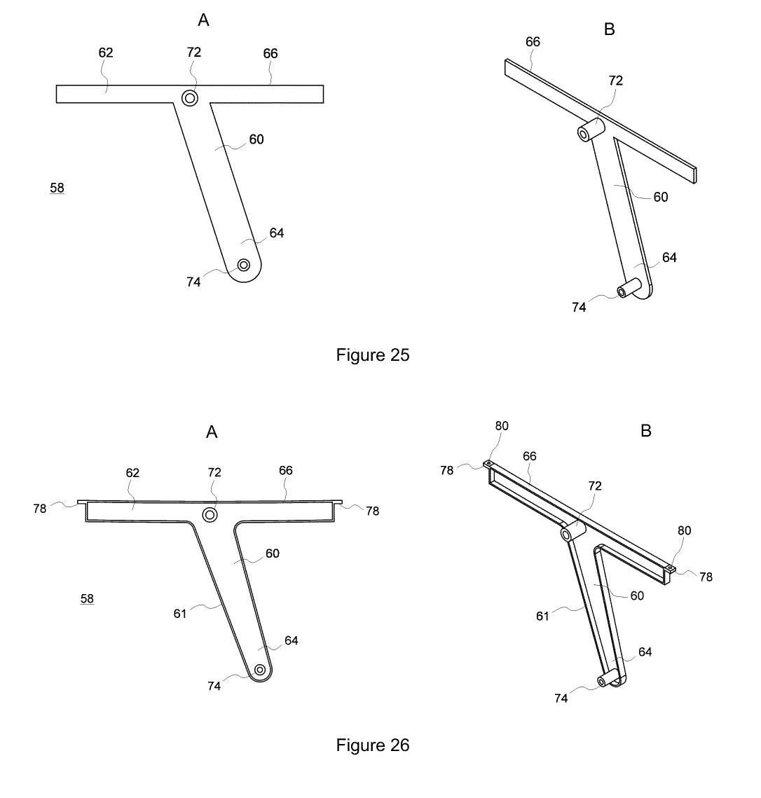

FIG. 25A shows a front view and FIG. 25B shows a perspective view of simplified rendering of a mirror rib 58. It comprises a main plate 60, comprising a crossbar 62 and arm 64. The crossbar 62 has a mirror interface surface 66. Fixedly attached to the main plate 60 are a pivot bearing 72 and actuation bearing 74. These have been described previously.

FIGS. 26A and B show a more detailed rendering of the mirror rib 58 shown in FIGS. 25A and B. This rib still includes a main plate 60, crossbar 62, arm 64, mirror interface surface 66, pivot bearing 72, and actuation bearing 74. In addition, the rib 58 includes a reinforcing ridge 61, which stiffens the main plate 60. This ridge 61 can be any of a variety of shapes, which provide additional rigidity; the one shown here is only representative. The rib main plate 60 can be formed by any of a number of processes, including machining, stamping, casting, and so on according to methods well-known in the art. The rib also includes extension tabs 78 for attaching the top strap 82, described below.

The angle between the arm 64 and crossbar 62 varies with mirror row position. This angle is computed so that the mirror is at the correct tilt angle for a given reference sun position, for a given position of the actuation mechanism drive arm 146 (see FIGS. 19C and D). For example, solar noon is a convenient choice, since the drive arm is vertical. In this configuration each rib arm 64 should also be vertical, as shown in FIG. 18C. Using standard geometric analysis techniques, the desired tilt angle for each mirror row is then computed. One method for achieving this is to identify the center point of the mirror interface surface 66, and construct two rays: the first corresponding to the vertical nominal sun direction at solar noon, and the second pointed from the center point of mirror interface 66 to the receiver center point. At the desired tilt angle, the mirror normal measured at the mirror center bisects the angle between these rays. Once the desired mirror tilt angle has been identified, the relative angle between the mirror and the vertical rib arm 64 (for solar noon) is computed to determine the correct rib arm angle for the particular mirror row.

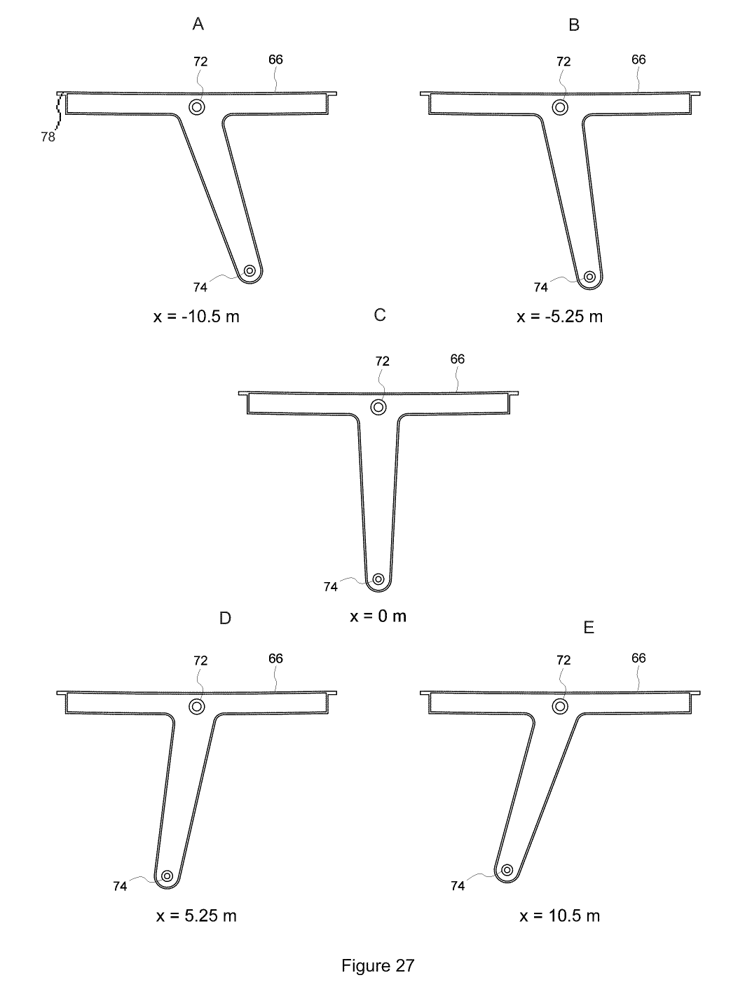

FIGS. 27A-E show a selection of example ribs with different arm angles. The mirror row position (x) is shown for each rib. The distance of the rib from a point directly under the receiver is designated x. Note that the example rib for x=0 m corresponds to a mirror directly under the receiver 4 (see FIG. 1), and does not appear in our example design shown in FIG. 18 because it would interfere with the receiver supports 8. However, it can be included in another design that employs a different receiver support design, such as an A-frame arrangement.

In addition to having different arm angles, the example ribs shown in FIG. 27 also have different curvatures for their mirror interface surfaces 66. The mirror interface surface 66 has a parabolic shape, designed to impart a parabolic shape to the attached mirror sheet. Because the distance from the mirror to the receiver changes from row to row, the optimum focal length of this parabola is also different for each row. The figures are drawn to scale with computer-aided design software, so the variations in parabolic curve are reflected in the drawings. However, the changes in curvature are so subtle that they are difficult to see.

Table 1 summarizes the arm angles and mirror interface surface focal lengths for our example design (FIG. 18), plus a center mirror at x=0 m that is not included in our design. These values are for a receiver 4 placed on the x=0 collector midplane, at a height of 14.51 m. Focal length values were computed by optical analysis software that estimated the focal length for each mirror that provided the smallest secondary reflector aperture that captures all reflected light throughout the day.

TABLE 1

| Mirror × Position | Arm Angle | Focal Length |
|---|---|---|
| (m) | (degrees) | (m) |
| −10.50 | 107.9 | 24.6 |
| −8.75 | 105.5 | 22.7 |
| −7.00 | 102.9 | 21.0 |
| −5.25 | 99.9 | 19.6 |
| −3.50 | 96.8 | 18.5 |
| −1.75 | 93.4 | 17.7 |
| 0.00 | 90.0 | 17.5 |
| 1.75 | 86.6 | 17.7 |
| 3.50 | 83.2 | 18.5 |
| 5.25 | 80.1 | 19.6 |
| 7.00 | 77.1 | 21.0 |
| 8.75 | 74.5 | 22.7 |
| 10.50 | 72.1 | 24.6 |

This table explains why the mirror interface surface curvatures seen in FIG. 27 are so subtle; the mirror focal length values are all much greater than the mirror width of 60 inches ≈1.5 m.

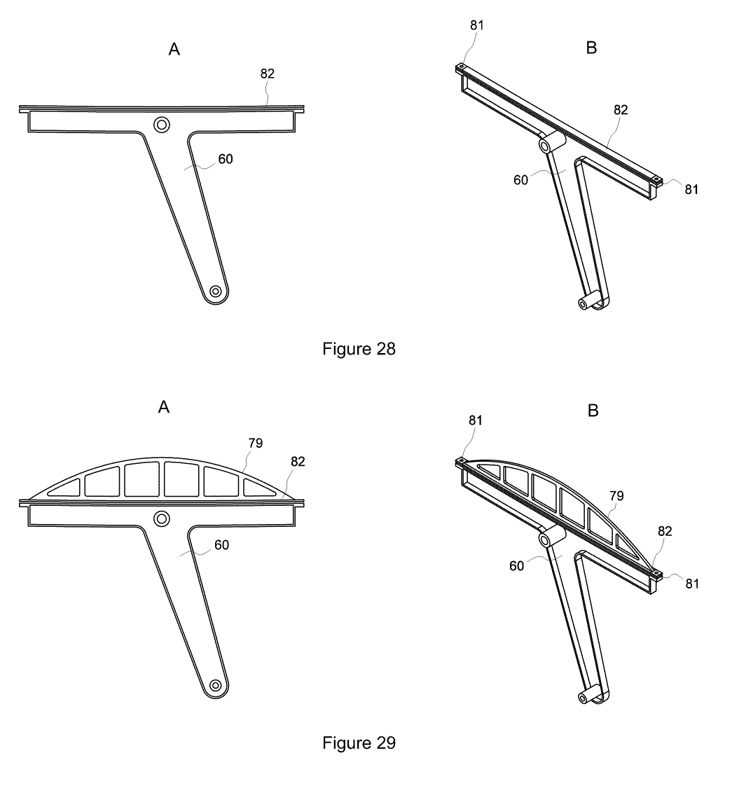

FIGS. 28-33 show alternative methods for attaching the mirror sheet 20 to the rib 58. In each case, the mirror sheet is held down against the rib mirror interface surface 66 (shown in FIGS. 25-27) using a top strap 82, which has varying configurations. In these figures, the mirror sheet itself is sandwiched between the rib mirror interface surface 66 and the top strap 82, but it is omitted from the drawing for clarity.

In FIG. 28, the top strap 82 is a simple bar, with holes 81 at each end which interface with the holes 80 (see FIG. 26) in the rib extension tabs 78. Fasteners are placed in these holes to secure the top strap 82 to the rib extension tabs 78. These fasteners can be screws, bolts and nuts, rivets, or any of a number of common fasteners well-known in the art. The fasteners are omitted in these and other drawings to reveal the holes 81. This bar embodiment of the top strap 82 can have excess curvature in its relaxed state, so that when its tips are forced down onto the extension tabs 78, positive clamping force is achieved from the center of the top strap 82 out to the periphery.

FIG. 29 shows an alternative embodiment, where the top strap 82 is reinforced with a buttress that increases the top strap's ability to resist back-side wind loads. This design might be chosen in situations where high winds at the site or other design factors lead to higher back-side wind loads than is appropriate for the simple strap shown in FIG. 28.

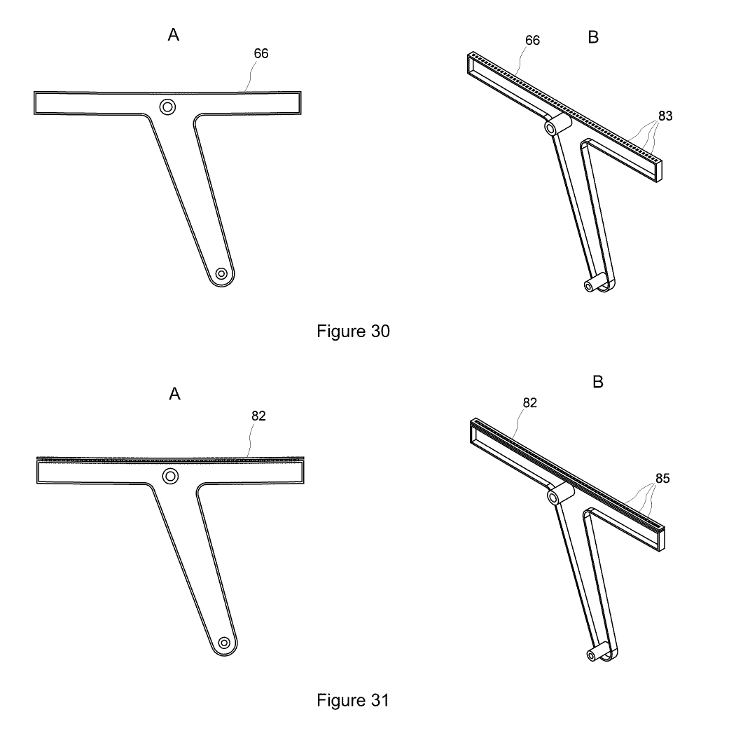

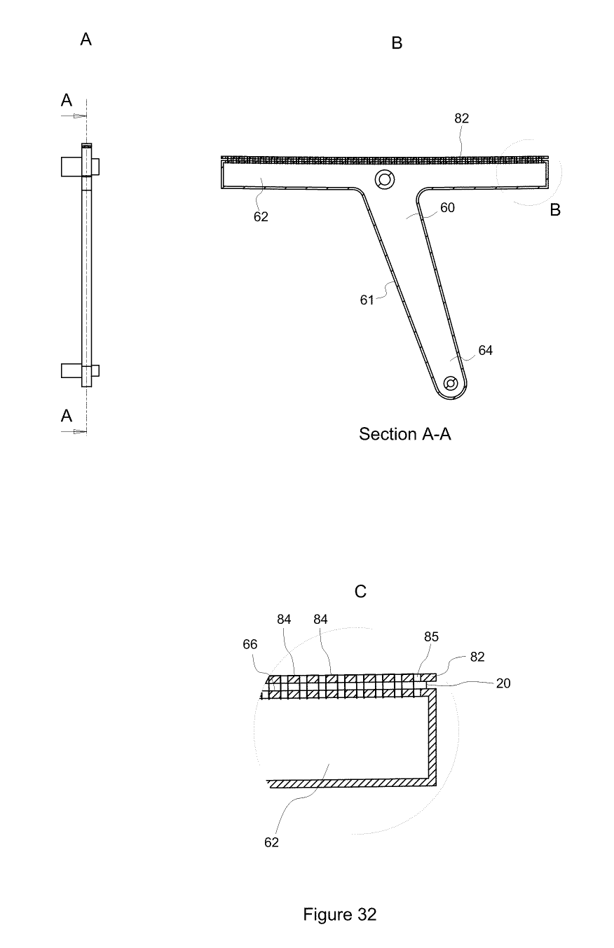

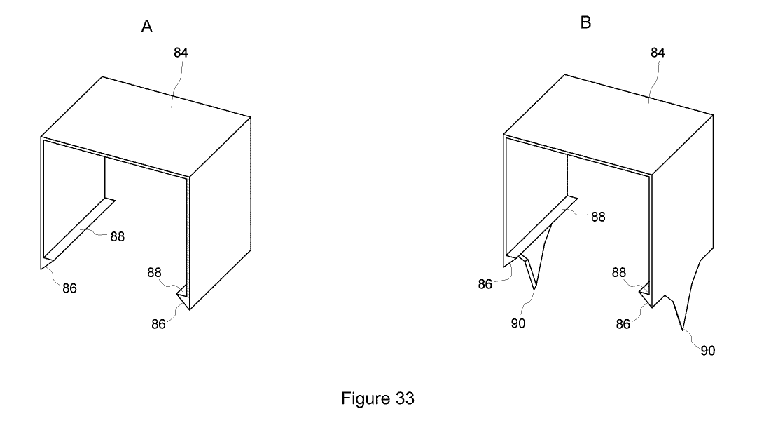

FIGS. 30-33 show a third embodiment, where the top strap 82 is held in place by a series of clips 85. As seen in FIG. 30, the mirror interface surface 66 has a series of clip holes 83 (visible in the perspective view of FIG. 30B). As seen in FIG. 31, the top strap 82 has a matching set of clip holes 85. These holes are spaced and shaped to allow the insertion of a retaining clip 85 shown in detail in FIG. 33. FIG. 32A shows a side view of the rib with the clips 85 in place. FIG. 32B is a cross-sectional view of rib 58 taken along line A-A of FIG. 32A. FIG. 32C shows an enlarged section of cross-bar 62 with the clips 85 in place. Clips 85 pass through the clip holes 85 in the top strap 82, through the mirror sheet 20, and through the clip holes in the rib mirror interface surface 66. In this way the clips 85 secure the top strap 82 and mirror sheet (not shown) to the rib mirror interface surface 66, much like a common stapler fastens together multiple sheets of paper. However, unlike a stapler, this attachment is not achieved by pressing against a form on the back side. Instead, the clip 85 is held in place by catch barbs 88 shown in FIG. 33, which grab the back side of the hole 83. The catch barbs 88 have adjacent chamfers 86 which help guide the barbs 88 past the walls of holes 85 and 83 during the clip insertion process. In this regard the clips 85 are similar to snap-fit devices common in other application areas such as consumer products.

In order to prepare the mirror sheet for attachment using these clips, holes in the mirror sheets can be formed, for example by a punching operation. Alternatively, if the holes 83 and 85 are placed so that they align with the unsupported film gap in a mirror sheet with embedded strips 30 (see FIG. 5), then the holes can be automatically pierced in the sheet simultaneously with clip insertion, by employing clips with pierce tips 90 as shown in FIG. 33B. After piercing the film portion of the sheet, the clip 85 holds the sheet firmly between the top strap 82 and rib mirror interface surface 66, preventing further tearing of the film.

The clip-based design shown in FIGS. 30-33 provides additional constraint against back-side wind loads compared to the simpler design of FIG. 28, without incurring the shading penalty of the buttress design shown in FIG. 29. However, installation complexity is higher. The attachment design is selected depending on the application.

While not shown, extension tabs 78 such as those seen in FIG. 28 can be added to the clip-based design of FIGS. 30-33, producing a design with additional reinforcement of the connections at the edge of the mirror.

The clip-based approach shown in FIGS. 30-33 can be modified to utilize other fasteners which pass through aligned holes in multiple plates. These include screws, bolts and nuts, one-sided pop rivets, and a variety of other fastening methods well-known in the art. Each has the common characteristic of sandwiching the mirror sheet between the top strap 82 and the rib mirror interface surface 66 using multiple fasteners which pass through aligned holes in all three components. If the fasteners have a short profile, then they avoid creating shading losses. These variations are considered to be embodiments of the collector disclosed herein.

For the simple top strap of FIG. 28 and the clip-based fastening method of FIGS. 30-33, reflective polymer film can be added to the top strap surface to produce additional reflective area and increase energy capture. In the case of the clip-based design, the reflective polymer film can be added either before or after clip installation.

In FIGS. 28-32, the gap between top strap 82 and cross-bar 62 is shown exaggerated for clarity, so that the gap between these different parts can be more easily seen. In reality they are much closer together, separated only by the mirror film thickness.

### 1.5 Variable Focal Length Ribs

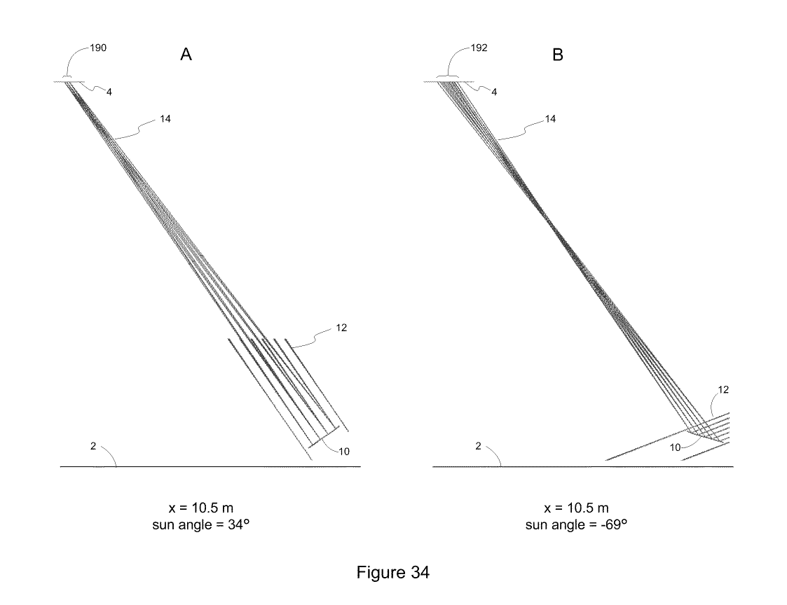

The rib design described in the preceding section provides a simple implementation of a mirror with a fixed focal length, which remains constant throughout the day. However, this design does not produce maximum performance, as explained in the discussion of FIGS. 34-37 and 59-76 below.

FIGS. 34A and B show the result of a computer ray tracing analysis of the light reflecting from the outer mirror in our example design, at two different times of day. The mirror focal length is the same in both figures, and is set to the distance x from the mirror to the receiver center. In this analysis, the receiver 4 is modeled as a horizontal line, placed at a height corresponding to the opening aperture of a secondary reflector 6 (see FIG. 1). The lateral extent of rays reflected onto this line determines the size of secondary reflector needed to capture all of the reflected light. For capturing all the reflected light, a small, tight pattern of focused light is best, because it enables the receiver 4 to achieve higher temperatures of the heated fluid.

FIG. 34A shows the reflected light pattern of reflected light at mid-afternoon, when the mirror tilt angle required to reflect the reflected light 14 onto the receiver 4 is nearly perpendicular to the incident sun rays 12. Because the mirror focal length is chosen to be the distance to the receiver center, this results in a well-focused, tight pattern of light 190 with minimum beam spread reflected onto the receiver 4. This small pattern of light 190 incident on the receiver aperture is desirable.

In contrast, FIG. 34B shows that the pattern of reflected light 192 striking the receiver 4 is not nearly so tightly focused. The mirror focal length is the same as in FIG. 34A, but at this different time of day the incident sun rays 12 come from a different direction, resulting in a reflected light pattern 192 having wider beam spread than the reflected light pattern 190 shown in FIG. 34A. A different mirror focal length is required to achieve the tightest possible focus.

Computer analysis was used to seek the fixed focal length for each mirror row that provides the best compromise value, for example, to determine the particular focal length value that minimizes the maximum beam spread on the receiver throughout the day. Minimum beam spread was the criterion used to compute the focal length values in Table 1 above. Compromise focal lengths can be used, but inherently sacrifice performance, because the best possible focal length is simply not the same for different sun angles.

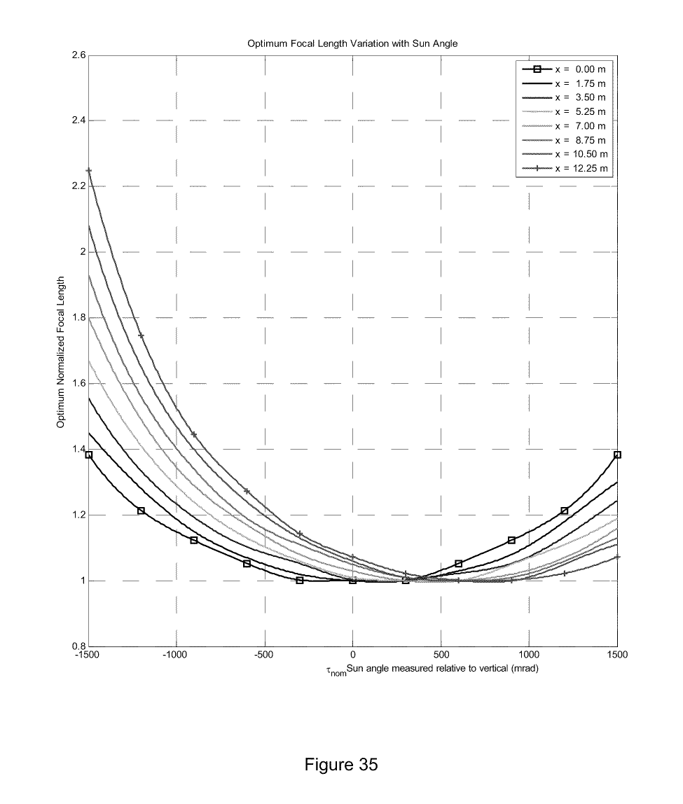

FIG. 35 shows the result of computer analysis calculating the optimum focal length for all times of day, for each mirror position in our example design (FIG. 18) plus a few additional mirror positions. Focal length on the vertical axis is expressed in normalized terms as the quotient of the optimum absolute focal length divided by the distance from the mirror to the receiver center. This plot provides a prescription for mirror design to achieve optimum performance: In a collector that provides the prescribed focal length as a function of sun angle, the resulting reflected sun rays are optimally focused on the receiver at all times.

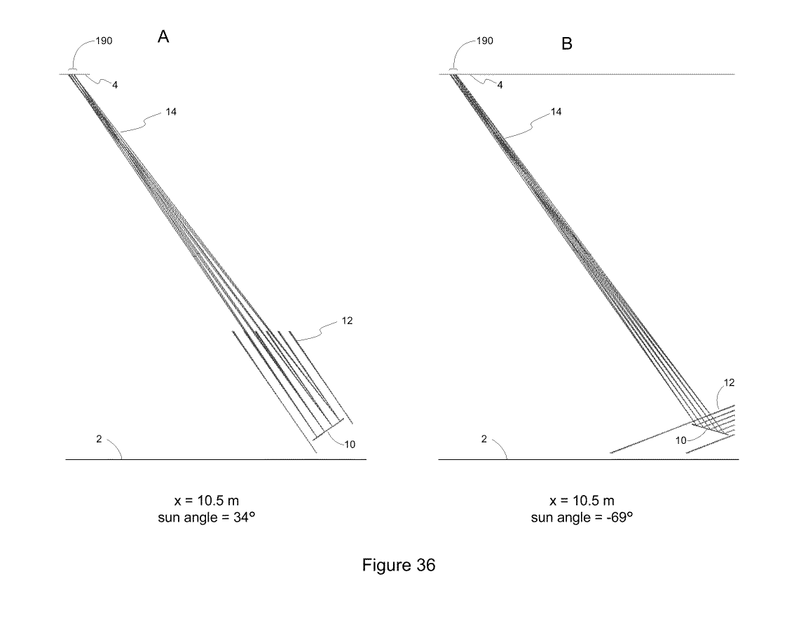

FIGS. 36A and B show the impact of following this policy. These are the same two situations as presented in FIGS. 34A and B, but now the mirror focal length is adjusted in each case to match the optimum focal length indicated by the corresponding curve in FIG. 35. This results in a tightly-focused beam on the receiver 4 in both cases. Careful study of the full computer analysis results confirms that this remains true for all sun angles throughout the day, and for all mirror positions. (Note that the prescription for optimum focal length is different for each mirror position.)

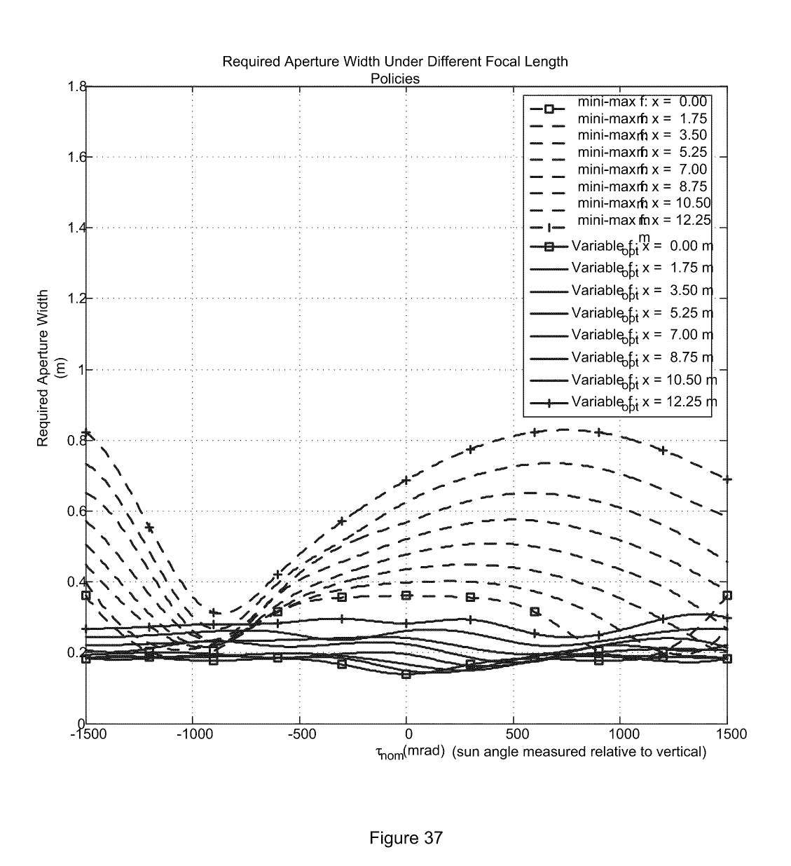

FIG. 37 shows the benefit of this in terms of required secondary aperture width. The vertical axis shows the width of the reflected beam on the horizontal receiver line, which are expressed as functions of sun angle shown on the horizontal axis. The dashed lines show the result for a fixed focal length selected for each mirror, using the “compromise” focal lengths described above. Note that the beam is tightly focused during a short part of the day, but spreads wide at other times. Meanwhile, the solid lines show the result for mirrors that follow the varying focal length prescription shown in FIG. 35. These mirrors achieve consistently tight focus throughout the day, thereby allowing the use of a smaller receiver, enabling higher receiver temperatures and more efficient energy production. Thus there is a significant economic benefit to using linear Fresnel mirrors with an optimally varying focal length.

1.5.1 Self-Adjusting Rib Assembly with Pulleys

In one embodiment a self-adjusting rib that automatically varies the focal length of the mirror using compound pulleys is provided. In this embodiment, rotation of the rib by the push rod causes a central pivot bearing to pull on attached straps, causing the compound pulleys to rotate, and causing secondary straps to pull on the tips of the compliant mirror support, thus adjusting curvature of the mirror.

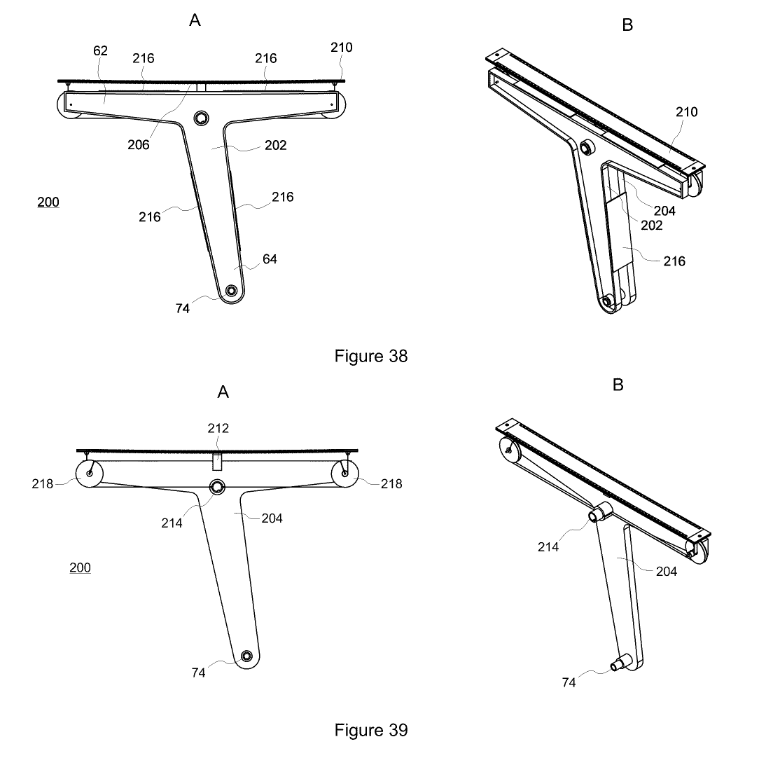

FIGS. 38A and B show a self-adjusting rib 200 which achieves a variable mirror curvature according to the prescription of FIG. 35 using a passive compliant mechanism. It is comprised of a first main plate 202 and a second main plate 204 (shown in FIG. 38B), each of which has a crossbar 62 and arm 64 similar to the fixed focal length rib 58 (see FIG. 11). The main plates are held together using join plates 216, which are attached to the main plates by any of a variety of fastening means well known in the art. The design also includes a compliant mirror support 206 with a compliant mirror interface surface, against which the mirror sheet is placed, and a compliant top strap 210. These and other internal mechanism components are explained below.

FIGS. 39A and B show the same self-adjusting rib 200, but with the first main plate 202 (shown in FIGS. 38A and B) removed to reveal the internal mechanism. We now see the pivot bearing 214, which is now rotatable, and which contains additional features described below. There is also an actuation bearing 74, which is fixedly attached to arm 64. The compliant mirror support 206 is attached to the main plates 202 (seen in FIGS. 38A and B) via a compliant support mounting bracket 212. Also included are compound pulleys 218 and associated pulley straps, which work together to modify the mirror focal length through the range of mirror tilt angles.

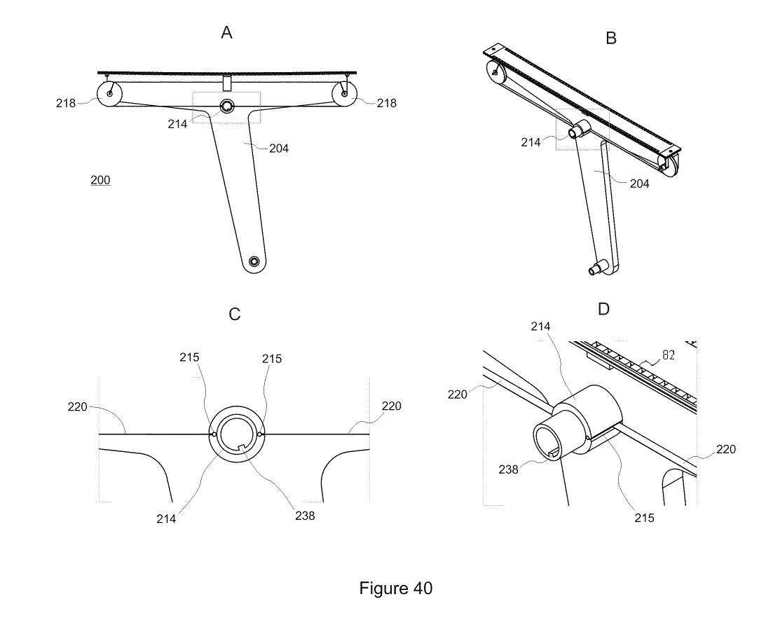

FIGS. 40A and B show front and perspective views, respectively, of the self-adjusting rib 200 of FIGS. 39A and B. FIGS. 40A and D show detailed views of the rotatable pivot bearing 214. Unlike the fixedly-attached pivot bearing 72 of the fixed focal length rib 58 previously described (see FIG. 11), the rotatable pivot bearing 214 is free to rotate relative to the adjacent first main plate 202 (shown in FIGS. 38A and B) and second main plate 204, which it engages via extensions that insert into holes in these plates. FIG. 40C shows details of the front of the rotatable pivot bearing 214 (shown in FIG. 40A), and FIG. 40D shows a detailed perspective view of the rotatable pivot bearing (shown in FIG. 40B). The rotatable pivot bearing 214 also includes a key 238, which engages a slot 240 in the horizontal support rod 42 (shown in FIG. 44B), so that the rotatable pivot bearing 214 can now slide on the horizontal support rod 42, but not rotate as before. Thus the pivot bearing now only has one translational degree of freedom—sliding along the horizontal support rod 42. But the rib still has the original two degrees of freedom, because it can slide along the support rod (carrying the pivot bearing with it), or rotate relative to the pivot bearing (which does not itself rotate relative to ground).

The rib therefore is still capable of moving along the translation freedom 68 and rotation freedom 70 shown in FIG. 11. However, the pivot bearing 214 can only move along the translation freedom 68. The pivot bearing key 238 engaging the slot 240 in the horizontal support rod 42 provides a means of maintaining the pivot bearing at a fixed orientation relative to the ground. It is to be understood that a variety of other means well-known in the art could be employed to achieve the same purpose, such as providing the horizontal support rod with a square cross-sectional shape, and providing a pivot bearing with a matching shaped hole, or by providing two parallel horizontal support rods with a matching pair of holes in the pivot bearing, etc.

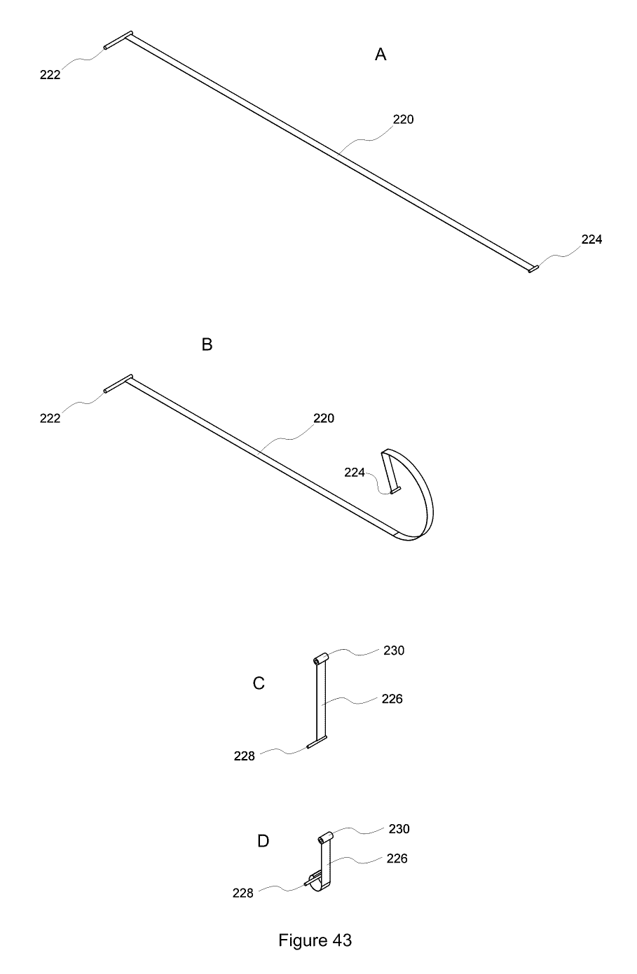

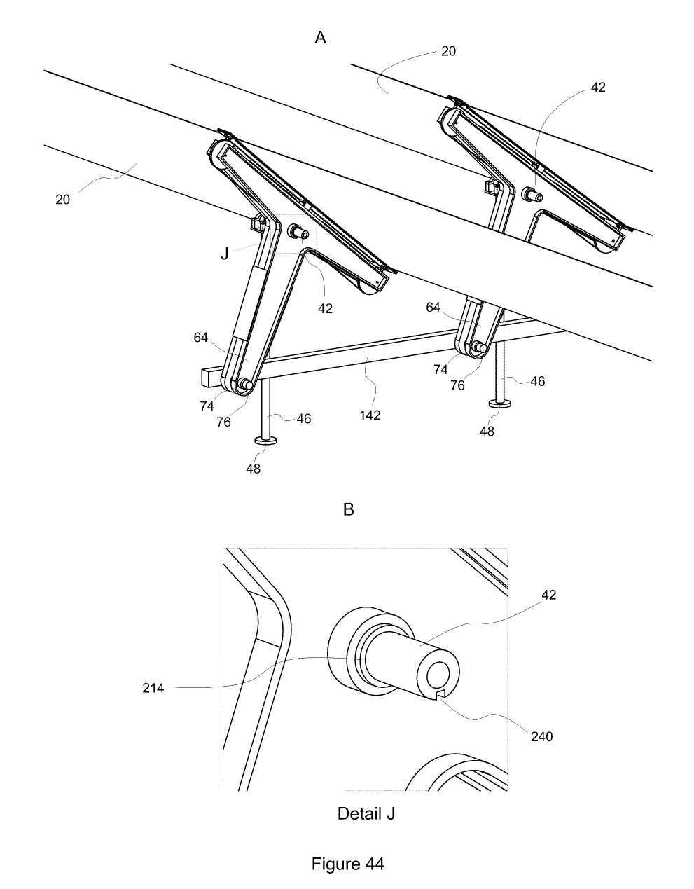

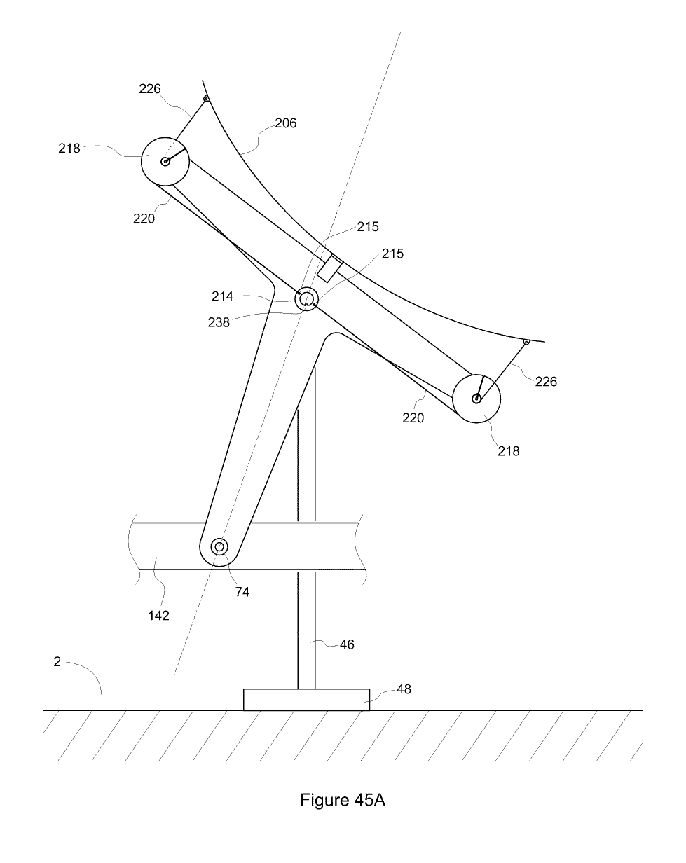

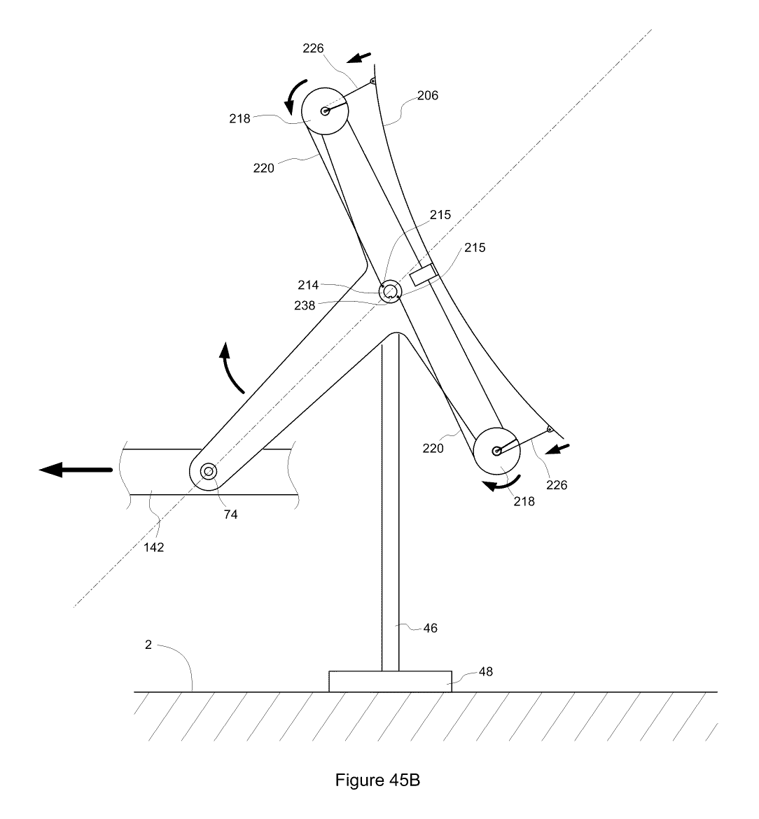

The rotatable pivot bearing 214 includes two channels 215 (shown in FIG. 40C) which each hold the proximal end studs 222 of a primary pulley strap 220 (shown in FIGS. 43A and B). These channels 215 hold the straps in proper alignment with the compound pulleys 218. The channels 215 are placed on diametrically opposite sides of the rotatable pivot bearing 214; the angle of these placements compared to the key 238 varies depending on the mirror row, as explained below.

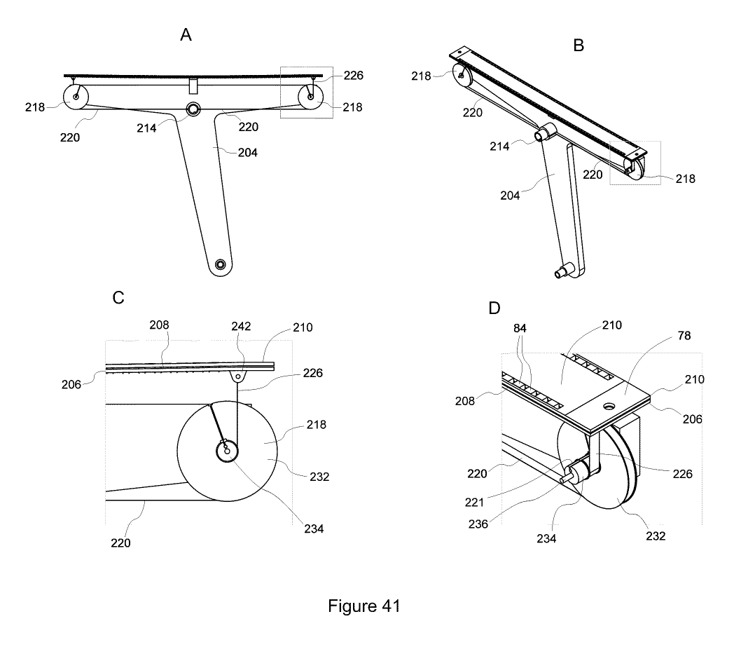

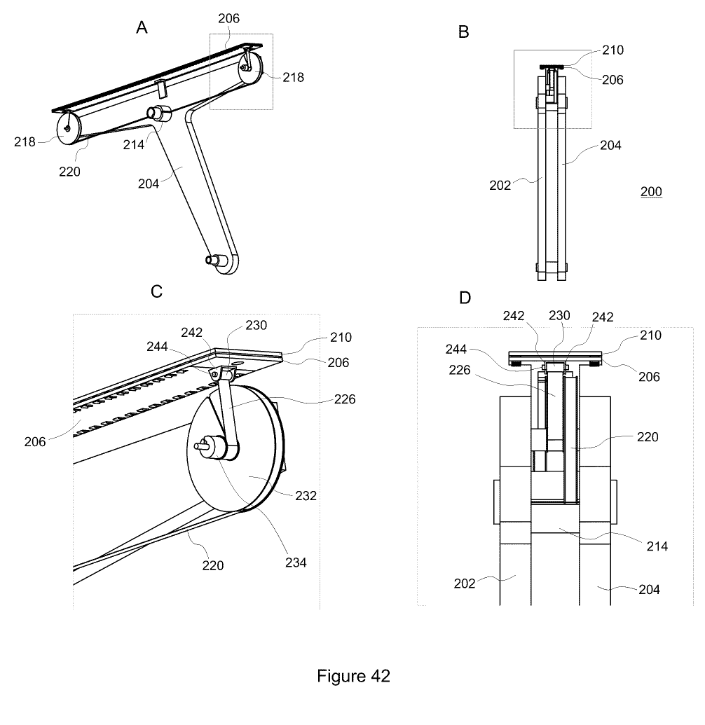

FIGS. 41A and B show the same elements as FIGS. 40A and B, with primary pulley strap 220 labeled. FIGS. 41C and D show detailed views of the right end of the ribs 200 shown in FIGS. 41A and B respectively, including compound pulley 218 and its interface with the primary pulley strap 220 and secondary pulley strap 226. The compound pulley 218 contains two wheels. The first wheel 232 is larger, and is wrapped by the primary pulley strap 220. The pulley has a channel 221 (FIG. 41D) for the distal end stud 224 (shown in FIGS. 43A and B) of the primary pulley strap 220; the opposite end of the primary pulley strap 220 is held in the rotatable pivot bearing 214. The configuration of the primary pulley strap 220 wrapped around the first wheel 232 is shown in FIG. 42C.

The second wheel 234 of the compound pulley 218 is smaller, and is wrapped by the secondary pulley strap 226 (see FIGS. 43C and D). The proximal end stud 228 (FIG. 43D) of the secondary pulley strap 226 is received in channel 221 (see FIG. 41); the opposite end stud 230 (see FIG. 43D) is attached to the compliant mirror support 206 (see FIG. 42A) as explained below. The first wheel 232 and second wheel 234 of the compound pulley 218 are rigidly connected. The channel 221 holds both the distal end stud 224 of the primary pulley strap 220, and the proximal end stud 228 of the secondary pulley strap 226.

The compound pulley 218 rotates on a pulley shaft 236 that passes through mounting holes on the first main plate 202 and second main plate 204 of the rib 200, and is attached to them using any of a number of fastening means well known in the art, such as retaining rings.

FIGS. 42A and B show detailed views of the compound pulley 218 and associated components, giving more detailed views of the interface between the secondary pulley strap 226 and the underside of the compliant mirror support 206. This attachment is formed by a pair of gussets 242 attached to the underside of the compliant support 206, which each have a hole to allow insertion of an attachment pin 244. The attachment pin passes through a hole in the secondary pulley strap distal end stud 230 (see FIGS. 42C and D), and then is retained by retaining rings or other well-known fastening methods. FIG. 43B shows the secondary pulley strap 226, both before and after it is wrapped around the second wheel 234 of the compound pulley 218.

FIG. 42B shows an end view of the self-adjusting rib 200, with both the primary main plate 202 and secondary main plate 204 in place. The join plates 216 are omitted for clarity. Note that, as shown in FIG. 42D, the secondary pulley strap 226 is wider and centered between the plates, allowing it to apply force along the centerline of the compliant mirror support 206. The primary pulley strap 220 is narrower and offset to the side to avoid interference. The two primary pulley straps are offset to opposite sides of the self-adjusting rib 200, so that the resulting symmetry allows the same compound pulley part design to be used at both ends of the self-adjusting rib 200. FIGS. 42C and D show more detailed views of FIGS. 42A and B, respectively.

FIG. 41D also shows a view of the interface between the compliant mirror support 206 and the compliant top strap 210. The compliant mirror support 206 has an upper compliant mirror interface surface 208, analogous to the mirror interface surface 66 on the fixed rib design (see e.g., FIG. 26). The mirror sheet (not shown) is held against this surface, sandwiched between the compliant mirror interface surface 208 and the compliant top strap 210. These are held together by a series of clips 85, similar as shown in FIGS. 30-32, and also by fasteners placed through holes in extension tabs 78, as shown in FIG. 28. In the example shown in FIG. 41D, there are two rows of clips; a single row of clips as shown in FIG. 30-32 can also be used.

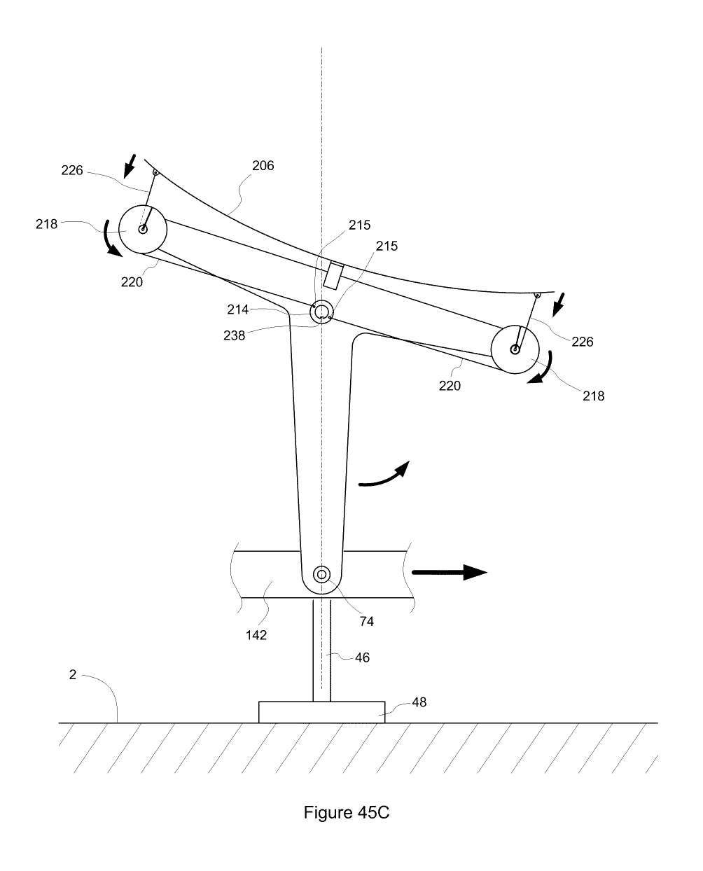

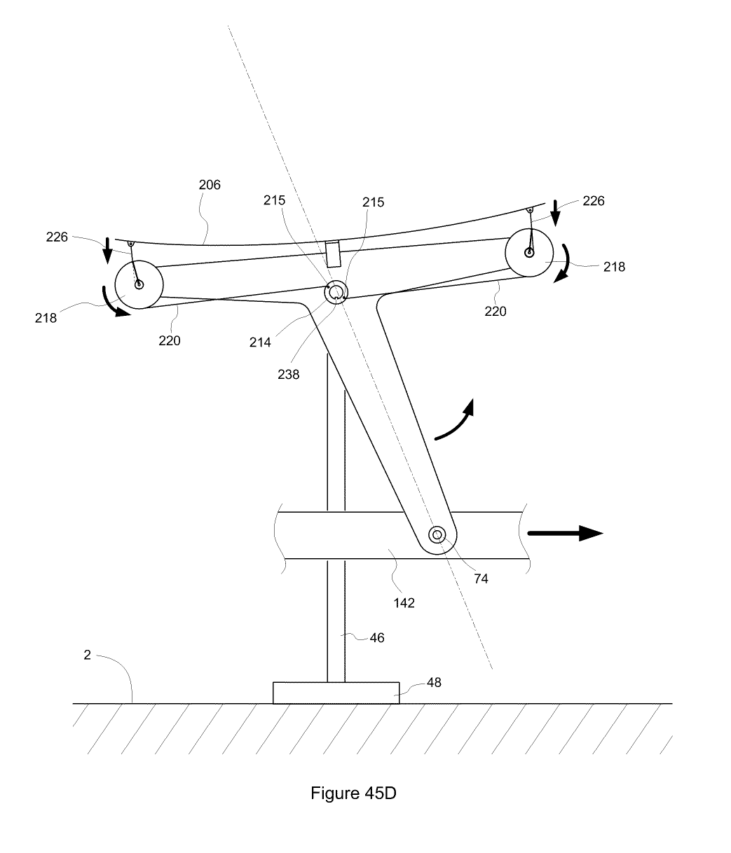

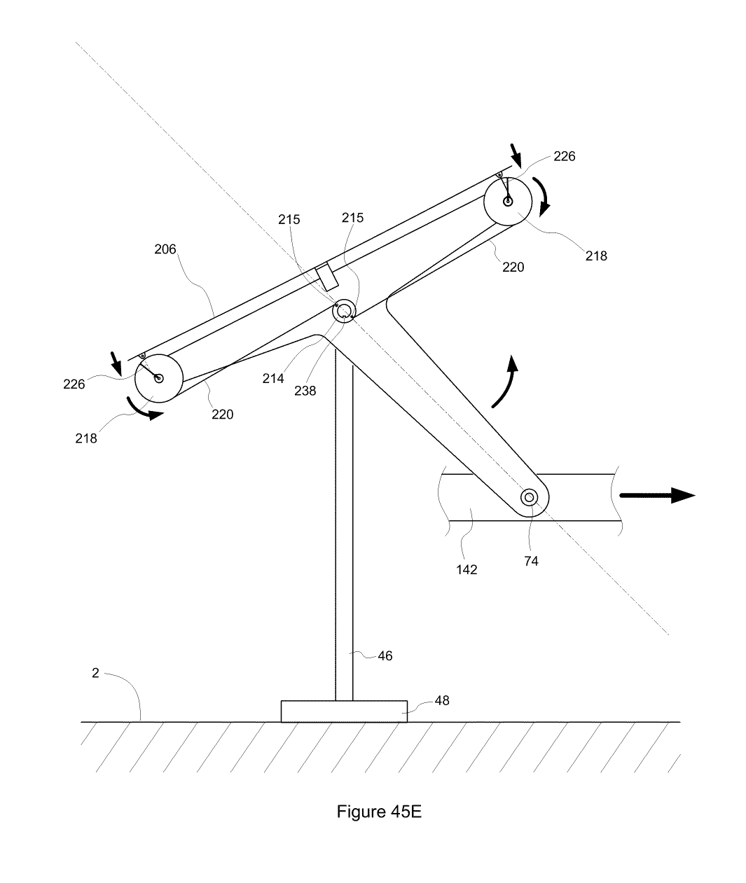

FIG. 44A shows the self-adjusting rib 200 installed in a linear Fresnel collector. The rib is placed on the horizontal support rod 42. FIG. 44B shows detail of horizontal support rod 42. The rotatable pivot bearing key 238 (shown in FIG. 45A) is engaged in a slot 240 in the horizontal support rod 42. By convention the slot 240 is always oriented down as shown in the figure, and the horizontal support rod 42 is not allowed to rotate.

FIG. 44A also shows the mirror sheet 20 attached and in place, and the actuation rod 76 engaging the rib's actuation bearing 74, thereby pivotally attaching the arm 64 of the self adjusting rib to the push rod 142 as in the previous fixed focal length case. The remainder of the actuation mechanism is identical to that previously discussed with respect to the fixed rib; the push rod 142 is attached to a drive arm 146, etc. The adjustment of the mirror focal length happens passively as the mirror is tilted to track the sun. This action is described in FIGS. 45A-E.

FIG. 45A shows a cross-section view of an example self-adjusting rib mounted on a mirror support 40 (comprising vertical support pole 46 and ground attachment interface 48) and pivotally attached to a push rod 142. Note that the pivot bearing key 238 is oriented at the bottom of its hole and thus engaging with a downward-pointing slot 240 as shown in FIG. 44. This orientation of the pivot key 238 remains invariant in all of the configurations shown in FIGS. 45A-E. For the self-adjusting rib design, the rotatable pivot bearing 214 rotates relative to the rib, not the ground.

The orientation shown in FIG. 45A is the “neutral angle” for this particular mirror row. This is the angle where the mirror normal at the mirror center points directly at the receiver center, and this is also the angle where the optimum focal length prescribed by the analysis presented in FIG. 35 is at a minimum. As a result, this is the tilt angle where the mirror should have its shortest focal length, and therefore tightest curvature and greatest chord depth. This is shown in FIG. 45A greatly exaggerated; the mirror curvature in FIGS. 45A-E are all shown greatly exaggerated so that the change in mirror curvature can be seen. Similarly, the compound pulley 218 rotation angles exhibited in FIGS. 45B-E are also shown exaggerated, although not to such a great degree. The neutral angle for this example mirror row happens to correspond to a mid-morning time; the neutral angle for other rows occurs at other times of day.

In the neutral angle shown in FIG. 45A, the mirror has its shortest focal length and greatest curvature. This shape is set by the compliant mirror support 206. The term “compliant” as used for the mirror support 206 means that the mirror support must allow bending through the range of focal lengths desired, must do so without exceeding its maximum yield stress, and must provide enough force-resisting bending so that it will not allow the pulley straps 220 and 226 to go slack under worst-case wind loads. For rotations to tilt angles in either direction, the compliant mirror support 206 should flatten to increase the focal length. This is achieved by the angle of the channels 215 in the rotatable pivot bearing 214 relative to the key 238. Note that at this neutral angle, they are aligned with the primary pulley straps 220. This is the greatest relaxation these straps ever experience through the course of the day; at all other times, they are deflected by the channels 215, pulling on the compound pulleys 218.

This is shown in FIG. 45B, corresponding to a mirror tilt angle earlier in the day, shortly after sunrise. Note that the rotatable pivot bearing 214 maintains the same orientation relative to the ground 2, as evidenced by the key 238 at the bottom of the bearing hole. Consequently, the channels 215 which hold the proximal ends of the primary pulley straps 220 are also in the same position as shown in FIG. 45A. However, meanwhile the surrounding rib has rotated, and so the channels 215 are no longer on the shortest path for the primary pulley straps 220.

To reach this orientation from the neutral angle shown in FIG. 45A, the push rod 142 moves left, causing the rib 200 to rotate clockwise, as shown by the motion arrows. When this occurs, the fixed orientation of the channels 215 in the rotatable pivot bearing 214 result in a pulling of the primary pulley straps 220, causing the compound pulleys 218 to rotate in the directions shown. When the pulleys rotate, they pull on the secondary pulley straps 226, which in turn pull the compliant mirror support 206 to a flatter shape as desired.

FIG. 45C shows a similar motion, but in the opposite mirror rotation direction. This example corresponds to solar noon, a time later in the day rather than earlier. From the neutral angle, the rib moves to this orientation when the push rod 142 moves to the right, causing the rib to rotate counter-clockwise. Again the rotatable pivot bearing 214 maintains a fixed orientation relative to the ground 2, and thus pulls in the primary pulley straps 220, which rotate the compound pulleys 218, which in turn pull in the secondary pulley straps 226, which pull on the compliant mirror support 206 to draw the mirror 10 into a flatter shape.

FIG. 45D shows the situation still later in the day, at mid afternoon. The push rod 142 has moved further to the right, rotating the rib 200 further counter-clockwise. The pulling on the primary pulley straps 220 and consequent rotation of the compound pulleys 218 continues, pulling the compliant mirror support 206 to a still flatter shape.

FIG. 45E shows the situation even later in the day, shortly before sunset. The push rod 142 has advanced even further to the right, and the rib is near its most counter-clockwise orientation. The rotatable pivot bearing 214 is still in the same orientation relative to the ground 2. However, the relative rotation of the rib 200 is so great that the channels 215 have pulled the primary pulley straps 220 a significant distance, causing the compound pulleys 218 to rotate further and pull the compliant mirror support 206 to a much flatter shape than in the neutral angle.

Note that the change in mirror shape is not symmetric when viewed relative to solar noon. The mirror is much flatter in the near-sunset position than in the near-sunrise position. This is because for this mirror row, the neutral angle did not occur at solar noon. The change in shape is symmetric with respect to the neutral angle.

The motion snapshots shown in FIGS. 45A-E show a greatly exaggerated mirror shape and slightly exaggerated pulley rotations, but otherwise the drawings are to scale. Analysis of the focal length values prescribed in FIG. 35 shows that the change in focal length required to achieve increased performance is quite subtle. For example, the maximum deflection of the tip of the compliant mirror support 206 from neutral angle to flattest shape is only 4.2 mm for the mirrors on the outside of the mirror array, and smaller for mirrors closer to the receiver. (Tip deflection is advantageously measured from the point of connection of compliant mirror support 206 with gusset 242 to which secondary pulley strap 226 is also attached for the purpose of deflecting the tip of compliant mirror support 206 (see FIG. 41C)). This change in shape would be very difficult to perceive in scale drawings. Further, this is why the design includes a compound pulley 218 and two pulley straps instead of just one. Without the motion reduction provided by the mechanical advantage of the different size wheels, it would not be possible to put the channels 215 for the proximal end studs 222 of the primary pulley straps 220 in place without requiring a horizontal support rod 42 that would be unacceptably small. The compound pulley solves this problem by reducing the effective motion distance of the primary pulley strap. This brings the additional benefit of providing mechanical advantage, which reduces the tension force carried by the primary pulley straps 220, and also the push rod force required to deflect the compliant mirror support 206.

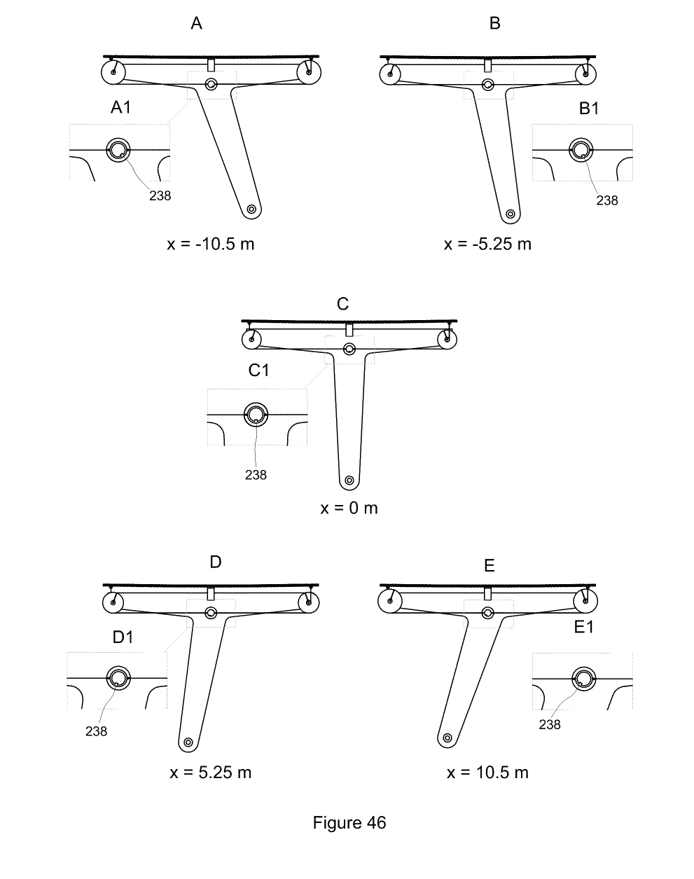

Each mirror row position has a different optimum focal length prescription as defined by FIG. 35. This is characterized by a different neutral angle and maximum tip deflection. As a result, the position of the rotatable pivot bearing 214 and the diameter of the first wheel of the compound pulley vary for each mirror row. This is illustrated in FIGS. 46A-E, which show the self-adjusting rib designs corresponding to the same mirror row positions as shown for fixed focal length ribs 58 in FIG. 27. The first main plate 202 and join plates 216 are omitted to allow study of the internal mechanism details. Note that the angles of arms 64 are the same as for the fixed focal length ribs 58, since the basic mirror tilt angle requirements remain unchanged. The compound pulley first wheel diameters vary with row position, with the smallest diameter corresponding to x=0 m, and the largest diameter corresponding to x=±10.5 m. Each row has a different neutral angle, as evidenced by the key 238 position seen in the detailed view of each rotatable pivot bearing 214.

The procedure to compute the required first wheel diameter and rotatable pivot bearing channel angle follows these basic steps:

(1) Compute the neutral angle for the mirror row. This corresponds to the angle where the normal at the mirror center point points directly at the receiver center.

(2) Compute the angle for the rotatable pivot bearing channels, which is 90° from the angle of the mirror normal in the neutral angle position.

(3) Compute the maximum angular excursion, which is the angular difference from sunrise or sunset mirror angle to the neutral angle.

(4) Using the optimum focal length prescription computed from optical analysis and the parabola equation, compute the difference in tip position between the neutral position and the maximum angular excursion position.

(5) Based on a fixed diameter of the second wheel, compute the pulley rotation required to achieve this tip deflection.

(6) Based on the rib rotation required to reach the maximum angular excursion and the radius of the rotatable pivot bearing, compute the linear distance that the primary pulley strap is pulled when the rib rotates from the neutral position to the maximum angular excursion position.

(7) Using the linear distance computed in step 6 and the pulley rotation computed in step 5, compute the required first wheel diameter, so that the arc length subtended by the wheel rotating through the required pulley rotation equals the linear pull distance.

The calculation details of each step listed above are straightforward geometric calculations easily performed by one of ordinary skill in the art without undue experimentation. Table 2 shows the results of this analysis for our design example. In this case the rotatable pivot bearing diameter is 3.5 inches, and the second wheel diameter is 1.25 inches.

TABLE 2

| Mirror × | | | Maximum | First Wheel |
|---|---|---|---|---|
| Position | Arm Angle | Neutral Angle | Tip Deflection | Diameter |
| (m) | (degrees) | (degrees) | (inch) | (inch) |
| −10.50 | 107.9 | −35.9 | 0.166 | 7.09 |
| −8.75 | 105.5 | −31.1 | 0.163 | 6.73 |
| −7.00 | 102.9 | −25.8 | 0.158 | 6.37 |
| −5.25 | 99.9 | −19.9 | 0.149 | 6.13 |
| −3.50 | 96.8 | −13.6 | 0.137 | 5.94 |
| −1.75 | 93.4 | −6.9 | 0.121 | 5.88 |
| 0.00 | 90.0 | 0.0 | 0.109 | 5.65 |
| 1.75 | 86.6 | 6.9 | 0.121 | 5.88 |
| 3.50 | 83.2 | 13.6 | 0.137 | 5.94 |
| 5.25 | 80.1 | 19.9 | 0.149 | 6.13 |
| 7.00 | 77.1 | 25.8 | 0.158 | 6.37 |
| 8.75 | 74.5 | 31.1 | 0.163 | 6.73 |
| 10.50 | 72.1 | 35.9 | 0.166 | 7.09 |

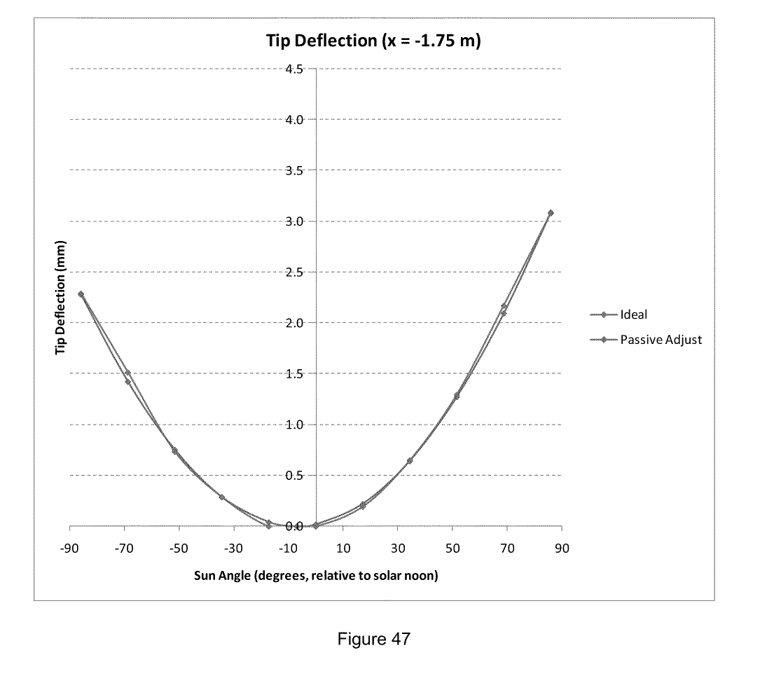

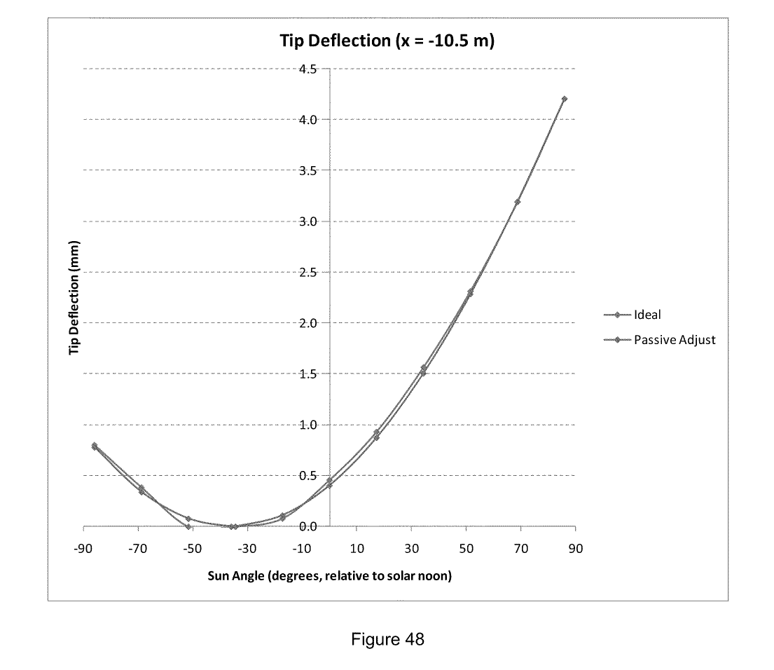

As can be seen from the above sequence of steps, the selection of second wheel diameter is driven by the maximum tip deflection, which occurs at the minimum angular excursion. It turns out that this choice also provides excellent control of the tip position across the range of mirror tilt angles throughout the day. FIGS. 47 and 48 demonstrate this, by comparing the mirror tip position prescribed by the analysis shown in FIG. 35 (converted into tip deflection), against the tip position achieved by the self-adjusting rib employing the appropriate second wheel diameter as listed in Table 2. Both figures show close agreement between the prescribed tip position (labeled “Ideal” in the plots) and the tip position predicted by simulation of the self-adjusting rib mechanism (labeled “Passive Adjust” in the plots). Study of the plots for the mirror positions yields similar results.

The compliant mirror support 206 and attached compliant top strap 210 connected at multiple points together form a flexible beam that must deform in response to changes in tip position imposed by pulling forces at the tip applied by the secondary pulley strap 226. Further, this flexible beam must avoid motion that causes the pulley straps 220 and 226 to lose tension in the presence of external disturbances such as wind forces. This is accomplished by preloading the compliant mirror support/compliant top strap beam, so that positive tension occurs on the pulley straps 220 and 226 under all conditions.

The design of this flexible beam and its constituent parts is straightforward for those of ordinary skill in the art of designing compliant mechanisms. The basic design goals are to (a) provide a beam that can comply through the range of expected deflections without exceeding the material yield stress at any point, and (b) provide required forces at expected deflection points. The basic design approach is to select a material and then a beam cross section that satisfies these requirements. The following equation is helpful:

$$w = \frac{9 {kP}_{max} ls ( \frac{l}{2} )}{4 {h}^{2} [ {σ}_{max} - \frac{3 {Eh Δ y}_{day}}{2 {( \frac{l}{2} )}^{2}} ]}$$

This equation is derived from modeling the flexible beam comprising the compliant mirror support 206, compliant top strap 210, and multiple attachment points as a pair of opposed linear beams fixed at one end. Considering the symmetry of these two opposed beams, only one beam needs to be considered for the analysis. Thus the beam length is l/2, where l is length of the compliant mirror support 206 (60 inches in our example). Pₘₐₓ is the maximum external disturbance pressure tending to flatten the beam that must be resisted by the preload, and k is a safety factor greater than one chosen to provide a preload margin. The parameter s is the span length between ribs.

The parameter σₘₐₓ is the maximum allowable stress for the chosen material, including consideration of desired material stress safety factor. E is the material elastic modulus, and Δy_{day} is the maximum tip deflection required through the course of a day, taken from Table 2. The remaining parameters w and h describe the rectangular beam cross section assumed in this derivation; h is the beam thickness, and w is the beam width. One of these parameters can be independently chosen, and the other calculated using the above equation. Exploration of parameter choices is accomplished easily with the help of a computer.

Once the beam cross-section is defined, the preload deflection required to achieve the desired preload force can be calculated:

$$Δ {y}_{preload} = k [ \frac{3 {P}_{max} {ls ( \frac{l}{2} )}^{3}}{2 {Ewh}^{3}} ]$$

The beam should be shaped so that deforming it by an amount Δy_{preload} brings it to the shape corresponding to the desired parabola at the neutral angle. Further shape changes are imposed by the self-adjusting rib mechanism, as shown in FIGS. 45A-E.

For our example design with a mirror sheet width of 60 inches, a beam fabricated of stainless steel with a thickness of 0.432 inches and width of 4.0 inches meets preload, deflection, and stress requirements. This can be implemented by splitting the 0.432 inch beam thickness evenly between the compliant mirror support 206 and compliant top strap 210, selecting dimensions of 0.216 inch thickness and 4.0 inch width for each piece. These should be formed so that in their relaxed state, the tip is 1.09 inches above the tip position desired in the rib's neutral position. This requires a preload force of 91 pounds to pull the tip into position to engage the distal end of the secondary pulley strap 226, and 105 pounds to deform the mirror to its most flat shape through the course of the day. The maximum stress under this condition is anticipated to be less than 26,000 psi, well underneath the yield strength of stainless steel. This analysis was performed for the outermost mirrors with the maximum tip deflection, and can be used without modification for interior mirrors.

Once dimensions for the compliant mirror support 206 and attached top strap 210 have been selected, dimensions for the pulley straps can be selected. For the example design, the maximum tension force seen by the pulley strap is 105 pounds. Based on this dimensions for the pulley straps are easily calculated by one of ordinary skill in the art without undue experimentation; for the example design, the secondary pulley strap 226 can be made of stainless steel with a thickness of about 0.007 inches and a width of about 0.75 inches. The Figures show a conservative width of 0.875 inches. The primary pulley strap 220 can be made smaller due to the mechanical advantage of the compound pulley 218; in this case a thickness of 0.007 inches and a width of 0.625 inches is shown.

1.5.2 Self-Adjusting Rib Assembly with Pivot Cam

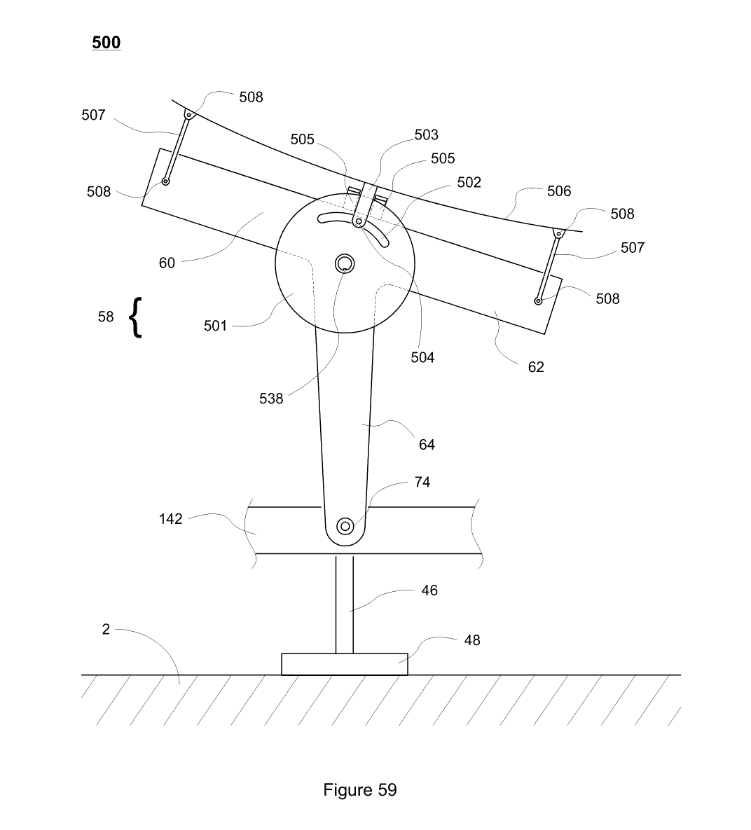

In another embodiment of the self-adjusting rib, which also adjusts mirror curvature in mechanical response to the actuator that tilts the mirror to track the sun through the day, a pivot cam is used to move the center of the mirror toward or away from the rib pivot point to adjust curvature, all as shown in FIGS. 59-75.

An embodiment of this passive curvature adjustment rib mechanism 500 is shown in FIG. 59, with mirror curvature exaggerated. In common with the above-described embodiment using pulleys, rib 58 is comprised of a main plate 60 comprising crossbar 62 and arm 64. Rib 58 is controlled by push rod 142 connected to rib 58 via an actuation bearing 74. Rib 58 is supported by a vertical support pole 46, which is attached to ground 2 by ground attachment interface 48. Compliant mirror support 506 attached to rib 58 using linkage bar 507, with hinges 508 at both ends of each linkage bar 507.

The pivot cam embodiment includes a pivot cam 501, which contains a hole 512 for sliding on the horizontal support rod 42, and a key 538 for engaging slot 240 in the horizontal support rod. Similar to the pivot bearing in the previous compound pulley embodiment, the pivot cam 501 is rotatably attached to the rib main plate 60. This arrangement allows the rib main plate 60 to move along both the translational freedom 68 and the rotational freedom 70 shown in FIG. 11. Meanwhile, the pivot cam can only move along the translation freedom 68. The pivot cam key 538 engaging the slot 240 in the horizontal support rod 42 thus provides a means of maintaining the pivot cam at a fixed orientation relative to the ground. It is to be understood that a variety of other means well-known in the art could be employed to achieve the same purpose, such as providing the horizontal support rod with a square cross-sectional shape, and providing a pivot cam with a matching shaped hole, or by providing two parallel horizontal support rods with a matching pair of holes in the pivot cam, etc.

A feature of this pivot cam embodiment that differs from the pulley embodiment is pivot cam 501, which contains a cam groove 502 on both its front and back side. The cam grooves 502 on the front and back side of pivot cam 501 have the same shape, and are aligned so as to be superimposed when viewed from the front as in FIG. 59 (see FIG. 64). Compliant mirror support 506 has attached cam-following fingers 503, hanging down from the center of compliant mirror support 506 on each side of pivot cam 501, each of which has an attached cam-following pin 504, which engages with either the front or back cam groove 502. The cam-following fingers 503 are slidably contained between two centering tabs 505, which prevent cam-following fingers 503 from moving left or right relative to crossbar 62, to which the centering tabs 505 are rigidly attached.

The centering tabs 505 provide a means to prevent the cam-following fingers 503 from moving right or left relative to rib main plate 60 while allowing them to move toward or away from the rib pivot point. It is to be understood that this functional purpose may be achieved by a variety of means, including centering tabs 505 flanking the cam-following fingers 503 shown in FIG. 59, or equivalently a vertical slot added to the cam-following fingers 503 which engages a centering tab or pin rigidly attached to rib main plate 60 thereby achieving a similar motion constraint, or by any of a number of equivalent means for preventing motion in one direction while allowing motion in a perpendicular direction that are well-known in the

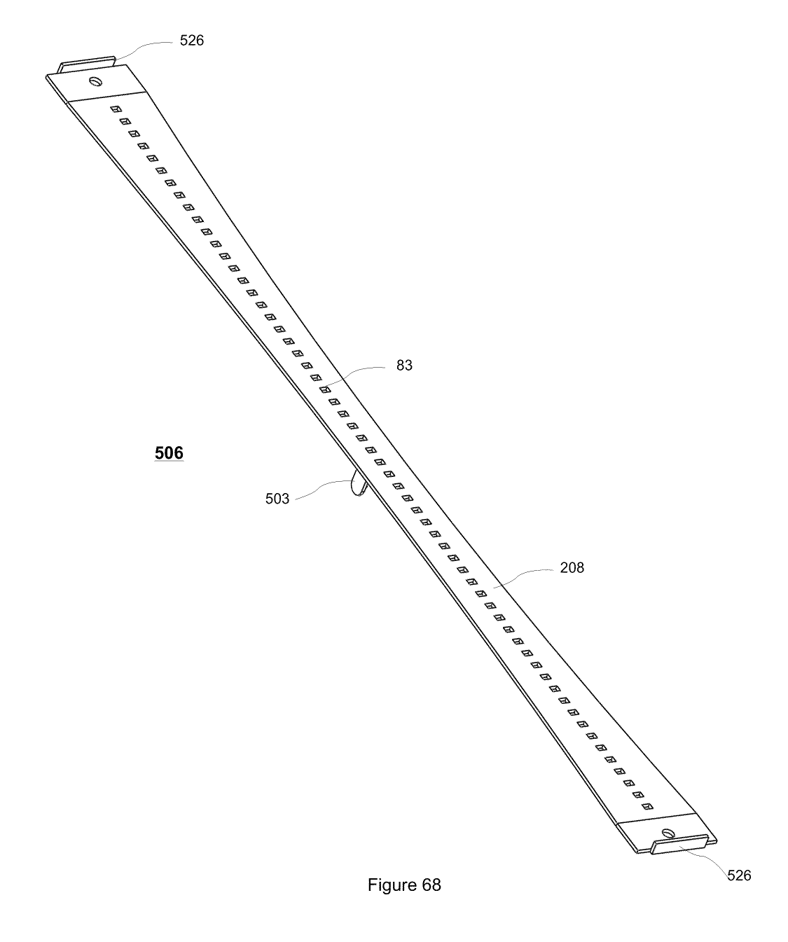

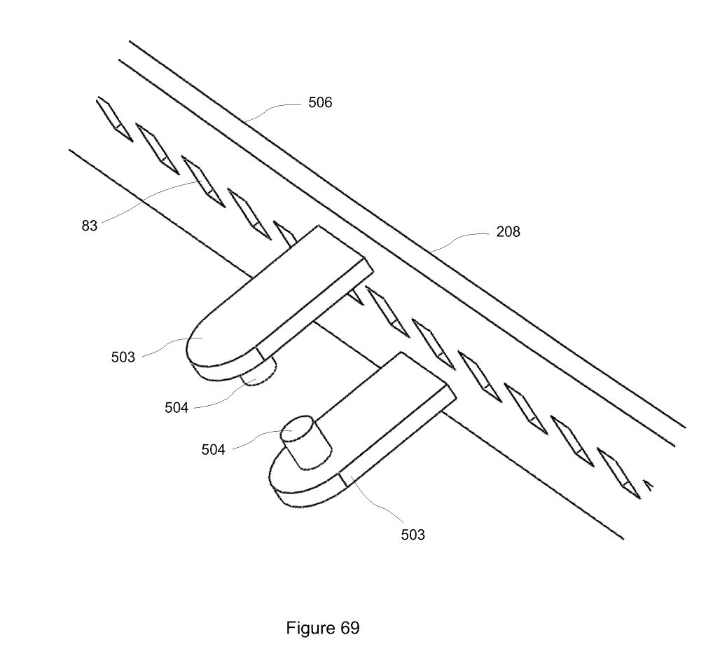

Compliant mirror support 506 of this embodiment, shown in FIG. 59 (and enlarged in FIG. 68), is different from compliant mirror support 206 of the pulley embodiment shown in FIG. 41D. For example, the compliant mirror support 506 of the pivot cam embodiment can be attached to crossbar 62 via linkage bars 507 with hinges 508 at both ends of each linkage bar 507. In another embodiment (see FIG. 71), compliant mirror support 506 can be attached to crossbar 62 via flexure plates 518. In addition, in an embodiment, compliant mirror support 506 has an hourglass shape to facilitate accuracy of deflected curvature as discussed below, and in embodiments has a single row of clip holes 83 (see FIG. 68).

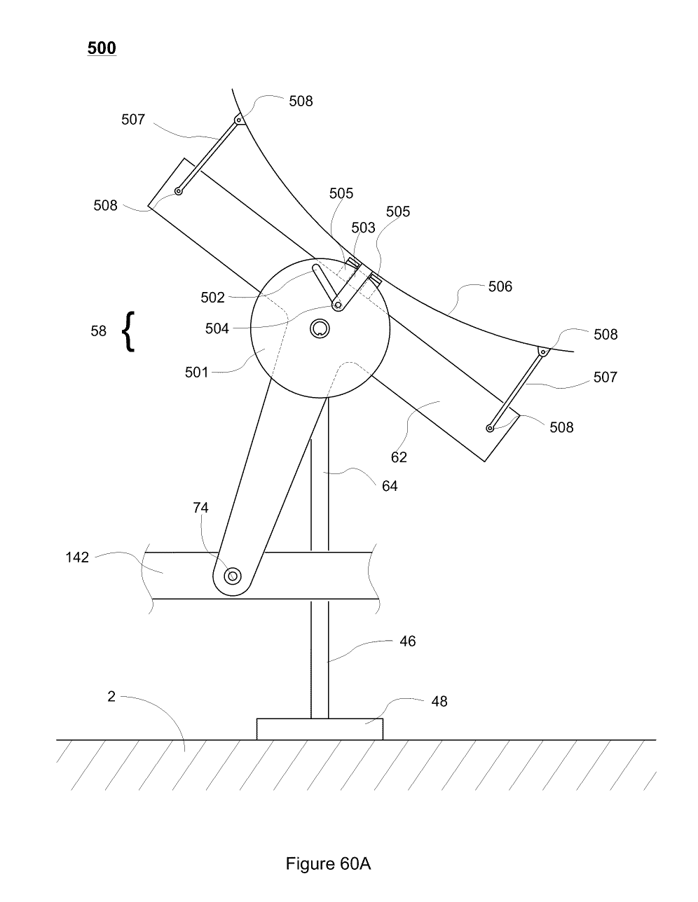

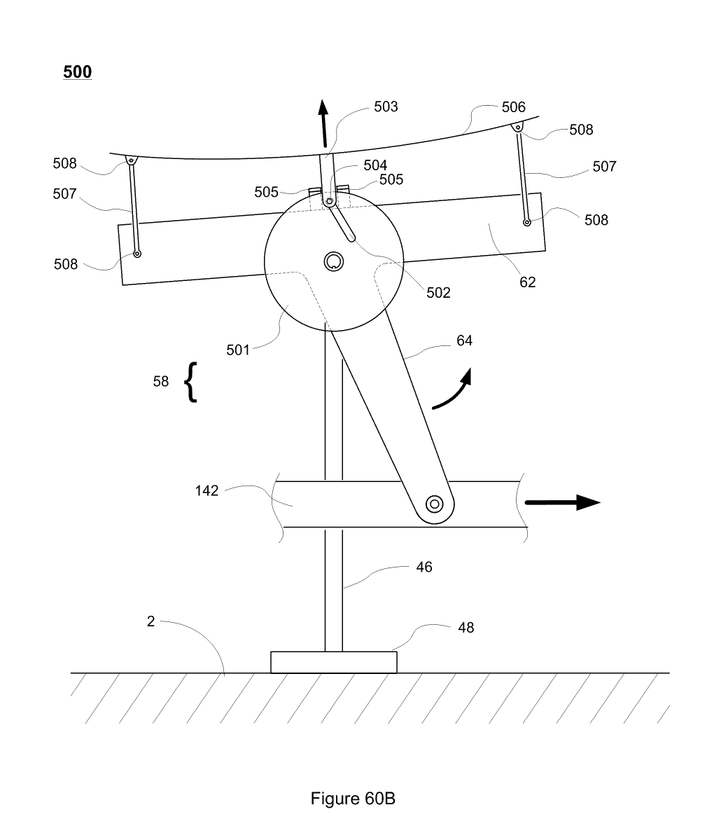

FIGS. 60A and B show the self-adjusting rib pivot cam embodiment in operation, with the mirror curvature greatly exaggerated to facilitate explanation. The rib orientation shown in FIG. 60A is the “neutral angle” for this particular mirror row, where the mirror normal at the mirror center points directly at the receiver center. This situation is the same as the previous neutral angle situation illustrated in FIG. 45A. As with the previous example, this neutral angle corresponds to the rib orientation where the optimum focal length prescribed by the analysis described above with respect to FIG. 35 is at a minimum, and where the mirror has its greatest chord depth. To cause this curvature, the cam groove 502 is shaped so that the distance from the cam center to the cam groove is shortest for this orientation; that is, when the rib is oriented in the neutral angle, the cam-following pin 504 is closest to the pivot cam center, due to the shape of the groove. This in turn increases the chord depth of the mirror, thus increasing curvature.

FIG. 60B shows the same rib, now in an orientation corresponding to a later time in the day, corresponding to mid afternoon. This is the same situation illustrated in FIG. 45D for the pulley embodiment. As push rod 142 moves to the right, causing rib 58 to rotate as shown in FIG. 60B, pivot cam 501 and its cam groove 502 remain fixed in space, with their orientation held fixed by key 538 (see FIGS. 64A and B) engaging the slot 240 in horizontal support rod 42 (see FIG. 44). Meanwhile, cam-following pins 504 remain in cam grooves 502. The rotation of the rib relative to the pivot cam causes the pins 504 to slide to a new position in the grooves. As cam-following pins 504 slide in groove 502, the shape of groove 502 forces pins 504 away from crossbar 62. This in turn forces cam-following fingers 503 away from crossbar 62, thus reducing the curvature of compliant mirror support 506.

Note that in FIGS. 60A and B, the mirror curvature is shown greatly exaggerated. This in turn causes FIGS. 60A and B to show a highly distorted cam groove, for the purpose of explanation.

FIG. 59 shows a rib with a more realistic rendering of the cam groove 502. In FIG. 59, the rib 58 and cam groove 502 are shown for a rib of a linear Fresnel reflector that is at a particular x position relative to the receiver (x=−10.5 m). Both the curvature of compliant mirror support 506 at the neutral angle and the shape of the pivot cam groove 502 vary with reflector position relative to the receiver.

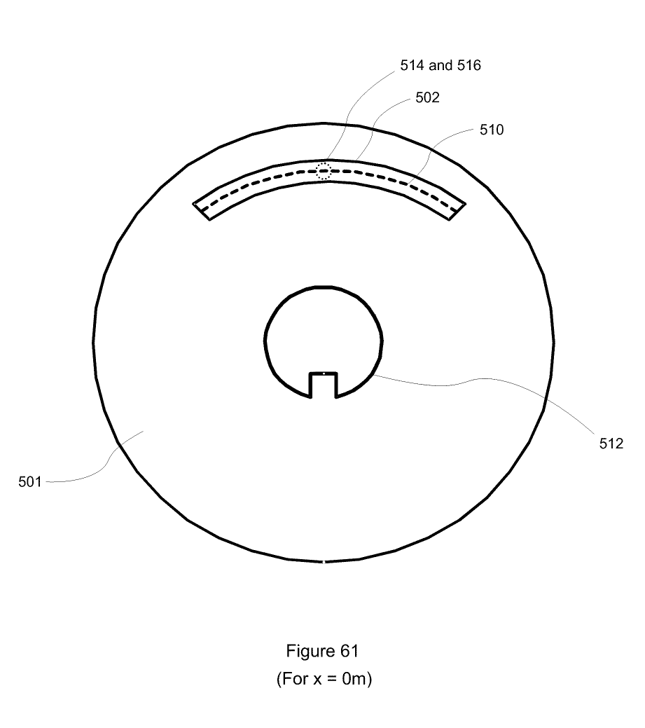

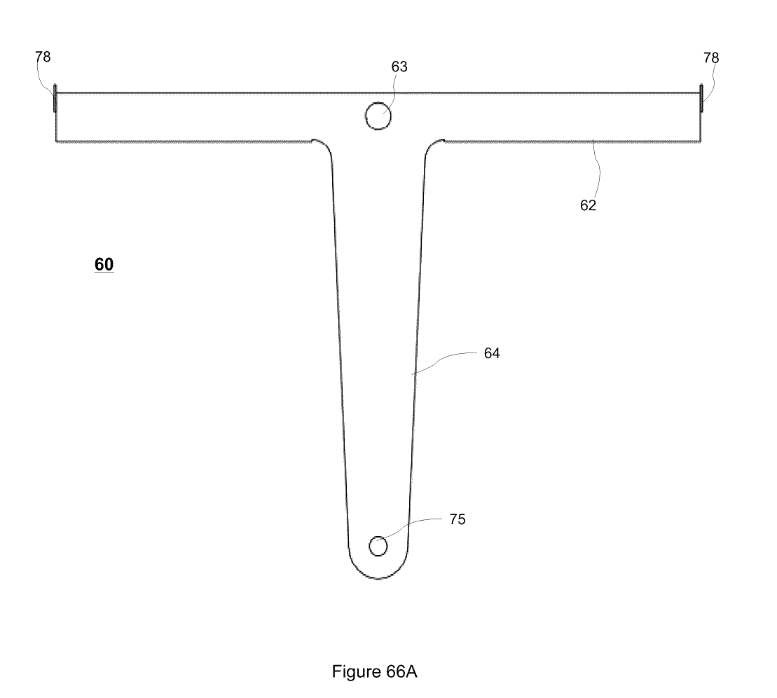

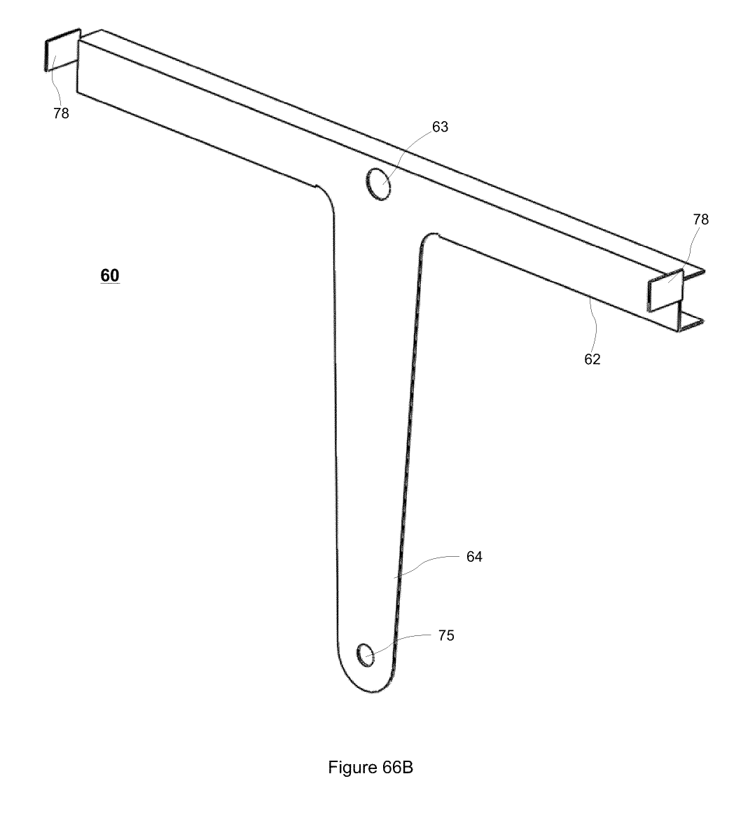

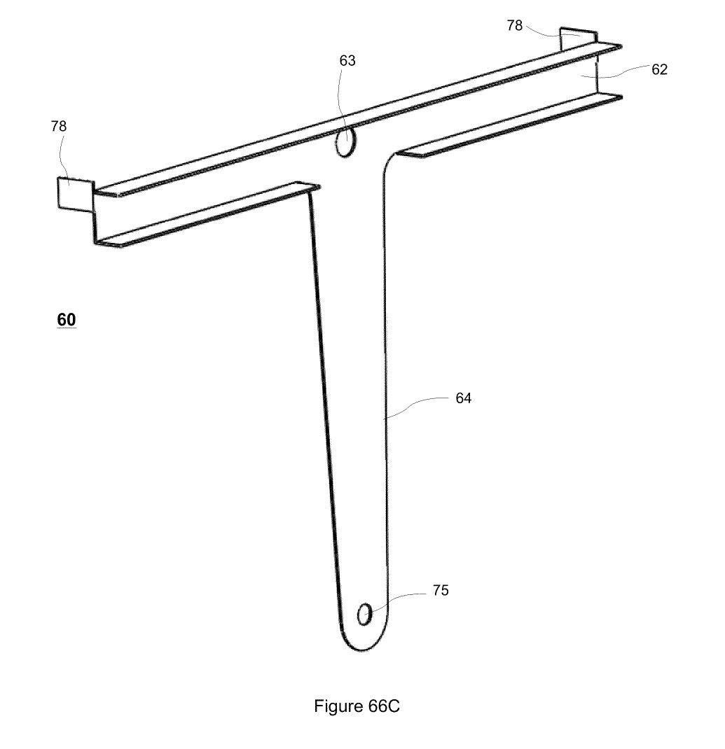

FIGS. 61, 62 and 63 show schematic drawings of the cam grooves 502 for three different example reflector positions (x=0 m, x=12.5 m, and x=25 m, respectively). Cam groove center lines 510 and cam holes 512 are also shown in these figures. Note that the rounded ends of cam grooves 502 are not shown. Also note that pivot cam groove 502 is not an arc concentric with the center of pivot cam 501 shown in each Figure. Instead each Figure shows a groove having a different shape relative to the center of pivot cam 501. Thus, when rib 58 rotates relative to pivot cam 501, causing a cam-following a pin 504 to slide to a different position in cam groove 502, the radial position of the cam-following pin 504 is forced to change in a different way in each Figure, causing the center of compliant mirror support 506 to move toward or away from the rib pivot point 540 (see FIG. 66A) in a different way for each Figure, thus varying mirror curvature as required by the position of each reflector with respect to the receiver.

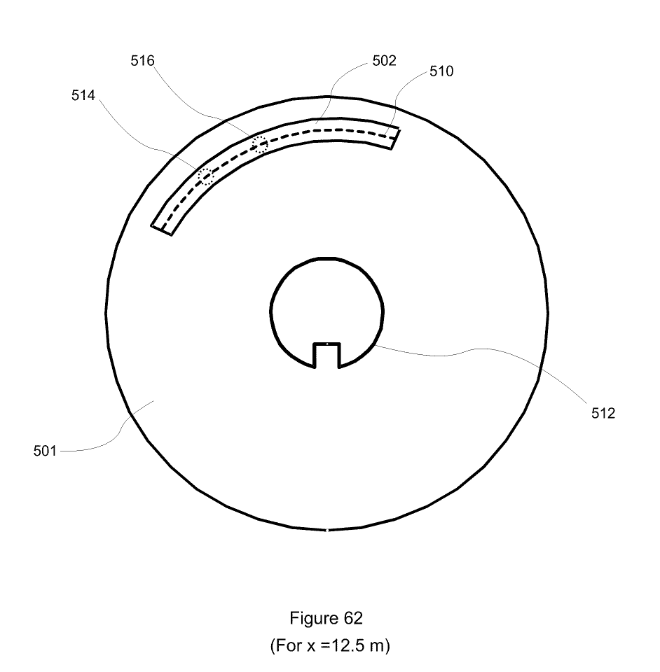

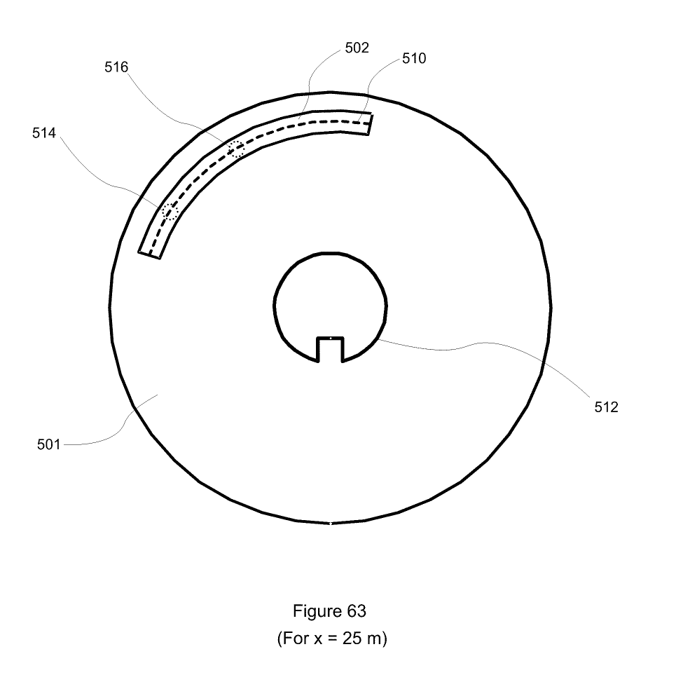

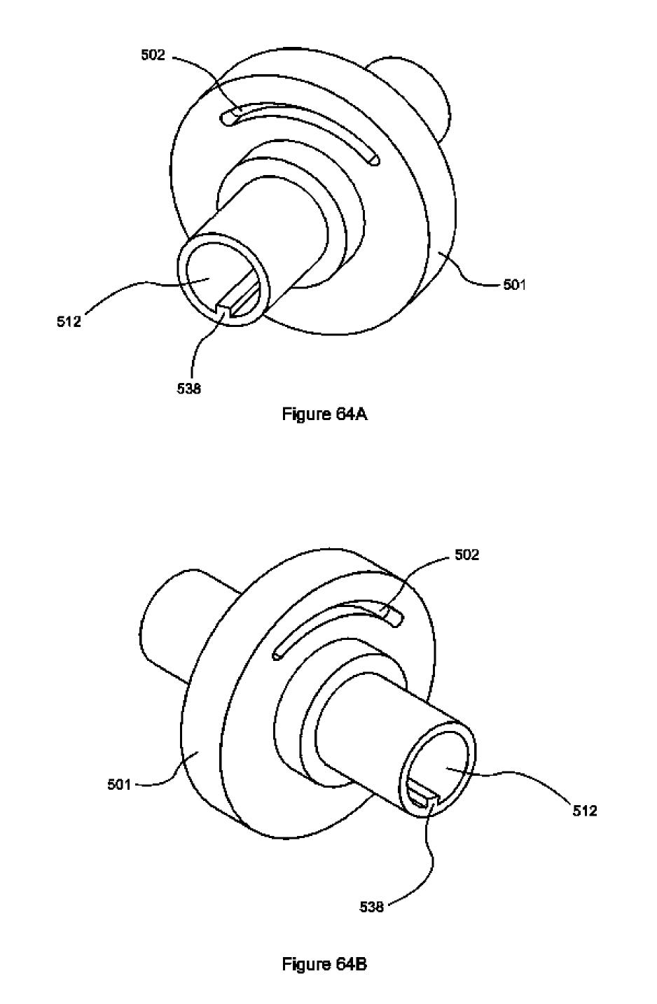

FIGS. 61-63 show the neutral position 514 of cam-following pin 504 that would occur when the corresponding rib is oriented at the neutral angle. The solar noon position 516 of cam-following pin 504 that would occur for the rib orientation at solar noon is also shown. These can be seen to vary, depending on the x position of the reflector relative to the receiver. For the cam groove shown in FIG. 61 corresponding to a reflector at x=0 m (directly under the receiver), the neutral position 514 and solar noon position 516 are coincident. FIG. 62, for a reflector position with respect to the receiver of x=12.5 m, shows the different neutral position 514 and noon position 516 of cam-following pin 504. FIG. 63, for a reflector position with respect to the receiver of x=25 m, shows further differing neutral and noon positions 514 and 516, respectively, of cam-following pin 504. Cam grooves 502 for the corresponding negative x positions would be mirror images of those shown for positive x positions.

FIGS. 64A and B show a perspective view and back perspective view, respectively, of a pivot cam 501. This example is for a reflector positioned at x=0 m. Note that a cam groove 502 is seen on both the front and back sides of the pivot cam 501; these cam grooves would appear superimposed if the pivot cam were transparent and viewed from the front as in FIGS. 59-60. In an alternative embodiment, only a single cam groove 502 is provided on either the front or back side, with a corresponding single cam-following finger 503 and cam-following pin 504 on the compliant mirror support 506 also provided. This embodiment reduces cost, but has the disadvantage of potentially allowing the cam-following pin 504 to pop out of the cam groove 502. It is also possible for the cam groove 502 to be cut all the way through the pivot cam disk, allowing a single cam-following pin 504 to pass through the groove, spanning the gap between the opposed cam-following fingers 503.

The cam groove 502 is designed to achieve the desired focal length as a function of sun angle, for the corresponding reflector x position. This functional relationship is illustrated in FIG. 35, explained above. The design of the cam groove shape is straightforward for one skilled in the art of cam design, such as for automated assembly machines, so the calculation method will be described only briefly here.

Given a desired functional relationship between normalized focal length and sun angle, such as a particular curve taken from FIG. 35, the desired cam groove shape is computed via the following basic steps:

(1) The vertical axis of a curve taken from FIG. 35 is expressed in terms of normalized focal length. This is converted to absolute focal length by multiplying each normalized focal length by the distance from the reflector center point to the receiver. This produces a function describing desired absolute focal length as a function of sun angle.

(2) The absolute focal length values are then converted to desired chord depth values. For each focal length f, this is done using the mirror width w and the equation for the desired chord depth d=[1/(4f)]*(w/2)². This calculation is applied for all focal lengths, producing a function describing desired chord depth as a function of sun angle.

(3) The chord depth values are then converted to desired cam groove radial position values, meaning the distance from the pivot cam center to the cam groove center line 510. This is accomplished by selecting a radial position rₒ corresponding to a zero chord depth, and then computing each individual radial position r=rₒ−d. By applying this calculation to all desired chord depth values produced in step (2), we obtain a function describing desired cam groove center line radial position as a function of sun angle. For FIGS. 61-63, a value of rₒ=79.4 mm was selected as an example.

(4) The result of step (3) is then converted to a function of cam-following pin 504 angle instead of sun angle. For each sun angle, the angle of the mirror normal required to reflect sunlight onto the receiver is computed, given the reflector x position and receiver height. This is a straightforward geometric calculation, also used as part of the computation of rib arm angle, etc. The resulting mirror normal angle is also the angle from the center of pivot cam 501 to the cam-following pin 504, for the particular sun angle. This calculation is applied to all sun angles, producing a function describing desired cam groove center line radial position as a function of angular position of the cam-following pin 504. This is a description of the cam groove shape in polar coordinates.

The pivot cam embodiment of the self-adjusting rib requires fewer parts than the pulley embodiment described in Section 1.5.1, because the two compound pulleys 218 and pivot bearing 214 of the pulley embodiment are replaced by a single pivot cam 501. Several additional parts required for the pulley embodiment are also eliminated, such as the primary and secondary pulley straps 220 and 226 and the shafts 236 of compound pulleys 218 (see FIGS. 39-42).

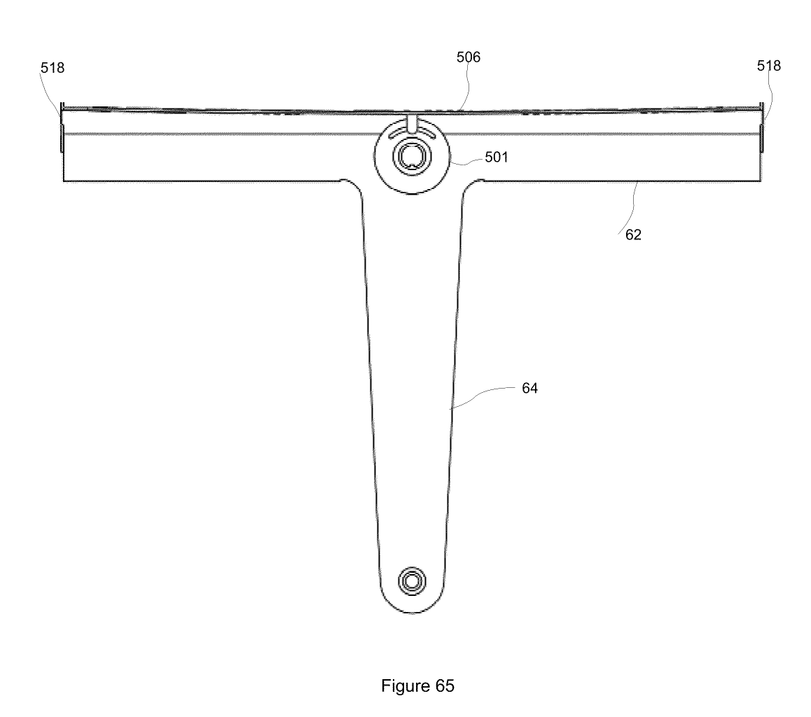

FIG. 65 shows a further improvement of the pivot cam design. In this embodiment, the linkage bars 507 are replaced by flexure plates 518, which allow the necessary compliance with no moving parts. The embodiment using flexure plates 518 is fabricated from fewer component parts than the embodiment using linkage bars 507 and hinges 508, and the constituent parts are simpler in shape.

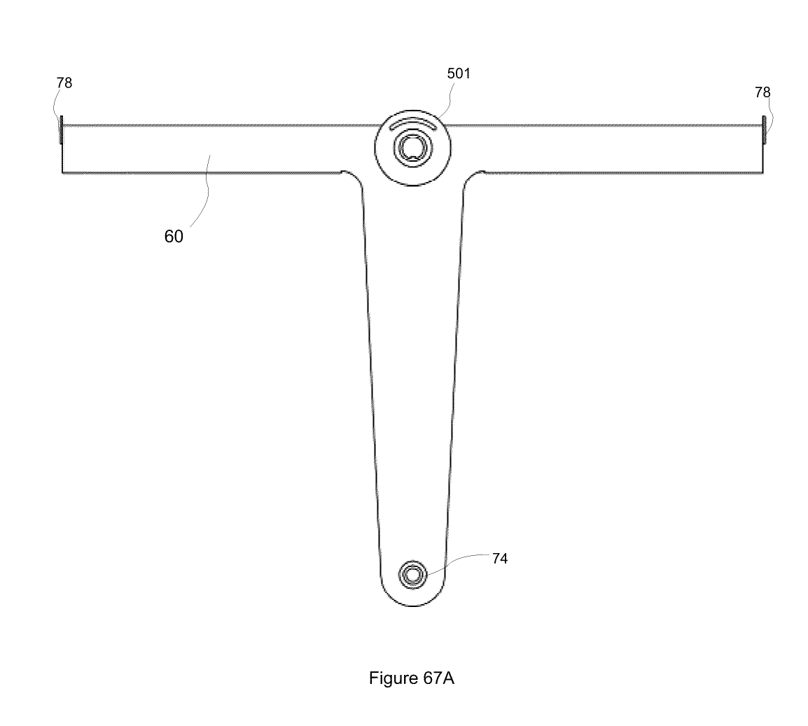

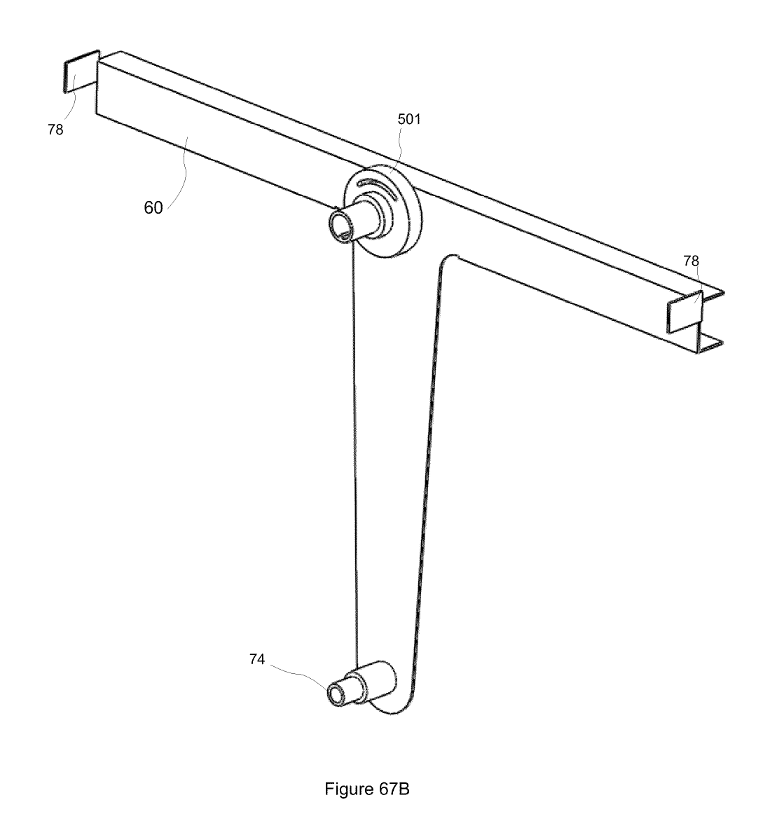

FIGS. 66-75 illustrate a method of assembling the pivot cam embodiment. FIGS. 66A, B and C show a front view, a perspective view and a back perspective view of rib main plate 60, which can be fabricated by die stamping or other means known to the art. Rib main plate 60 is equipped with extension tabs 578, and comprises crossbar 62, arm 64, pivot bearing hole 63, and actuation bearing hole 75. The center of pivot bearing hole 63 defines the rib pivot point 540. FIGS. 67A and B show a front view and perspective view, respectively, of main plate 60 after the addition of pivot cam 501 and actuation bearing 74, which can be added by simple insertion.

FIG. 68 shows compliant mirror support 506, which defines the mirror curvature. Note the hourglass plan shape, which is explained below. Compliant mirror support 506 is equipped with clip holes 83 and comprises compliant mirror interface surface 208. Cam-following finger 503 is shown extending from the underside of compliant mirror support 506.

FIG. 69 shows a close-up view of cam-following fingers 503 underneath compliant mirror support 506. Round cam-following pins 504 engage cam groove 502 on either side of pivot cam 501 (see, e.g., FIG. 59). Cam-following pins 504 can be fabricated by one of ordinary skill in the art using, e.g., simple dowels with hardened polished surfaces, and can include roller bearings. Pivot cam 501 and its cam groove 502 are made of suitable materials, as known to the art, that allow long life when cam-following pins 504 slide through cam groove 502 in operation. Example materials include Delrin™, brass, Delrin™ with polished stainless steel inserts along groove walls, etc, and other such durable materials known to the art.

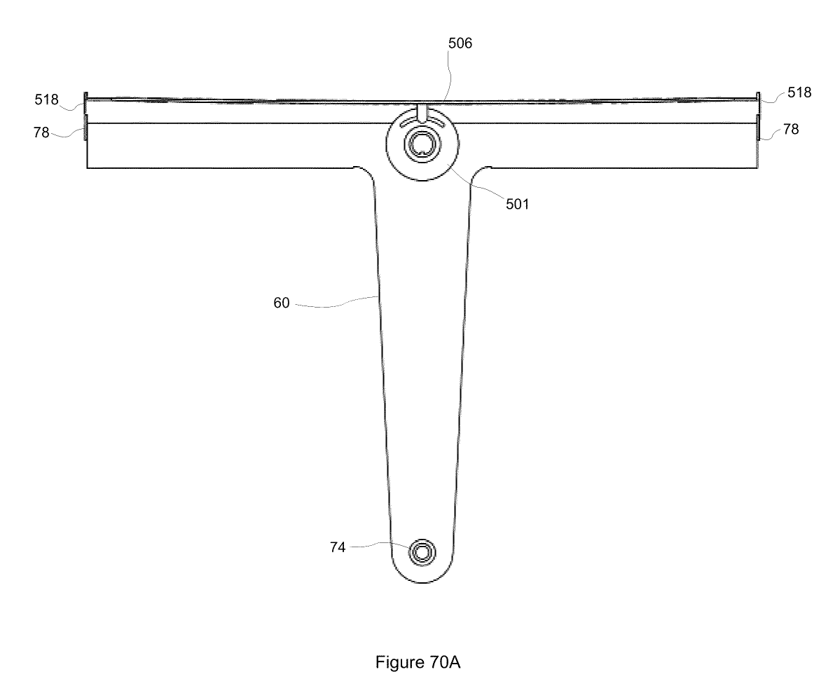

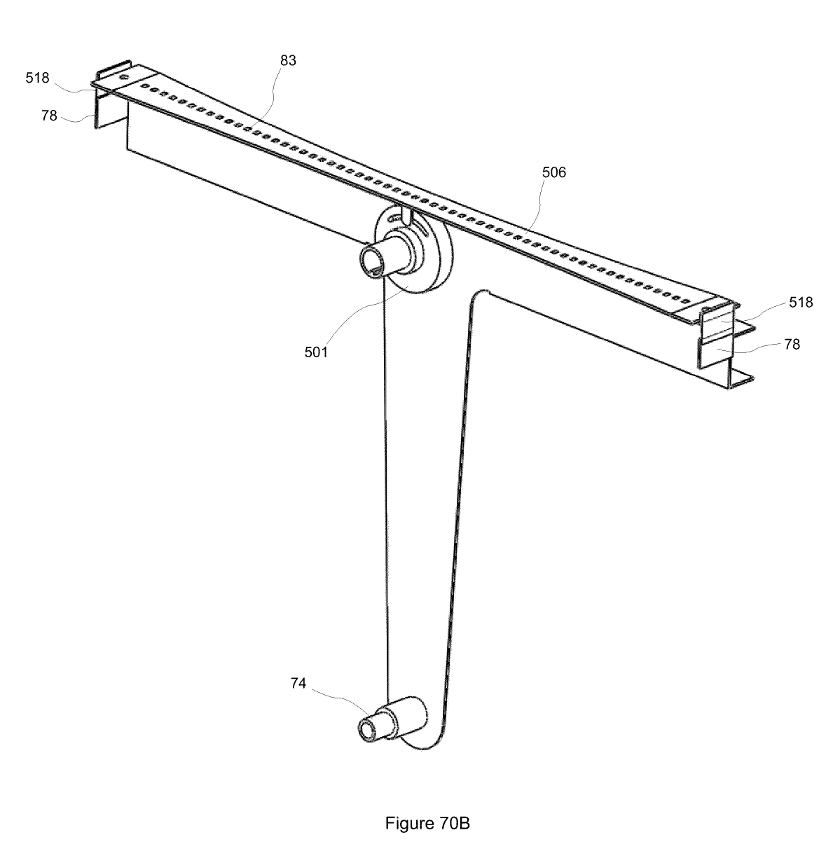

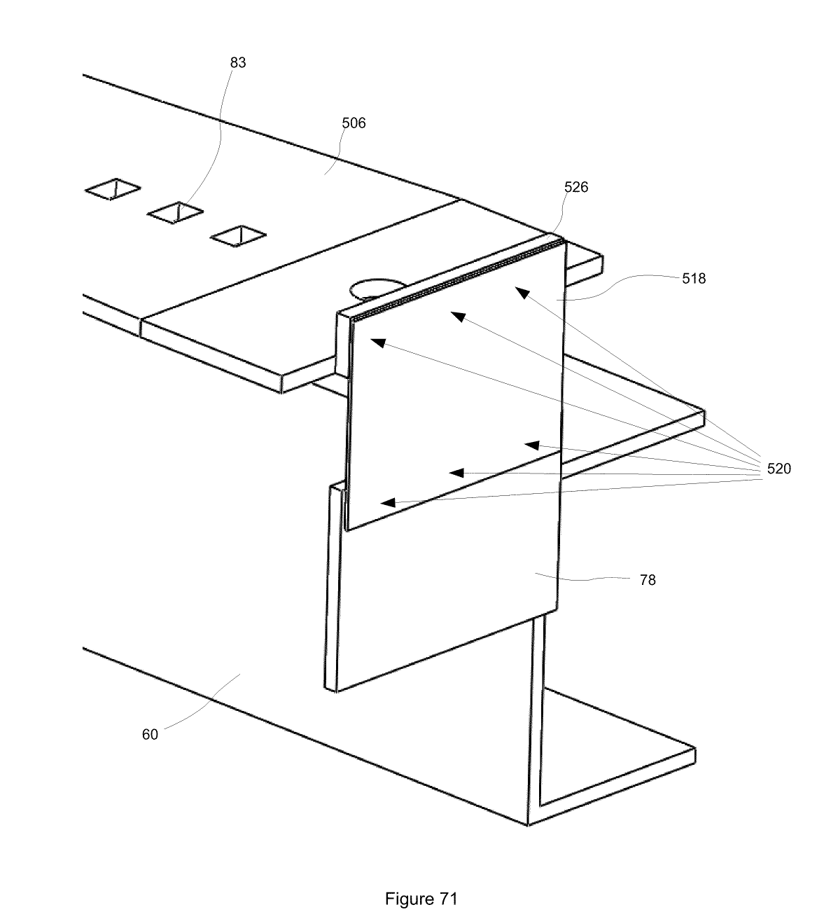

FIGS. 70A and B show a front view and a perspective view, respectively, of rib 58 with compliant mirror support 506 attached. Pivot cam 501, extension tabs 578 and flexure plates 518 are also shown in these Figures.

FIG. 71 shows a close-up view of flexure plate 518 in place on compliant mirror support 506. Also shown are clip holes 83 in compliant mirror support 506, and extension tab 578 at the end of main plate 60. Flexure plates 518 are thin plates that can be made of spring or stainless steel, and can be attached to both extension tab 578 of the rib main plate 60 and attachment flange 526 of compliant mirror support 506. Fastening locations 520 are shown on flexure plate 518 to indicate where flexure plate 518 is attached, e.g. by resistance welding, to extension tab 578 and to attachment flange 526 at the end of compliant mirror support 506. Attachment methods include resistance welding, brazing, adhesives, rivets, nuts and bolts, or other fastening methods known in the art.

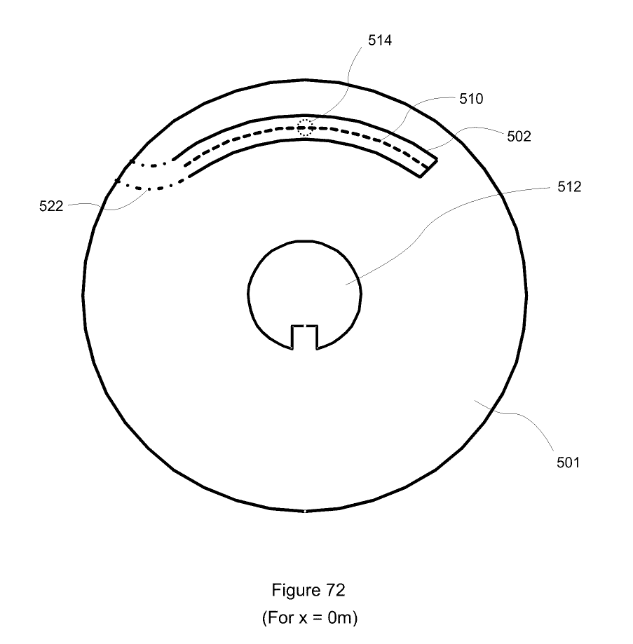

To attach compliant mirror support 506 to rib 58, cam-following fingers 503 underneath compliant mirror support 506 are assembled into cam groove 502. This can be accomplished by a variety of methods. For example, cam-following fingers 503 can bend outward, compliantly flexing to spread out to allow compliant mirror support 506 to be moved into place, then finally springing back into position when assembly is complete. Alternatively, round cam-following pins 504 can be attached after compliant mirror support 506 is attached to rib 58, for example by screwing a bolt through a hole in cam-following finger 503 into the centerline of cam-following pin 504. Further, cam groove 502 in pivot cam 501 can be extended, as groove extension 522 (shown in FIG. 72) to the boundary of pivot cam 501, allowing cam-following pins 504 to be inserted into cam groove 502 from the side.

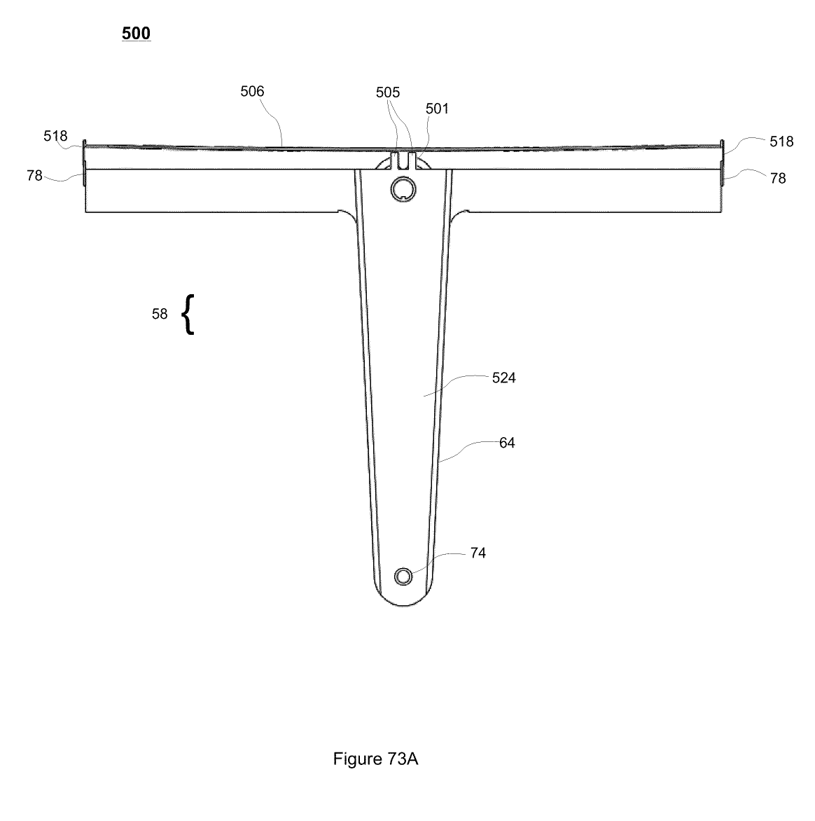

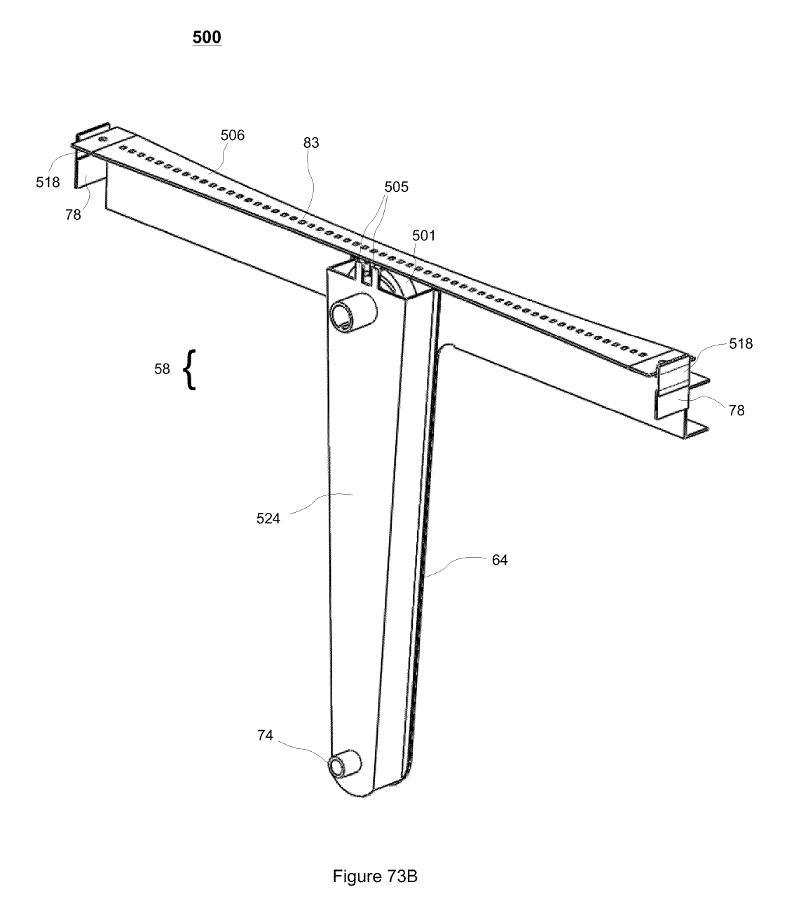

Assembly of the passive curvature adjustment mechanism 500 continues by adding retainer plate 524 as shown in FIGS. 73A and B, which are a front view and a perspective view, respectively, of the assembled passive curvature adjustment mechanism 500. Retainer plate 524 holds pivot cam 501 and actuation bearing 74 in place, and also stiffens arm 64 of rib main plate 60. Retainer plate 524 is attached to rib main plate 60 along both edges by a method known to the art, e.g., resistance welding. Retainer plate 524 can be fabricated from the drop remaining after stamping main rib plates 60 (see, e.g., FIG. 66), thus recovering raw material that would otherwise be scrapped. This means the raw material requirement for the pivot cam embodiment is about half that required for the pulley embodiment.

FIGS. 73A and B show the centering tabs 505 attached to the retainer plate 524. As an alternative embodiment, the centering tabs may be attached to the rib main plate 60 as shown in FIG. 59, to both plates, or to another part fixedly attached to either or both of these plates.

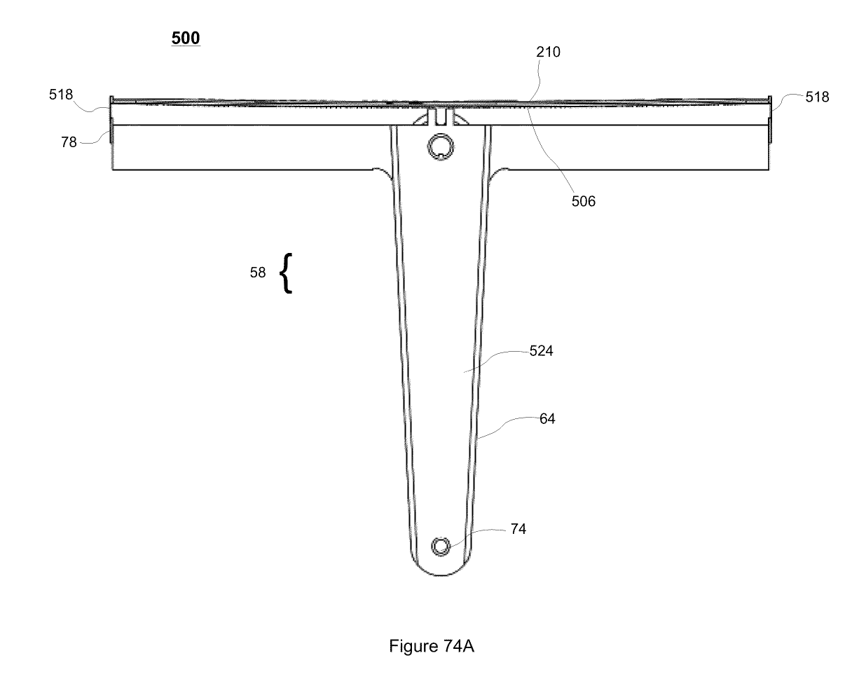

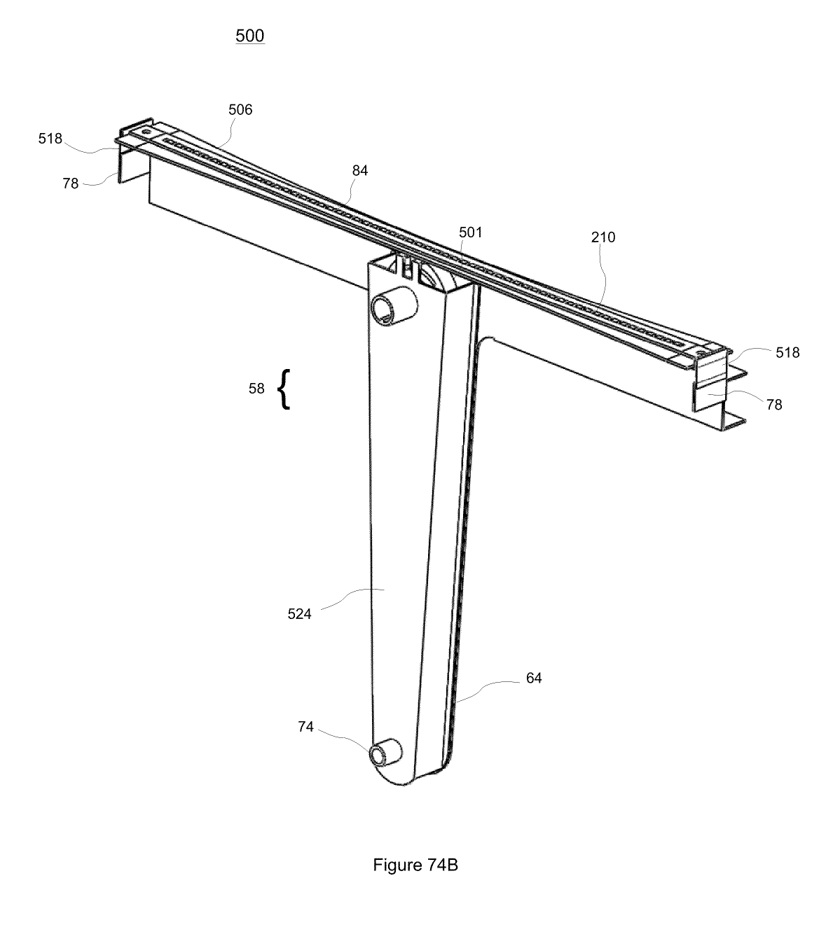

Finally compliant top strap 210 is added. FIGS. 74A and B show front and perspective views respectively of the assembled passive mirror adjustment mechanism 500. Strap 210 is added after mirror sheet 20 (see, e.g., FIG. 32) is installed, to clamp mirror sheet 20 against the compliant mirror interface surface 208 of compliant mirror support 506. As with the previously-described pulley embodiment, top strap 210 is held against compliant mirror support 506 with a series of clips 85, which are similar to staples (see, e.g., FIG. 32). However, in the pivot cam embodiment shown in FIGS. 74A and B, there is only one row of clips 85, thus reducing the number of clips 85 and clip holes 83 needed by a factor of two. If desired, two rows of clips could be employed, similar to the design shown in FIG. 41. Additional fastening could be provided using the holes at each end of the compliant top strap 210, as described above in the explanation of FIG. 28.

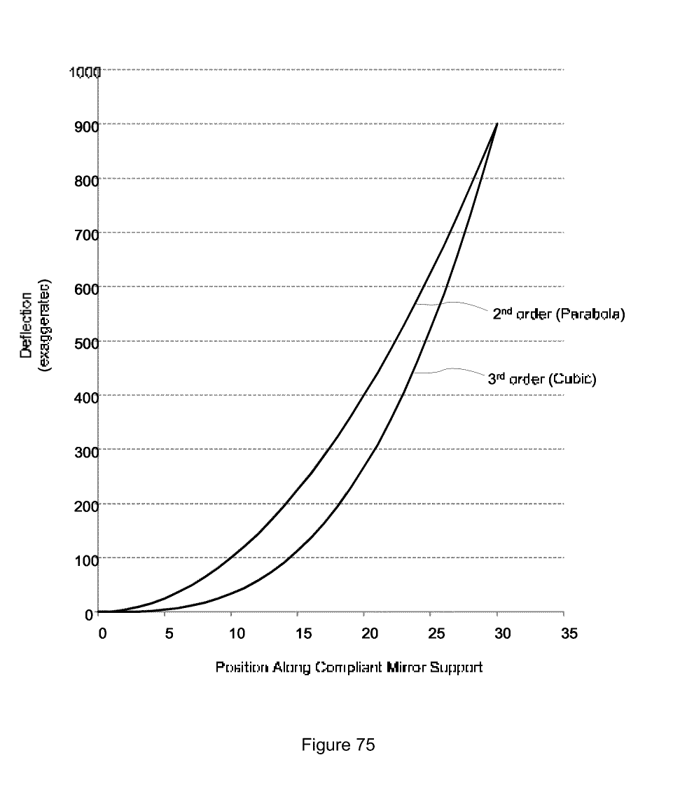

In an embodiment, the contour defining the hourglass shape of compliant mirror support 506 is selected to provide a deflection matching the desired parabolic shape corresponding to a second-order polynomial function, rather than the shape corresponding to a third-order polynomial function that would result for deflection of a beam of ordinary constant cross-section. A beam of constant cross-section will tend to deflect along a curve defined by a third-order cubic polynomial, whereas higher performance may be achieved by a compliant mirror support that bends along a curve defined by a second-order parabolic polynomial. The difference between these deflection shapes is illustrated in FIG. 75, where the horizontal axis is position along the length of the beam, measured from the beam center, and the vertical axis is beam deflection. The deflection is shown greatly exaggerated for the purpose of explanation. The hourglass plan shape of compliant mirror support 506 can be tuned to achieve a deflection shape closely approximating the desired second-order parabola curve. By providing a narrower width at the center of the compliant mirror support (corresponding to position 0 in FIG. 75), deflection curvature there is comparatively higher than the deflection curvature at the end of the compliant mirror support (corresponding to position 30 in FIG. 75), where the beam is wider and therefore stiffer. This increased curvature at the center of the compliant mirror support results in a deflection curve substantially matching the desired second-order polynomial function.

### 2. Manufacturing and Installation Method

The linear Fresnel collector design described in Section 1 is a significant improvement over the prior art because it eliminates the space frame component of prior designs, while also reducing material content comprising the mirror surface. This greatly reduces material requirements. In addition, the current collector allows a very efficient manufacturing and installation method, described in this section.

### 2.1. Reflective Laminate Sheet Manufacture

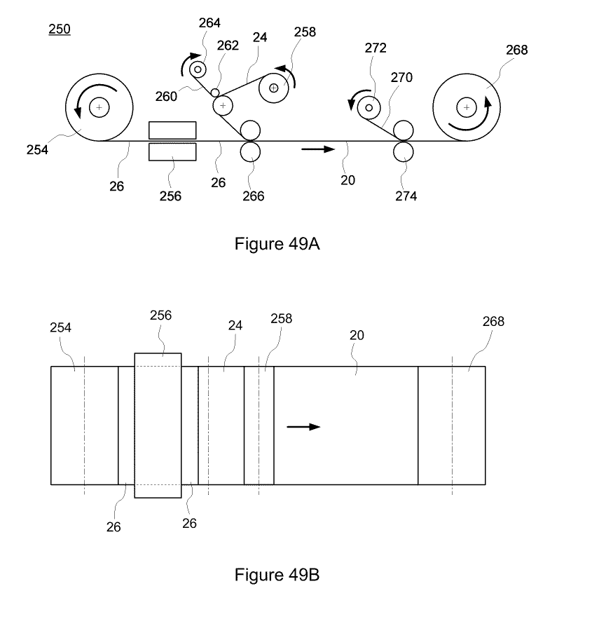

The first step in this approach is to use roll-to-roll manufacturing techniques to produce a roll of reflective laminate material ready to install at the site where the collector is being constructed. FIG. 49A shows a schematic diagram of a first roll-to-roll manufacturing process 250 for a roll of reflective laminate sheet. A backing substrate sheet 26 is unrolled from input backing substrate roll 254, and passes through an optional material preparation device 256 which applies leveling, cleaning, drying, surface roughening, or adhesive application operations as may be required by different applications. Meanwhile, reflective polymer film 24 is unrolling from reflective polymer film roll 258. If the reflective polymer film 24 has pre-applied adhesive, then the adhesive cover sheet 260 is separated from the reflective polymer film 24 at separation roller 262 and taken up onto the adhesive cover sheet take-up roller 264, allowing the reflective polymer film 24 to proceed with its adhesive layer exposed. The backing substrate sheet 26 and reflective polymer film 24 are then joined at the nip laminator rollers 266, which press the backing substrate sheet 26 and reflective polymer film 24 together to form a reflective laminate sheet 20, which is then rolled up into reflective laminate sheet roll 268. If desired an optional protective film sheet 270 can be added by unrolling it from a protective film roll 272 and joining it with the reflective laminate sheet 20 at second nip laminator rollers 274.

FIG. 49B shows a top view of the first roll-to-roll manufacturing process 250 of FIG. 49A. The separation roller 262, adhesive cover sheet take-up roller 264, protective film roll 272, and second nip laminator rollers 274 are omitted for clarity.

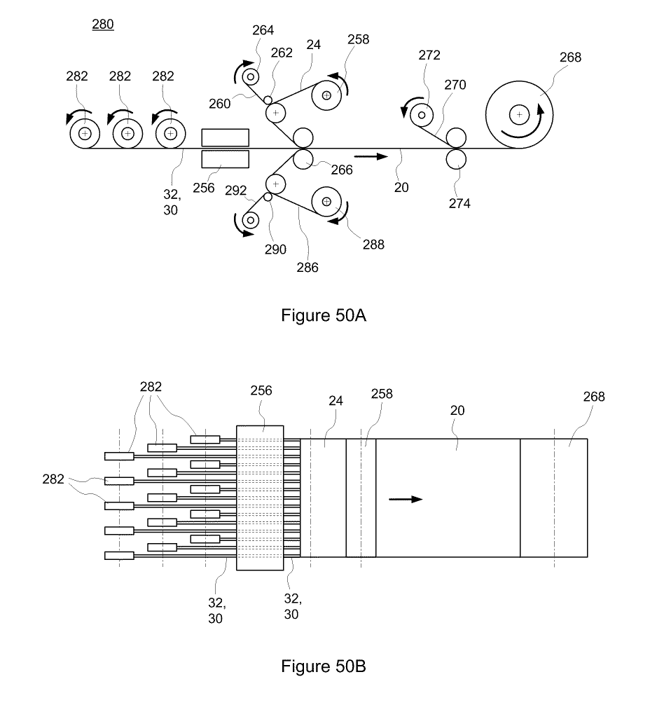

FIGS. 49A and 49B show a roll-to-roll manufacturing process for producing a reflective laminate sheet with a contiguous backing, as shown in FIG. 3. FIGS. 50A and B show a second roll-to-roll manufacturing process 280 which produces a reflective laminate sheet comprising embedded wires or strips, as shown in FIGS. 6 and 7. Instead of a single backing substrate sheet unrolled from a single backing substrate roll, this process includes multiple spools 282 of wire 32 or strip 30 which proceed through an optional material preparation device 256 and then on to the nip laminator rollers 266. Similar to the first roll-to-roll manufacturing process, reflective polymer film 24 unrolls from reflective polymer film roll 258, optionally separating from an adhesive cover sheet 260 at a separation roller 262 and proceeding to the nip laminator rollers 266. In addition, a backing material sheet 286 unrolls from a backing material roll 288, optionally separates from a backing adhesive cover sheet 292 at a second separation roller 290 and proceeds to the nip laminator rollers 266. The separation rollers 262 and 290 are optional in the sense that pre-applied adhesive can be included in either the reflective polymer film 24 or backing material sheet 286, or both. The wires 32 or strips 30, reflective polymer film 24, and backing material sheet 286 are joined at the nip laminator rollers 266 to produce a reflective laminate sheet 20, which is then rolled onto a reflective laminate sheet roll 268. The nip laminator rollers 266 can have grooves to accommodate the uneven thickness of the reflective laminate sheet 20 (see FIGS. 6 and 7), or can be made of a compliant material that can accommodate the uneven thickness. Once again an optional protective film sheet 270 can be added by unrolling it from a protective film roll 272 and joining it with the reflective laminate sheet 20 at second nip laminator rollers 274, which again can include grooves or compliant materials to accommodate the uneven thickness of the reflective laminate sheet 20.

FIG. 50B shows a top view of the second roll-to-roll manufacturing process 280 of FIG. 50A. The separation roller 262, adhesive cover sheet take-up roller 264, protective film roll 272, and second nip laminator rollers 274 are omitted for clarity. This top view shows the position relationship between the wire or strip spools 282, which must be positioned to allow tight spacing between individual wires 32 or strips 30. The staggered configuration shown here is one arrangement for solving this problem; other equivalent arrangements obvious to those of ordinary skill in the art can also be used and are considered to be within the spirit of the claims hereof. FIGS. 50A and 50B are schematic diagrams showing a reflective laminate sheet with 15 separate wires or strips; it is to be understood that the number of wires or strips can be different for different applications. For instance, the example design described in Section 1 employs 61 strips.

Whether produced by the first or second roll-to-roll manufacturing process, the finished laminated reflector sheet rolls can then be transported via truck to the solar field in which they are to be used to manufacture solar collectors.

### 2.2. Component Manufacture

A number of additional components are required for the linear Fresnel collector. These include support elements, ribs, self-adjusting ribs, receiver supports, receivers, and so on. These are to be manufactured in factories using methods well-known in the art, and transported to the solar field for final assembly and installation.

### 2.3. Field Preparation

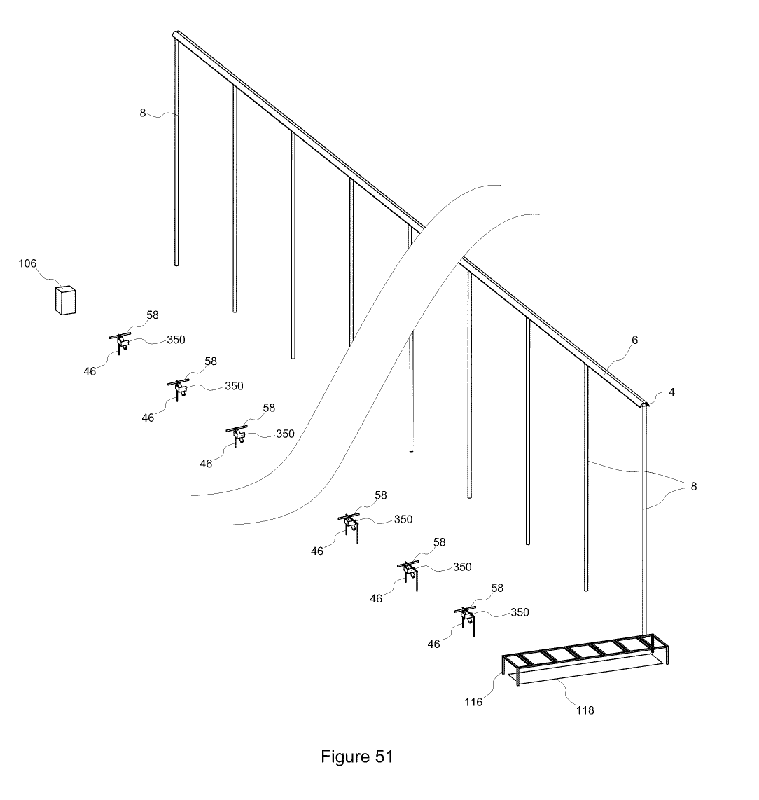

FIG. 51 shows the site for the linear Fresnel collector prepared for installing a mirror sheet. Shown are the fixed mount 106, tension device frame 116, and tension weight hole 118, ready for mirror attachment. The mirror supports 40 (comprising vertical support poles 46, ribs 58 (or 200 in the self-adjusting rib embodiment), and other components shown in FIGS. 8A and B) are installed. The ribs can be of either the fixed focal length (58) or self-adjusting (200 or 500) variety. The horizontal support rods 42 are carefully aligned to lie on a common line 50 (see FIG. 10), using laser alignment or surveying techniques. Each rib 58 is held in a fixed position using a temporary locking bracket 350, which holds the rib at the desired installation position along the horizontal support rod 42, and also at the desired installation orientation where the rib's crossbar 62 (see FIG. 11) is horizontal.

The receiver supports 8, receiver 4, and secondary reflector 6 are shown installed in FIG. 51; these are optional. Other elements can also be installed at this point, such as additional fixed mounts, additional rows of supports, additional mirrors already installed on supports, actuation units, and so on. These are optional, and are omitted from this figure for clarity.

### 2.4. Mirror Sheet Installation

After field preparation, mirror sheets are installed by unrolling reflective laminate sheet from a reflective laminate sheet roll 268, described in Section 2.1 above and hereafter referred to as a “mirror sheet roll” for brevity. In broad terms, the first end of the mirror sheet is attached to the fixed mount 106, and the mirror sheet roll is progressively unwound, deploying the mirror sheet. As the mirror sheet roll unwinds, it passes ribs shown in FIG. 51, and is attached to each rib as it passes. Some tension is applied to the mirror sheet during this process. After passing the final rib, the final end of the mirror sheet is attached to the tension device 110 (see FIG. 13), and final tension is applied to the mirror.

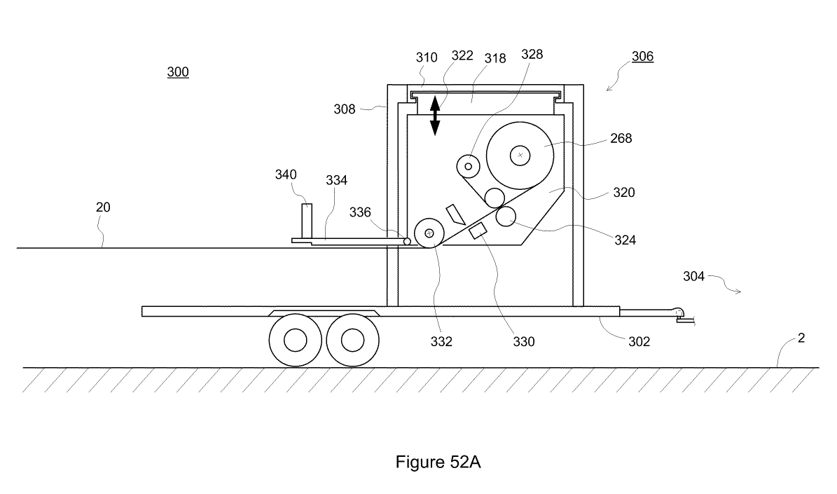

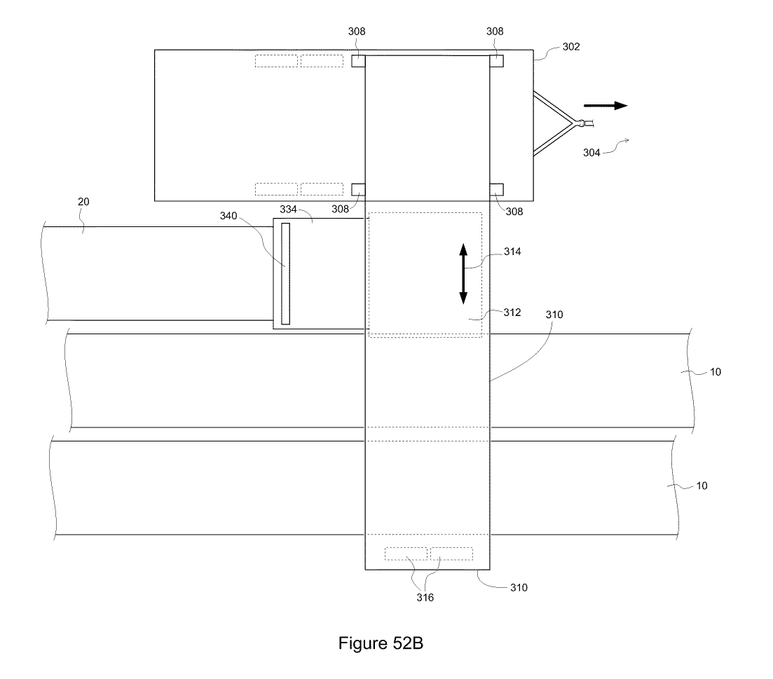

FIGS. 52A and 52B show a deployment vehicle for installing the mirror sheet. The deployment vehicle 300 has a chassis 302 for supporting the mirror installation apparatus 306. This chassis 302 provides a means for moving the vehicle along the length of the mirror, while deploying the mirror sheet 20. The figures show the chassis 302 as a trailer pulled by a tow vehicle 304 (not shown), but other self-powered chassis designs can also be used, including mounting the mirror installation apparatus 306 on the back of a flatbed truck.

The mirror installation apparatus 306 is comprised of a support frame 308 which carries a track 310, upon which slides a carriage 312 (see FIG. 52B). The track 310 extends laterally past the side of the deployment vehicle 300, and the carriage 312 can move along this track 310 to either a retracted position over the chassis 302 or to an installation position to the side of the vehicle. The track 310 allows the carriage 312 to move in a lateral translation direction 314 (see FIG. 52B), and the carriage 312 includes features that allow it to stop and hold its position at a desired location along the track 310. In this way the carriage 312 can positioned over the line required to install the current mirror. The end of the track 310 opposite the deployment vehicle 300 can include outrigger wheels 316 (see FIG. 52B) to support the end of the track and prevent tipping.

Referring to FIG. 52A, the carriage 312 comprises a main sliding frame 318 and a roll carrier frame 320. The roll carrier frame 320 can move in a vertical motion direction 322 to allow the position of the roll carrier frame 320 to be adjusted to a desired height.

Attached to the roll carrier frame 320 is the mirror sheet roll 268, which unwinds through a set of nip unwinding rollers 324. The mirror sheet roll 268 can be attached to a roll unwinding drive unit (not shown), which maintains appropriate relative tension between the mirror sheet roll and unwinding nip rollers to ensure proper roll unwinding.

If the mirror sheet roll 268 includes a protective film sheet 270 (not shown; see FIGS. 49A and 50A), this is separated from the mirror sheet 20 at the nip unwinding rollers and rolled up onto the protective film take-up roll 328.

The mirror sheet 20 then passes through a cutting tool 330, which can be used to cut the mirror sheet 20 at desired times. Finally, the mirror sheet 20 passes around a reorientation roller 332 which changes the orientation of the mirror sheet 20 from its initial direction to the desired mirror deployment orientation.

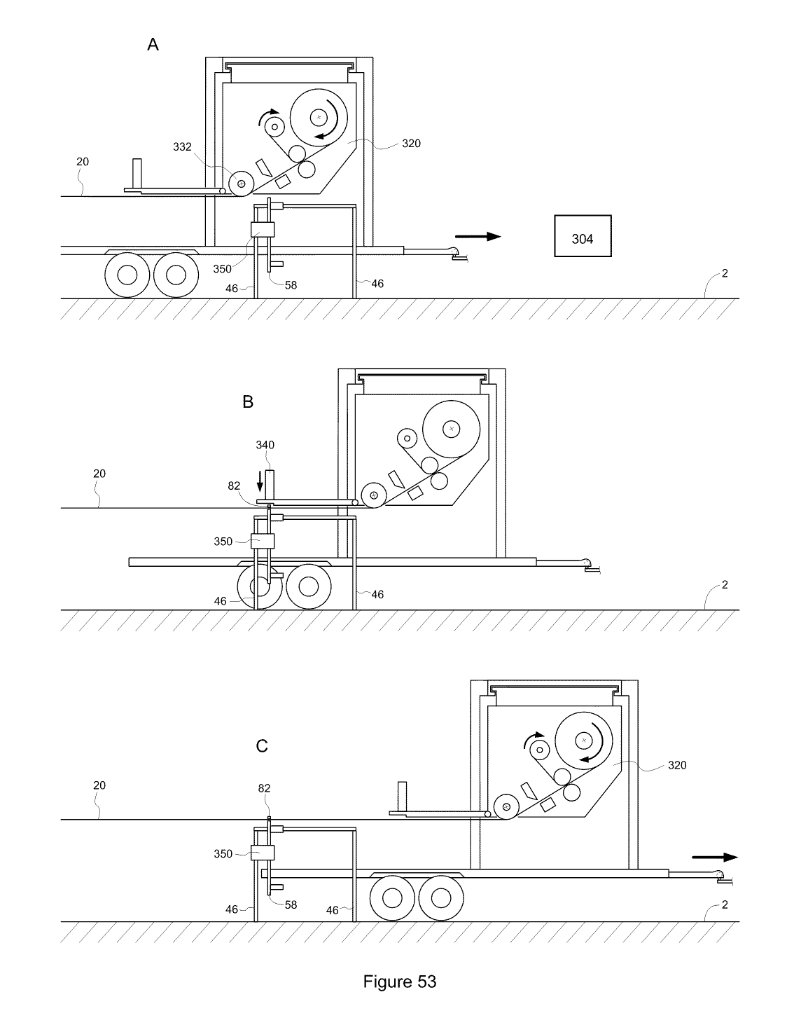

Attached to the roll carrier frame 320 is also an attachment deck 334 which is attached to the roll carrier frame 320 by means of a retraction hinge 336. The deck includes installation tools 340 for attaching the top strap 82 (see FIGS. 53B and C) to each rib as the deployment vehicle 300 passes. These installation tools 340 can be simple bins of fasteners and wrenches for manually installing top straps such as those shown in FIGS. 28 and 29. Alternatively, the installation tools 340 might include bins of clips and special-purpose hand-tools for installing the rib top straps such as shown in FIG. 30-32 or 40. As yet another alternative, the installation tools 340 might include special punches for creating holes in the mirror sheet 20, or automated mechanisms for installing a series of clips at high speed. Which of these or other alternatives is selected depends on the application.

The deployment vehicle 300 can also include a rack for carrying a supply of rib top straps (not shown).

FIGS. 53A, B and C show the deployment vehicle in operation as it moves past a rib while deploying the mirror sheet 20. In FIG. 53A, the deployment vehicle is approaching the rib. As it moves to the right, the various rollers on the roll carrier frame 320 rotate to unwind the mirror sheet 20 and deploy it behind the vehicle. In so doing they maintain the deployed mirror sheet 20 at a desired tension level, for stability and ease of handling. There are several ways this can be accomplished, but advantageously, the vehicle motion, in this case caused by the tow vehicle 304, is allowed to initiate roller motion. In this embodiment, the mirror sheet 20 is pulled out of the roll carrier frame system commensurate with vehicle motion. Maintaining tension in the deployed mirror sheet 20 can be achieved by an electronic control system receiving input from a load cell on the reorientation roller 332, or by a simple system involving friction clutches and drive motors that stall at a desired torque level. The mirror sheet tension during deployment can be as low as 0.5 pounds per inch of mirror sheet width for handling light sheets, or as high as 100 pounds/inch for deploying the sheet near nominal operating tension levels.

FIG. 53A shows the deployment vehicle approaching the rib 58, with the reorientation roller 332 at a height that will clear the rib 58 without colliding. The vertical motion capability of the roll carrier frame 320 is used to make adjustments as required to assure clearance, despite variations due to ground height variation, etc.

FIG. 53B shows the deployment vehicle at the rib location, where the installation tools 340 are used to install the top strap 82 securing the mirror sheet 20 to the rib, pressing the mirror sheet 20 against the rib's mirror interface surface 66 (see FIG. 11).

FIG. 53C shows the deployment vehicle moving on past the rib, with the top strap 82 installed. The rollers on the roll carrier frame 320 continue to unwind, maintaining desired tension.

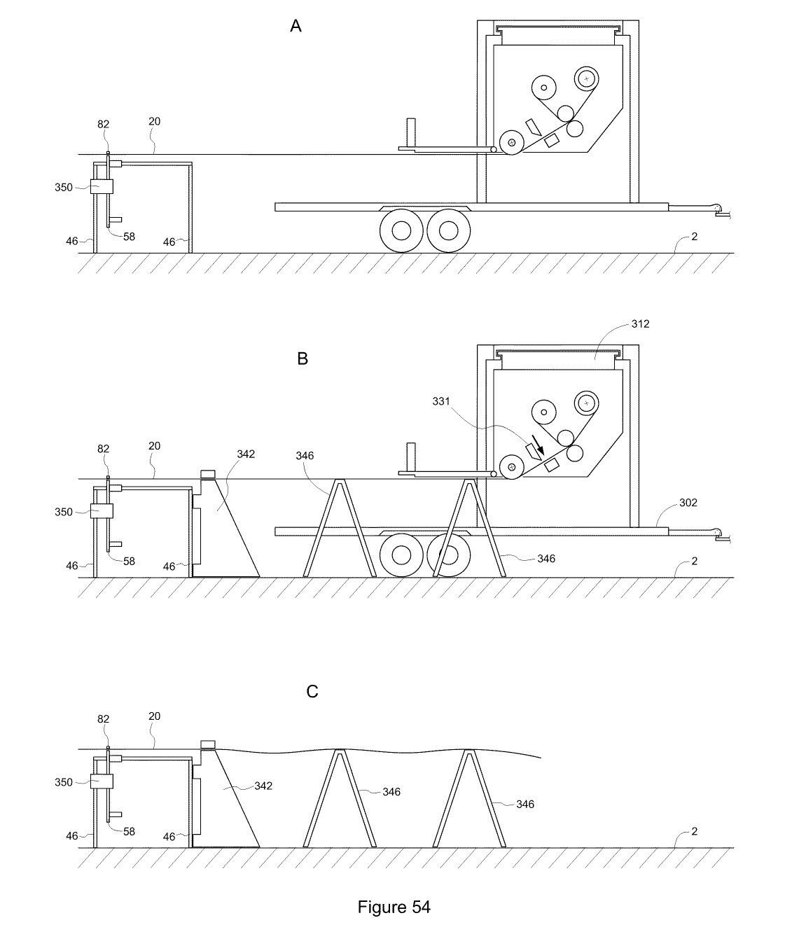

FIG. 54 shows the deployment vehicle 300 terminating installation after the mirror sheet 20 is attached to the final rib. It is desired to leave a tail of mirror sheet 20 available for attachment to the gather clamp 104 (see FIGS. 13-15). Meanwhile, it is also desired to maintain applied tension in the installed sheet. In FIG. 54A, the deployment vehicle 300 has advanced past the final rib. In FIG. 54B, a temporary tension clamp 342 has been added, which clamps on the mirror sheet 20 to maintain tension. The temporary tension clamp 342 can include connections to the mirror support vertical pole 46 to develop the necessary reaction force. Mirror tail supports 346 are also added. Once these elements are in place, the cutting tool blade 331 can advance, cutting the mirror sheet 20. After this point the deployment vehicle carriage 312 can retract into a position over the chassis 302, and the deployment vehicle 300 can depart, as shown in FIG. 54C, leaving the mirror tail ready for attachment to the gather clamp 104 and tension cable 108 (see FIGS. 13-15).

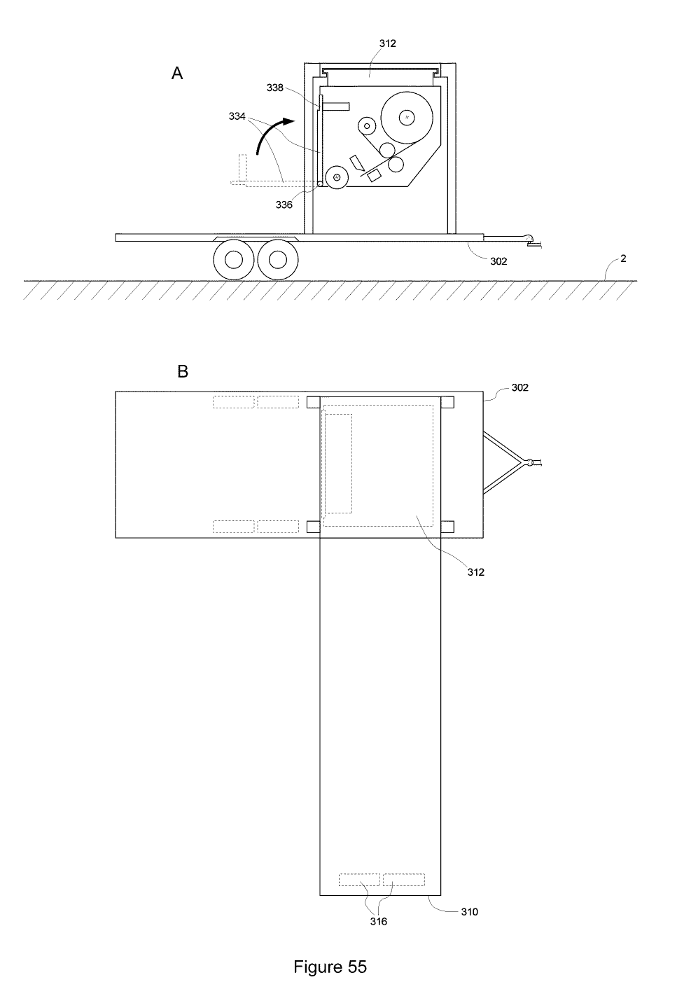

FIG. 55A shows a side view of the deployment vehicle illustrating the operation of the retraction hinge 336, which allows the attachment deck 334 to be moved into a stow position 338 so the carriage 312 can be retracted into a position over the chassis 302. This is necessary to allow the deployment vehicle 300 to depart after mirror installation, to prevent the carriage 312 from colliding with the tension device frame 116 (see FIGS. 13 and 1 (see FIGS. 13 and 14). FIG. 55B is a top view of the deployment vehicle shown in FIG. 55A.

The final steps of mirror installation are to attach the gather clamp 104 and tension cable 108, which is in turn attached to the tension weight 112 (see FIGS. 13 and 14). The tension weight 112 is then lowered to apply final tension, after which the temporary tension clamp 342 and mirror tail supports 346 (see FIG. 54) can be removed. FIG. 13 shows the result after this is completed. Once all mirrors of the linear Fresnel collector are installed, the rib temporary locking brackets 350 (see FIG. 51) can be removed, attaching the rib arms 64 to the mirror actuation mechanism 140 instead (FIG. 18).

The deployment vehicle 300 can be pulled by a tow vehicle 304 that is driven by a human driver. However, this repetitive and boring task can alternatively be accomplished by a robot control system, thereby increasing steering precision. The design of this robot control system can be accomplished using standard techniques well-known to those of ordinary skill in the art. One exemplary approach is to use the mirror vertical support poles 46 (see FIGS. 11 and 19B) as fiducial features to guide navigation. These are easily recognized by a variety of well-known robotic sensors, such as ultrasonic sensors, rotating light beams, rotating laser range finders, or cameras. The performance of these sensors can be augmented by applying reflectors or camera targets to the support poles, allowing simple sensor processing control algorithms. Alternatively, more sophisticated algorithms can be used without requiring the reflectors or camera targets. The use of the mirror vertical support poles 46 is especially well-suited to this task, both because they naturally define the mirror line 50 to follow, and because they also naturally define the positions where rib top strap 82 installation is required.

### 3. Mirror Edge Stiffening

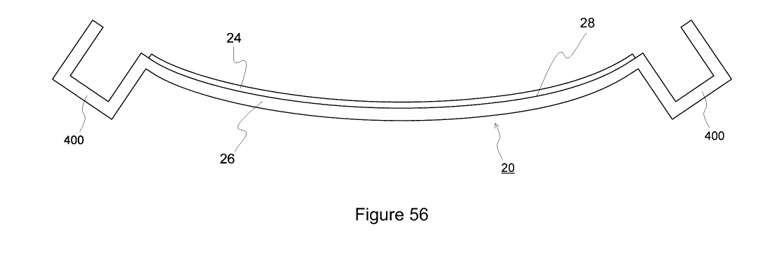

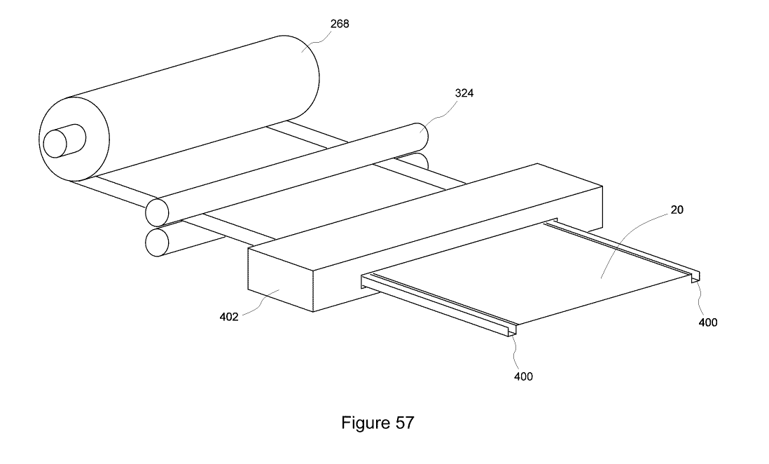

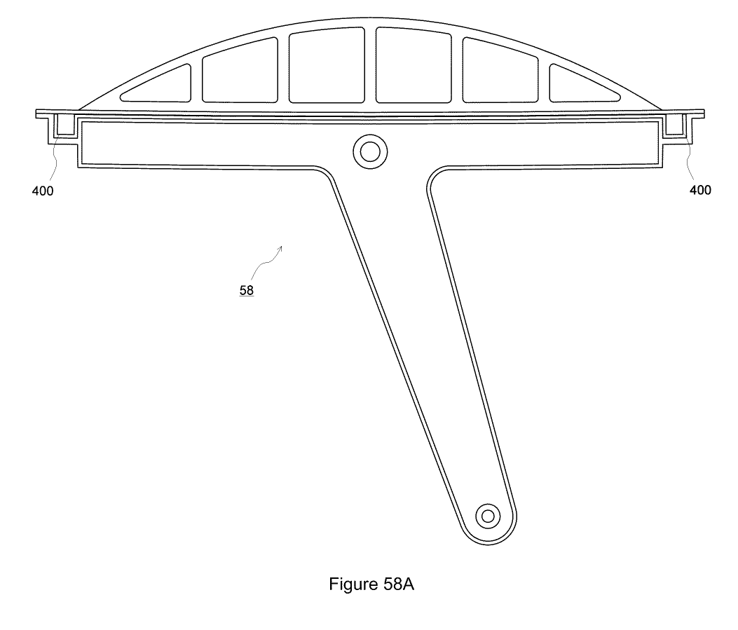

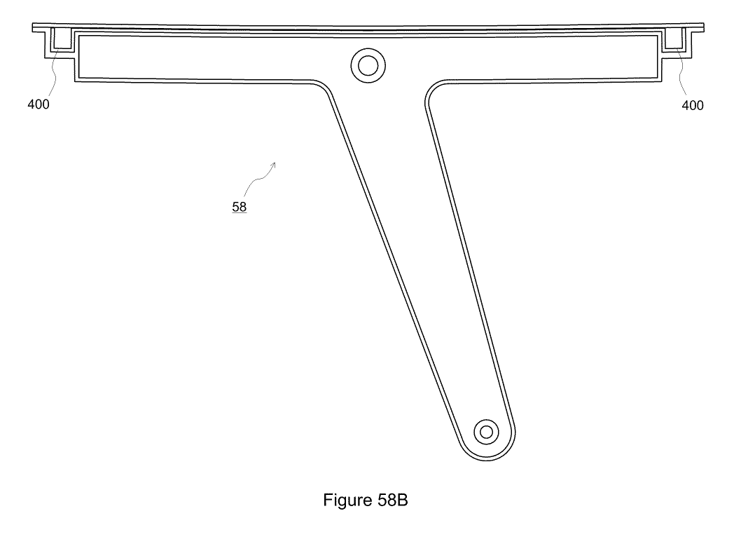

In some applications it may be desired to increase mirror edge stiffness to reduce deformation in the presence of applied disturbances. This can be accomplished for a mirror sheet with contiguous backing by extending the backing sheet beyond the width of the reflective polymer film, and then forming this additional material to a shape that includes features out of the nominal plane of the original sheet. FIG. 56 shows an example where this additional material forms a channel edge feature 400; other edge feature shapes such as boxes, triangles, I-beams, and the like all serve as out-of-plane edge features for the mirror sheet material to increase bending resistance. The reflective polymer film 24 and thicknesses of backing substrate 26 are shown exaggerated in FIG. 56 for clarity. In addition, the rounded corners typical of roll-formed shapes are drawn as sharp corners for simplicity.

FIG. 57 shows how increasing edge stiffness can be accomplished by adding a roll-forming mechanism 402 to the deployment vehicle 300 (see FIG. 52A). After the mirror sheet 20 unwinds from the mirror sheet roll, it passes through nip unwinding rollers 324 and then into the roll-forming mechanism 402. This device contains a series of rollers which deform the edges of the sheet to the desired shape. Roll-forming is a well-known process, and the detailed design of this mechanism is easily accomplished by one of ordinary skill in the art of designing roll-forming machines without undue experimentation. Depending on the internal details of the roll-forming mechanism 402, removal of the protective film 270 (see FIG. 50A) can be delayed until after roll-forming is complete, which causes the protective film take-up roll 328 (see FIG. 52A) to be relocated to a position after the roll-forming mechanism (not shown).

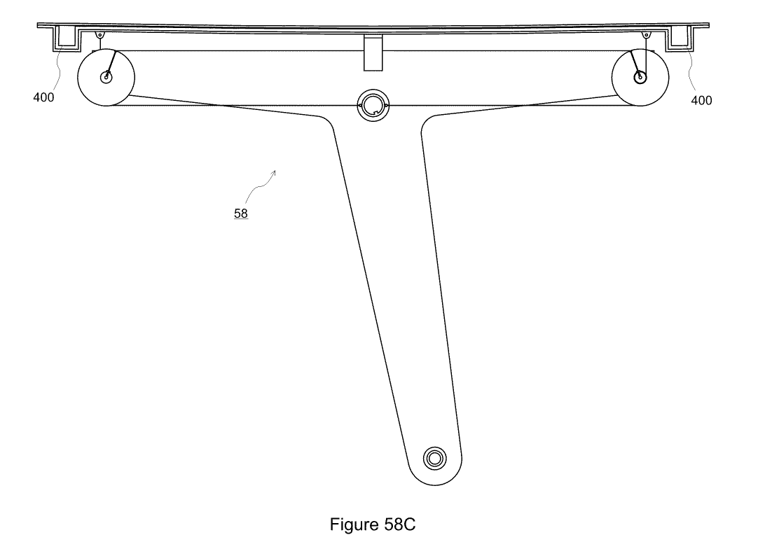

In addition to adding a roll-formed edge to the mirror sheet, the rib design needs to be modified to accommodate the out-of-plane edge feature. FIGS. 58A-C show how the fixed focal length and self-adjusting rib designs can be modified to hold and orient the channel edge feature shown in FIG. 56. Note that the mirror sheet thickness is exaggerated in these figures for clarity.

While a number of exemplary aspects and embodiments have been discussed above, those of ordinary skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A linear solar reflector comprising:
(a) a fixed mount;
(b) a mirror comprising at least one continuous reflective laminate sheet, which is under tension being exerted along its length, the sheet having a fixed end and tension end, wherein the fixed end is operably connected to the fixed mount;
(c) a tension mount operably connected to the tension end of the reflective laminate sheet; and
(d) one or more ground connections for the reflective laminate sheet separately connected to the ground and spaced along a line defined by the fixed mount and the tension mount.

2. The linear solar reflector of claim 1, also comprising a tension device operationally connected to the tension mount and the tension end of the reflective laminate sheet.

3. The linear solar reflector of claim 2, wherein the tension device comprises a tension weight.

4. The linear solar reflector of claim 1, wherein the reflective laminate sheet comprises a reflective polymer film.

5. The linear solar reflector of claim 4, wherein the reflective laminate sheet comprises tension-bearing strips.

6. The linear solar reflector of claim 5, wherein the reflective laminate sheet comprises a backing material.

7. The linear solar reflector of claim 6, wherein the laminate material comprising tension-bearing strips has a total resistance to elongation at least 25 times higher than the reflective polymer film and backing material without tension-bearing strips.

8. The linear solar reflector of claim 1, wherein the ground connection comprises:
(a) a mirror support operationally secured to the ground;
(b) a rib operationally connected to the mirror support, wherein the reflective laminate sheet is operationally secured to the rib, and wherein the operational connection between the rib and the mirror support allows the rib to rotate along a rotation freedom and translate along a translation freedom.

9. The linear solar reflector of claim 8, wherein the mirror support comprises:
(a) a first vertical support pole operationally secured to the ground;
(b) a horizontal support rod attached to the first vertical support pole.

10. The linear solar reflector of claim 8, wherein the rib comprises a pivot bearing at its operational connection with the mirror support, wherein the pivot bearing is operationally connected to the horizontal support rod, and wherein the pivot bearing is fixedly attached to or is part of the rib, and the operational connection between the pivot bearing and the horizontal support rod allows the pivot bearing to rotate along a rotation freedom and translate along a translation freedom.

11. The linear solar reflector of claim 1, also comprising an actuation mechanism operationally connected to said reflector, wherein said actuation mechanism comprises:
(a) a push rod operationally connected to an arm portion of a rib supporting the reflective laminate sheet, wherein motion of the push rod approximately along an axis defined by its length results in a change in angle of the rib;
(b) an actuation unit operationally connected to the push rod, wherein the actuation unit can cause the push rod to move approximately along an axis defined by its length; and
(c) a controller programmed with a sun-tracking algorithm, wherein the program causes the actuation unit to move the push rod approximately along an axis defined by its length in such a way as to cause the angle of the solar reflector to change as required for efficient collection of solar energy.

12. The linear solar reflector of claim 11, wherein the push rod is operationally connected to a component of a temperature compensation mechanism and is also operationally connected to the rib arm via an intervening actuation rod, wherein the actuation rod is also operationally connected to a component of the temperature compensation mechanism,

13. A curvature-adjustment system for adjustment of curvature of a mirror of a linear solar reflector supported by a rib pivotally attached to a horizontal support rod at a pivot point in response to movement of the rib by an actuator to track the sun throughout the day, said system comprising:
(a) a first main plate as a component of said rib;
(b) a compliant mirror support operationally attached to the first main plate, wherein the compliant mirror support is flexible and can bend through a range of desired curvatures for the linear solar reflector;
(c) a reflective laminate sheet operationally secured to the compliant mirror support,
(d) a mechanism that automatically changes the curvature of the compliant mirror support to a desired curvature in passive response to the actuation mechanism rotating the rib to track the sun through the day.

14. A curvature adjustment system of claim 13, comprising a mechanism capable of pulling the compliant mirror support to a desired curvature, said mechanism comprising:
(a) a rotatable pivot bearing pivotally attached to the first main plate, said rotatable pivot bearing comprising means for maintaining a fixed orientation relative to ground when installed on the horizontal support rod;
(b) a primary pulley strap, with a proximal end operationally attached to the rotatable pivot bearing, and a distal end operationally attached to a first wheel of a compound pulley;
(c) a compound pulley, wherein the compound pulley is pivotally attached to the main plate, and comprises:
(1) a first wheel, operationally attached to the distal end of the primary pulley strap; and
(2) a second wheel, operationally attached to the proximal end of a secondary pulley strap,
wherein the first wheel and second wheel have different diameters; and
(d) a secondary pulley strap, with a proximal end operationally attached to the second wheel of the compound pulley, and a distal end operationally attached to the compliant mirror support;
wherein rotation of the self-adjusting rib by the mirror actuation mechanism to an orientation away from the rib's neutral angle causes the rotatable pivot bearing to pull on the primary pulley strap, which in turn rotates the compound pulley, causing the secondary pulley strap to pull on the compliant mirror support, pulling the flexible beam formed by the compliant mirror support into the desired curvature.

15. A curvature adjustment system of claim 13, wherein the mechanism that changes the compliant mirror support to the desired curvature in passive response to the actuation mechanism rotating the rib to track the sun through the day comprises:
(a) at least one cam-following finger attached to and extending downward from the underside of the center of the compliant mirror support, and comprising a cam-following pin extending perpendicularly from the finger;
(b) means to prevent the cam-following finger(s) from moving right or left relative to the rib main plate while allowing them to move toward or away from the rib pivot point;
(c) a pivot cam rotatably attached to the first main plate of the rib, said pivot cam comprising means for maintaining a fixed orientation relative to ground when installed on the horizontal support rod;
d) at least one cam groove formed in the pivot cam for receiving said cam-following pin and allowing slidable movement of the pin therein during operation of the mechanism, in which operation the rib rotates upon said pivot cam in response to an actuation mechanism for orienting the reflector to track the sun; wherein the cam groove is shaped so as to cause the pin to move to a position within the groove calculated such that the finger causes the center of the compliant mirror support to move toward or away from the rib pivot point so as to produce a desired curvature in the mirror support.

16. An array of linear solar reflectors, each comprising the curvature adjustment system of claim 15, positioned with respect to a single receiver, wherein each solar reflector comprises a pivot cam having a cam groove with a shape and size selected to cause change of the curvature of the mirror of that reflector so as to reflect a desired amount of sunlight on said receiver over time.

17. A method of constructing a linear Fresnel collector, comprising the steps:
(a) providing a fixed mount;
(b) providing a reflective laminate sheet having a fixed end and a tension end;
(c) forming an operable connection between the fixed end of the reflective laminate sheet and the fixed mount;
(d) providing a tension mount;
(e) providing a first ground connection for the reflective laminate sheet between the fixed mount and tension mount;
(f) attaching the reflective laminate sheet to the first ground connection;
g) extending the tension end of the reflective laminate sheet to a location at or near the tension mount; and
h) forming an operable connection between the tension end of the reflective laminate sheet and the tension mount.

18. The method of claim 17, wherein the reflective laminate sheet is provided in the form of a roll.

19. A deployment vehicle useful for constructing a linear Fresnel reflector, the deployment vehicle comprising:
(a) a chassis;
(b) at least one reflective laminate sheet disposed on said vehicle;
(c) a tool disposed on said vehicle selected from the group consisting of:
(i) means for cutting reflective laminate sheets; and
(ii) means for attaching reflective laminate sheet to ground connections,
wherein the chassis provides a means for moving the vehicle along the length of the mirror, while deploying the reflective laminate sheet.

20. The deployment vehicle of claim 19, wherein the reflective laminate sheet is in the form of a roll and the vehicle also comprises a roll carrier for unwinding reflective laminate sheets from the roll.
